(19) United States
(12) Patent Application Publication
(10) Pub. No.: US 2006/0108170 A1
(43) Pub. Date: May 25, 2006

(54) Axle unit with slip sensor and slip meansurement method

(76) Inventors: Hiroaki Ishikawa, Kanagawa (JP); Yoshifumi Nakagome, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/535,199

(22) PCT Filed: Nov. 14, 2003
(86) PCT No.: PCT/JP03/14532

§ 371 Date: May 17, 2005

(30) Foreign Application Priority Data
Nov. 18, 2002 (JP) 2002-334105
Nov. 21, 2002 (JP) 2002-338366
Nov. 26, 2002 (JP) 2002-342640
Jan. 20, 2003 (JP) 2003-011459
Jan. 23, 2003 (JP) 2003-016601
Jan. 31, 2003 (JP) 2003-024355
Feb. 3, 2003 (JP) 2003-026419
Oct. 23, 2003 (JP) 2003-365350
Oct. 27, 2003 (JP) 2003-366354

(51) Int. Cl. G01P 1/02; F16C 41/04

(52) U.S. Cl. 180/282; 73/509; 73/494; 384/448; 324/160

(57) ABSTRACT

An axle unit 210 including a rolling bearing unit attached to a knuckle of a wheel support member has a slip sensor (211) including acceleration sensors and a rotation sensor in one piece. The slip sensor (211) has the rotation sensor placed on the base face, and the rotation sensor is placed facing an encoder (213) attached to a rotation member (212). At the vehicle running time, the traveling acceleration in the traveling direction of the wheel and the rotation angular speed are detected and at the vehicle running time, the ground speed of each wheel, the tire radius of each wheel, and the slip ratio of each wheel are found.

### TECHNICAL FIELD

This invention relates to an axle unit with a slip sensor and a slip measurement method used for stability control (stable run control) of an automobile.

### BACKGROUND ART

In recent years, a stability control system is adopted for a vehicle (for example, refer to patent document 1). Thus, a slip sensor for measuring the slip ratio and the slip state for each axle with high accuracy is demanded. A method for measuring the condition required for stability control using the slip sensor is demanded. (The slip ratio represents the difference between the peripheral speed of tire and the travel speed (ground speed) of tire. Generally, it is said that the slip ratio becomes 0.001, 0.01, 0.1, etc., because of a partial slip even when the tire grips the ground.)

[Patent document 1] JP-A-2003-118554

### DISCLOSURE OF THE INVENTION

By the way, the slip ratio of each wheel needs to be measured with good accuracy to enhance the control accuracy of TCS, ABS, stability control, etc.

However, the slip ratio of a wheel is found based on both the rotation speed of the wheel and the speed of a car body relative to the road surface (ground speed). According to the related art described above, the car body speed cannot directly be found although the rotation speed of the wheel can be detected with good accuracy. Thus, for example, the slip ratio must be estimated totally from the rotation speed of four wheels. Consequently, there is a problem of incapability of precisely finding the slip ratio and the slip state for each wheel particularly when the vehicle turns.

It is therefore an object of the invention to provide an axle unit with a slip sensor and a wheel slip ratio measurement method for making it possible to find the wheel slip ratio with good accuracy and more appropriately control stable running of a vehicle accordingly.

1) According to the invention, there is provided a wheel run state measuring method of using an acceleration sensor in the traveling direction of each wheel and a wheel rotation sensor, attached to each axle unit of a vehicle.

2) According to the invention, there is provided a wheel run state measuring method of using an acceleration sensor in the traveling direction of each wheel, attached to each axle unit of a vehicle, an acceleration sensor in the lateral direction of each wheel, and a wheel rotation sensor.

3) According to the invention, there is provided a wheel run state measuring method of using an acceleration sensor in the traveling direction of each wheel, attached to each axle unit having a drive wheel of a vehicle and a wheel rotation sensor.

4) According to the invention, there is provided a vehicle using the method described above in 1).

5) According to the invention, there is provided a vehicle using the method described above in 2).

6) According to the invention, there is provided a vehicle using the method described above in 3).

7) According to the invention, there is provided an axle unit or a rolling bearing unit for axle support having an acceleration sensor for measuring acceleration in the traveling direction of a wheel and a rotation sensor for measuring the rotation angular speed of the wheel.

8) According to the invention, there is provided a vehicle control apparatus using an acceleration sensor of each wheel and a wheel rotation sensor, attached to each axle unit of a vehicle.

9) According to the invention, there is provided a rolling bearing unit for axle support having the acceleration sensor and the rotation sensor described above in 8).

10) According to the invention, there is provided a wheel unit having a stationary member, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, and an acceleration sensor being attached to the stationary member for outputting an acceleration signal responsive to the acceleration in the traveling direction of the wheel unit.

11) According to the invention, there is provided a wheel unit having a stationary member, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, and an acceleration sensor being attached to the stationary member for outputting an acceleration signal responsive to the acceleration in the traveling direction of wheel.

12) According to the invention, there is provided a rolling bearing unit for wheel support having a rotation wheel, a stationary wheel, a plurality of rolling elements being placed between the stationary wheel and the rotation wheel, a sensor rotor being attached to the rotation wheel, a rotation speed sensor being attached to the stationary wheel so as to be opposed to the sensor rotor for outputting a rotation speed signal responsive to the rotation speed of the sensor rotor, and an acceleration sensor being attached to the stationary wheel for outputting an acceleration signal responsive to the acceleration in the traveling direction of wheel.

13) According to the invention, there is provided a wheel unit having a stationary member of the wheel unit below a spring of a vehicle suspension, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, and a semiconductor acceleration sensor being attached to the stationary member for outputting an acceleration signal responsive to the acceleration in the traveling direction of wheel.

14) According to the invention, there is provided a vehicle control method using an acceleration sensor in the traveling direction of each wheel and a wheel rotation sensor, attached to each axle unit of a vehicle.

15) According to the invention, there is provided a sensor having an acceleration sensor and a rotation speed sensor provided on a wheel to use the measuring method described above in 4) or the vehicle control method described above in 14).

16) According to the invention, there is provided a bearing including the sensor described above in 15).

17) According to the invention, there is provided a control system for controlling the run state of an automobile using the measuring method described above in 1) or the vehicle control method described above in 14).

According to the invention, the wheel slip ratio and the slip state can be found with good accuracy and stable running of the vehicle can be more appropriately controlled accordingly.

### BRIEF DESCRIPTION OF THE DRAWINGS

FIG. 1 is a sectional view of a rolling bearing unit used with a first embodiment of the invention;

FIG. 2 is a schematic drawing of a slip sensor used with a first embodiment of the invention;

FIG. 3 is a dynamical schematic representation used to calculate slip ratio in the first embodiment of the invention;

FIG. 4 is a dynamical schematic representation used to calculate slip ratio in the first embodiment of the invention;

FIG. 5 is a dynamical schematic representation used to calculate slip ratio in the first embodiment of the invention;

FIG. 6 is a dynamical schematic representation used to calculate slip ratio in the first embodiment of the invention;

FIG. 7 is a dynamical schematic representation used to calculate slip ratio in the first embodiment of the invention;

FIG. 8 is a dynamical schematic representation used to calculate slip ratio in the first embodiment of the invention;

FIG. 9 is a dynamical schematic representation used to calculate slip ratio in the first embodiment of the invention;

FIG. 10 is a dynamical schematic representation used to calculate slip ratio in the first embodiment of the invention;

FIG. 11 is a dynamical schematic representation used to calculate slip ratio in the first embodiment of the invention;

FIG. 12 is a dynamical schematic representation used to calculate slip ratio in the first embodiment of the invention;

FIG. 13 is a dynamical schematic representation used to calculate slip ratio in the first embodiment of the invention;

FIG. 14 is a dynamical schematic representation used to calculate slip ratio in the first embodiment of the invention;

FIG. 15 is a dynamical schematic representation used to calculate slip ratio in the first embodiment of the invention;

FIG. 16 is a dynamical schematic representation used to calculate slip ratio in the first embodiment of the invention;

FIG. 17 is a dynamical schematic representation used to calculate slip ratio in the first embodiment of the invention;

FIG. 18 is a dynamical schematic representation used to calculate slip ratio in the first embodiment of the invention;

FIG. 19 is a dynamical schematic representation used to calculate slip ratio in the first embodiment of the invention;

FIG. 20 is an external view of attachment of a pressure sensor used in the first embodiment of the invention;

FIG. 21 is a sectional view of the sensor portion in FIG. 20;

FIG. 22 is a dynamical schematic representation used to calculate slip ratio in the first embodiment of the invention;

FIG. 23 is a dynamical schematic representation used to calculate slip ratio in the first embodiment of the invention;

FIG. 24 is a dynamical schematic representation used to calculate slip ratio in the first embodiment of the invention;

FIG. 25 is a dynamical schematic representation used to calculate slip ratio in the first embodiment of the invention;

FIG. 26 is a dynamical schematic representation used to calculate slip ratio in the first embodiment of the invention;

FIG. 27 is a dynamical schematic representation used to calculate slip ratio in the first embodiment of the invention;

FIG. 28 is a dynamical schematic representation used to calculate slip ratio in the first embodiment of the invention;

FIG. 29 is a dynamical schematic representation used to calculate slip ratio in the first embodiment of the invention;

FIG. 30 is a measurement result table of examining the relationship between the sensor attachment position and an error in the first embodiment of the invention;

FIG. 31 is a dynamical schematic representation used to calculate slip ratio in the first embodiment of the invention;

FIG. 32 is a dynamical schematic representation used to calculate slip ratio in the first embodiment of the invention;

FIG. 33 is a sectional view of a rolling bearing unit for wheel support according to a second embodiment of the invention;

FIG. 34 is a sectional view taken on line IV-IV in FIG. 33;

FIG. 35 is a flowchart of control operation performed the second embodiment of the invention;

FIG. 36 is a sectional view of a rolling bearing unit for wheel support according to the second embodiment of the invention;

FIG. 37 is a sectional view of a rolling bearing unit for axle support according to a third embodiment of the invention;

FIG. 38 is a sectional view taken on line II-II in FIG. 37;

FIG. 39 is an enlarged view of the part indicated by arrow III in FIG. 137;

FIG. 40 is a diagram to show output change of a displacement measurement element;

FIG. 41 is a flowchart to execute a vehicle control method of a controller in each embodiment of the invention;

FIG. 42 is a sectional view of a rolling bearing unit for axle support according to a fourth embodiment of the invention;

FIG. 43 is a flowchart to execute a different vehicle control method of a controller in the embodiment of the invention;

FIG. 44 is a sectional view of a knuckle unit and a wheel unit according to a fifth embodiment of the invention;

FIG. 45 is a sectional view to show acceleration sensor arrangement according to a sixth embodiment of the invention;

FIG. 46 is a sectional view of a rolling bearing unit for axle support according to a seventh embodiment of the invention;

FIG. 47 is a sectional view of a rolling bearing unit for axle support according to an eighth embodiment of the invention;

FIG. 48 is a sectional view taken on line II-II in FIG. 47;

FIG. 49 is an enlarged view of the part indicated by arrow III in FIG. 47;

FIG. 50 is a sectional view of a rolling bearing unit for axle support according to a ninth embodiment of the invention;

FIG. 51 is a flowchart to execute a different vehicle control method of a controller in the embodiment of the invention;

FIG. 52 is a sectional view of a rolling bearing unit for axle support according to a tenth embodiment of the invention;

FIG. 53 is a sectional view of a rolling bearing unit for axle support according to an eleventh embodiment of the invention;

FIG. 54 is a sectional view of a rolling bearing unit for axle support according to a twelfth embodiment of the invention;

FIG. 55 is a sectional view of a rolling bearing unit for axle support according to a thirteenth embodiment of the invention;

FIG. 56 is a sectional view of a rolling bearing unit for axle support according to a fourteenth embodiment of the invention;

FIG. 57 is a sectional view of a rolling bearing unit for axle support according to a fifteenth embodiment of the invention;

FIG. 58 is a sectional view of a rolling bearing unit for axle support according to a sixteenth embodiment of the invention;

FIG. 59 is a sectional view of a rolling bearing unit for axle support according to a seventeenth embodiment of the invention;

FIG. 60 is an enlarged view of the part indicated by arrow III in FIG. 59;

FIG. 61 is a sectional view of a rolling bearing unit for axle support according to an eighteenth embodiment of the invention;

FIG. 62 is an enlarged view of the main part to show an example of a preferred attachment position of a composite sensor;

FIG. 63 is an enlarged view of the main part to show an example of a preferred attachment position of a composite sensor;

FIG. 64 is an enlarged view of the main part to show an example of a preferred attachment position of a composite sensor;

FIG. 65 is an enlarged view of the main part to show an example of a preferred attachment position of a composite sensor;

FIG. 66 is an enlarged view of the main part to show an example of a preferred attachment position of a composite sensor;

FIG. 67 is an enlarged view of the main part to show an example of a preferred attachment position of a composite sensor;

FIG. 68 is an enlarged view of the main part to show an example of a preferred attachment position of a composite sensor; and

FIG. 69 is an enlarged view of the main part to show an example of a preferred attachment position of a composite sensor.

### BEST MODE FOR CARRYING OUT THE INVENTION

Preferred embodiments according to the invention will be discussed in detail based on the accompanying drawings.

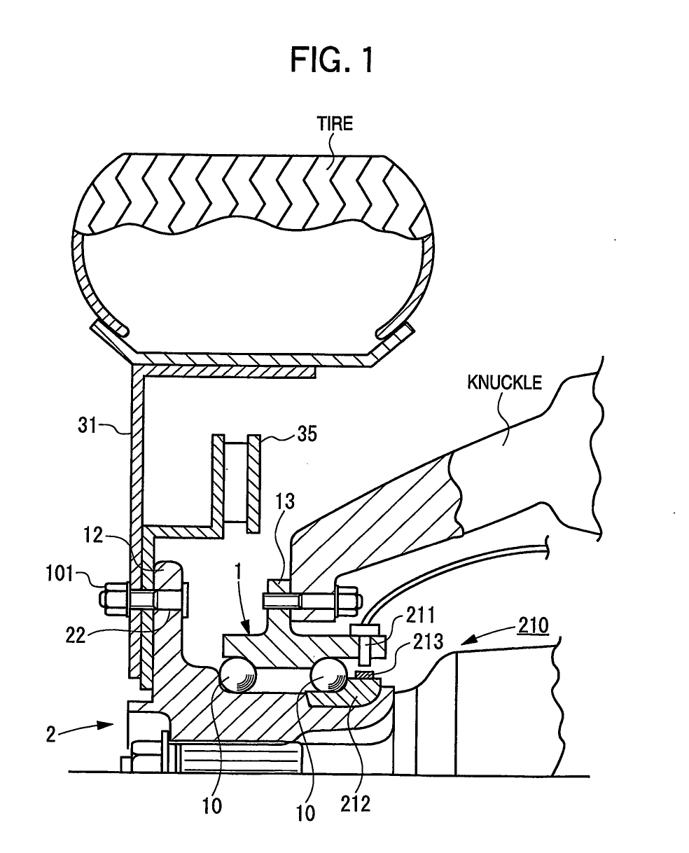

Next, a slip ratio measurement method of a wheel according to a first embodiment of the invention will be discussed with reference to FIGS. 1 to 32.

AS shown in FIG. 1, an axle unit (or wheel unit) 210 including a rolling bearing unit (also called a wheel bearing unit) attached to a knuckle of a wheel support member has a slip sensor 211 including acceleration sensors and a rotation sensor in one piece. The slip sensor 211 has the rotation sensor 222 placed on the base face, and the rotation sensor is placed facing an encoder 213 attached to a rotation member 212. A brake rotor and a tire are attached to the rolling bearing unit.

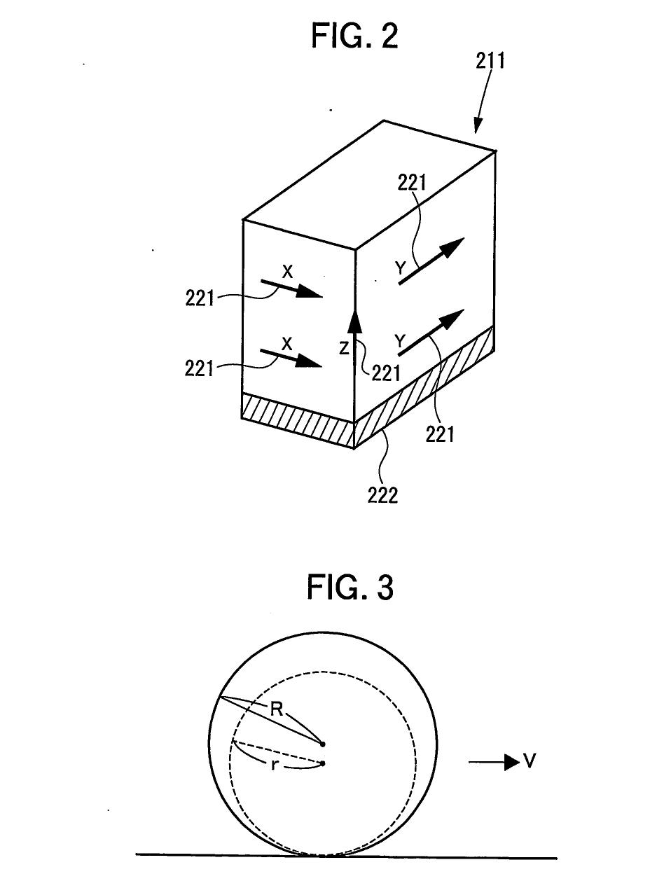

As shown in FIG. 2, as the acceleration sensors 221 of the slip sensor 211, two are attached in the x direction (wheel traveling direction), two are attached in the y direction (wheel lateral direction), and one is attached in the z direction (wheel longitudinal direction). A sensor having a three-axis acceleration sensor and a two-axis (x and y) angular acceleration sensor in one piece may be used. For example, the following products and patent documents are disclosed from Kabishiki kaisha Wako:

U.S. Pat. No. 6,282,956 Multi-axial Angular velocity sensor

U.S. Pat. No. 6,269,697 Angular velocity sensor using piezoelectric element

U.S. Pat. No. 6,098,461 Acceleration sensor using piezoelectric element

U.S. Pat. No. 5,850,040 Multi-axial acceleration sensor using

The y-direction acceleration sensor 221 becomes necessary at the turning time. The z-direction acceleration sensor 221 is used for correcting the effect of a vibration component caused by uneven spots on the road surface, but may be nonexistent.

Further, to find the ground speed of the car body, the acceleration sensor may be provided on the car body. In this case, the ground speed of each wheel is replaced with the ground speed of the car body in reading. In this case, at the traveling time in a straight line, the acceleration and ground speed of each wheel may be replaced with the acceleration and ground speed of the car body.

To begin with, ground speed V of each wheel is found. As shown in FIG. 3, at the real running time, a partial slip occurs in radius R of the wheel at the driving time in each wheel, particularly the drive wheel, and given speed appears. Assuming that the same speed appears with partial slip 0, it can be considered that the radius of each wheel small changes, and the radius of each wheel is assumed to be virtual radius r. The virtual radius becomes smaller than the real radius at the driving time; in contrast, it becomes large at the braking time.

Using wheel rotation angular speed a) detected by the rotation sensor 222 attached to each rolling bearing unit (or wheel support member or axle unit or wheel unit) 210 and acceleration αₓ relative to the x direction of each wheel detected from the acceleration sensor 221 attached to each wheel support member, ground speed V of each wheel is represented by the following expression:

[Expression 1]
V=ω (101)

Here, assuming that the virtual radius r is constant (r=const), if the expression is differentiated with respect to the time (represented by ′ in the expression) to transform the expression, the virtual radius r is represented as follows:

[Expression 2]
V′=rω′ (102)
[Expression 3]
αₓ=rω′ (103)
[Expression 4]

$$r = \frac{{α}_{x}}{{ω}^{′}} \qquad ( 104 )$$

Next, using acceleration αₓ detected by the acceleration sensor 221 attached to each wheel support member (axle unit or wheel unit) 210 and rotation angular speed ω detected by the rotation sensor 222, ground speed V of each wheel can be found as in the following expression from expressions (101) and (104):
[Expression 5]

$$V = r ω = \frac{α}{{ω}^{′}} ω \qquad ( 105 )$$

Strictly, when the virtual radius r is constant, expression (105) holds; however, when αₓ/ω′ is almost constant in each wheel, the ground speed V of each wheel can be found from expression (105). Here, the expression “αₓ/ω′ is almost constant” is used to mean change within 10 mm or 1 mm for one second or change within 10 mm or 1 mm within the sampling interval, for example. Letting the time when the condition becomes false, namely, when αₓ/ω′ does not become almost constant be t1 and the ground speed at the time be Vₜ₁, the later ground speed V in each wheel is found by the following expression:
[Expression 6]

$$V = {V}_{{t}_{1}} + {\int }_{{t}_{1}}^{t} {α}_{x} ⅆ t \qquad ( 106 )$$

When αₓ/ω′ again becomes almost constant, the ground speed V in each wheel is replaced with the value of (αₓ/ω′) ω, whereby the ground speed V in each wheel can always be found with high accuracy. Whether or not αₓ/ω′≅const can be determined by determining whether or not it changes within 10 mm or 1 mm for one second or changes within 10 mm or 1 mm within the sampling interval, for example.

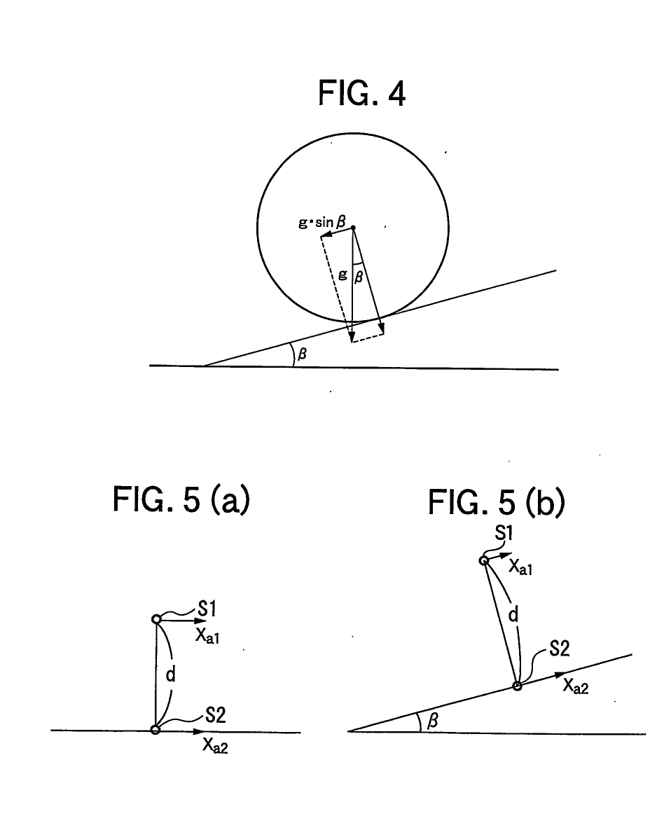

Next, the effect of road gradient angle β is removed. As shown in FIG. 4, at the slope running time, if the acceleration sensor 221 is an acceleration sensor using the force generated by acceleration, such as a piezo element system, a piezoelectric element system, or a strain gate system, the effect of road gradient angle β appears and therefore needs to be removed. As for output of the acceleration sensor, the output when the vehicle is accelerated in the x direction, namely, in the traveling direction of the vehicle is positive. Real acceleration αₓᵣ is found by the following expression as gravity component g sinβ is removed from output αₓₐ of the acceleration sensor 221:

[Expression 7]
αₓᵣ=αₓₐ−g·sin β (107)

β becomes positive on an upward slope and becomes a negative value on a downward slope. When ω≅const, almost αₓᵣ≅0 results and therefore the road gradient angle β can be found as in the following expression. Whether or not ω≅const is determined by measuring the ratio between ω₁ at the measurement time and ω₂ in constant time Δt after the measurement. For example, if ω₁/ω₂ is within ±1% or 0.1%, it is determined that ω≅const.
[Expression 8]

$$sin β = \frac{{α}_{xa}}{g} \qquad ( 108 )$$

When the condition does not hold, as the two acceleration sensors 221 for detecting acceleration in the same direction, S1 is placed above and S2 is placed below as in FIG. 5(a) and the later road gradient angle β is found from the following expression where sensor outputs are (αₓₐ₁ and αₓₐ₂, the distance between the sensors is d, the time when the condition becomes false is t₁, and the road gradient angle just before the condition becomes false is βₜ₁ (see FIG. 5(b)):
[Expression 9]

$$β = \int {\int }_{{t}_{1}}^{t} \{ ( {α}_{xa 2} - {α}_{xα 1} ) / ⅆ \} ⅆ {t}^{2} + {β}_{{t}_{1}} \qquad ( 109 )$$

(αₓₐ₂−αₓₐ₁)/d in expression (109) is the angular acceleration difference caused by the road gradient angle and therefore as integration is performed twice, the fluctuation of the road gradient angle is found. If ω≅const again results, the value is replaced with the value found according to expression (108). Accordingly, the road gradient angle can always be found with high accuracy. Hereinafter, the acceleration αₓ will represent the real acceleration αₓᵣ.

Next, the slip ratio S of tire will be discussed. The slip ratio S of tire is defined by the following expression where V_{θ} is the peripheral speed of the tire:

[Expression 10]
S=1−V/V_{θ}(at driving time) (110)
S=1−V_{θ}/V(at braking time) (110)

The tire peripheral speed V_{θ} is found as the product of the tire real radius R and the rotation angular speed ω detected by the rotation sensor 222. That is, V_{θ}=Rω.

Since the ground speed V of each wheel is always found by expressions (105) and (106), the slip ratio of each tire is found from the following expression according to expression (110):

[Expression 11]
S=1−V/Rω(at driving time) (111)
S=1−Rω/V (at braking time) (111)

Here, the real radius R of each wheel (tire) is found as R=V/ω because the ground speed V is always found according to expressions (105) and (106). However, R=V/ω always holds for a driven wheel when no brake is applied and R=V/ω holds for a drive wheel if the slip ratio S of the tire is almost 0, for example, within 0.01 or 0.001.

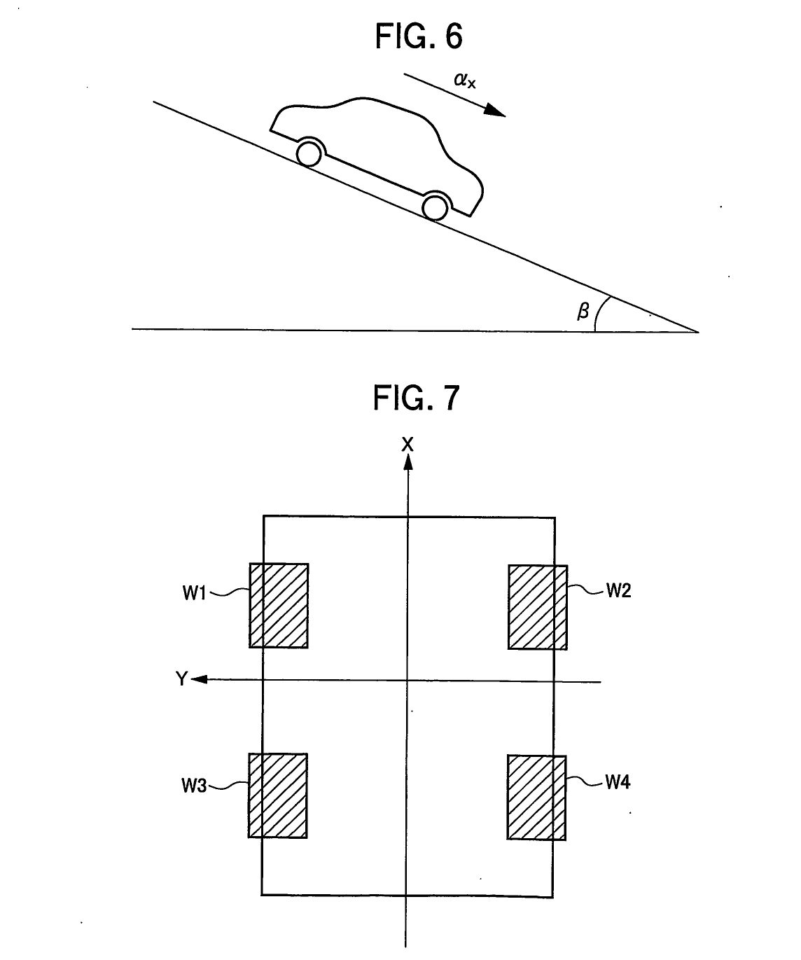

Next, the condition that the slip ratio of the tire of the drive wheel becomes almost 0, namely, a neutral state is entered is shown. In the neutral state, if the effects of run resistance, air resistance of the tire, etc., are not received, the following expression is applied considering the road gradient angle β as shown in FIG. 6:

[Expression 12]
αₓ≅−g sin β (112)

To actually find R under the neutral condition, R is further found at almost the traveling time in a straight line (definition of the traveling time in a straight line is described later) with no brake applied.

In fact, in the drive wheel, even under the neutral condition (α≅−g sinβ), slip ratio rather than neutral exists. Therefore, acceleration α_{xN} (negative value) corresponding to the neutral state at the ground speed V is added by experiment on a flatland when no natural wind exists or the like and, for example, the values of α_{xN} corresponding to V=10, 20, 30, 40, and 50 (km/h) are stored and each value is added and when the following expression holds, the neutral state is assumed to be entered:

[Expression 13]
αaₓ=−g sin β+α_{xN} (113)

In the condition of expression (113), R may be measured several times and be averaged.

If α_{xN} is not stored, when expression (112) holds when the effects of run resistance of the tire, air resistance, etc., are small, namely, when the vehicle runs at low speed, the neutral state may be assumed to be entered.

In the calculation, it is assumed that the effect of the external force of natural wind (simply, wind), etc., does not exist. However, if the external force of wind, etc., is considered, a slip occurs even in the state of expression (113). Thus, the condition that drive force does not appear and engine brake is not applied either for the speed of the automobile and the number of revolutions of the engine (for example, the opening of engine throttle, etc.,) is stored and R is measured only under the stored condition. When the clutch is in disengagement and the brake is not effective, it may be assumed that the neutral state is entered as with the driven wheel.

Under the condition that the slip ratio of each wheel is small, namely, when the road gradient angle is small with low acceleration, namely, when both αₓ and −g sinβ are small and further air resistance is small (namely, low speed of 10 km/h or less), r may be averaged to find R.

When the electric system of the automobile (power supply) is off, the value of R is stored and when the automobile is next driven, the value is used until R is found.

Since the real radius R of the wheel is thus found, the precise slip ratio of each wheel can always be found according to expression (111).

When the real radius of each tire is thus found, it is also useful for detecting an anomaly of each tire. For example, it is advisable to detect an anomaly when a tire blows out as follows:

First, if the virtual radius r or the real radius R rapidly becomes small, the accelerator slot is closed. Then, if the virtual radius r or R rapidly becomes large and is restored, simply a slip occurs; if the virtual radius r or R is not restored, there is a possibility that the tire may blow out, and therefore the driver is prompted to stop the vehicle.

When the tire radius decrease ratio of one wheel from time t₁ to time t₂ (Rₜ₁−Rₜ₂)/Rₜ₂ is larger than the tire radius decrease of any other wheel (for example, 10% or more for two to five seconds; 5% or more for five to 20 seconds), it is advisable to perform similar control.

Next, a method of finding the road friction coefficient at the traveling time in a straight line will be discussed.

The road friction coefficient of each wheel in a state in which a partial slip occurs at the traveling time in a straight line is found using the slip ratio S. The traveling time in a straight line refers to the time when x-direction acceleration αxn (n=1, 2, 3, 4) in the traveling direction of each wheel is almost equal or the time when y-direction acceleration α_{yn} (n=1, 2, 3, 4) in the lateral direction of each wheel is almost 0.

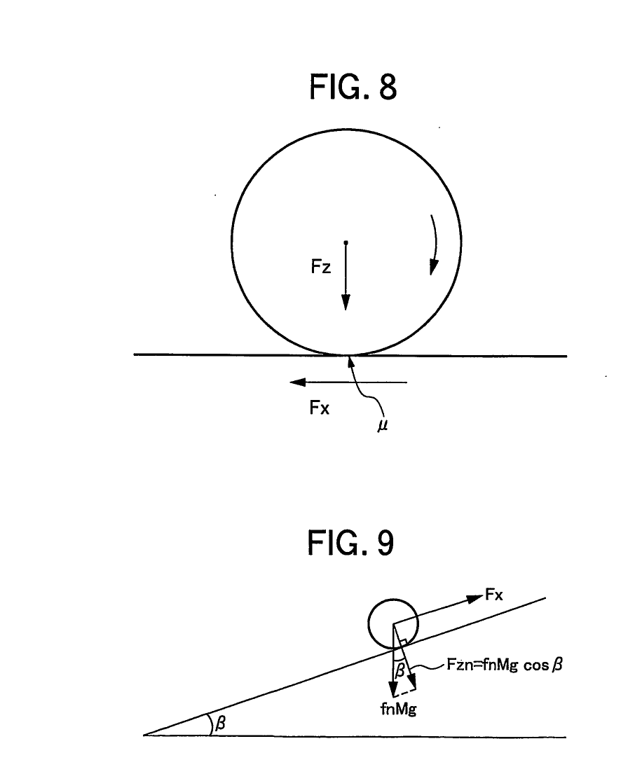

Here, wheels 1, 2, 3, and 4 and the x and y directions are determined as shown in FIG. 7. Road friction coefficient μ is found using the slip ratio S of each wheel, longitudinal load F_{z}, and the inertial force caused by vehicle weight M. In a state in which a partial slip occurs, it is assumed that generally the following expression holds for drive force Fxn in the x direction acting on each wheel, slip ratio Sn, road friction coefficient μn, and longitudinal load Fzn of each wheel as in FIG. 8. (In an area wherein the slip ratio S is small, it is assumed that Fx changes almost linearly relative to S. In fact, it is also considered that Fx changes like a curve relative to S, but here it is assumed that Fx changes almost linearly relative to S.) A calculation method based on change like a curve is described later. k_{b} is a constant determined by the rubber material of the tire, the structure of a tread pattern, etc.

[Expression 14]
Fₓ₁=1/k_{b}μ₁F_{z1}S₁ (114-1)
Fₓ₂=1/k_{b}μ₂F_{z2}S₂ (114-2)
Fₓ₃=/1k_{b}μ₃F_{z3}S₃ (114-3)
Fₓ₄=1/k_{b}μ₄F_{z4}S₄ (114-4)

Considering an equation of motion at the center of gravity, car body drive force F_{xc} is represented by the following expression where the acceleration at the center of gravity is α_{xc} and the vehicle weight (mass) is M. Product Mα of the car body mass M and the acceleration α is the inertial force based on the car body mass. The acceleration at the center of gravity α_{xc} at the traveling time in a straight line is found as the average of the x-direction acceleration αₓₙ (n=1-4) of each wheel. In the equation of motion, the acceleration component caused by gravity needs to be added.

[Expression 15]
F_{Xc}=M(α_{xc}+g sin β) (115)

In fact, the effects of air resistance, run resistance of the tire, and natural wind act on the wheel and therefore these are assumed to be R_{ω} and need to be considered for the equation of motion.

Here, assuming that R_{ω} is a constant in a minute time, F_{xc} is represented by the following expression:

[Expression 16]
F_{xc}=M(α_{xc}+g sin β)+R_{ω} (116)

If this expression is differentiated with respect to the time, R_{ω} disappears.

If it is considered that the road gradient angle β does not change in a minute time, the gravity component also disappears and the road gradient angle β becomes the following expression: (Calculation may be performed when β does not change for a constant time.)

[Expression 17]
F′_{xc}=Mα′_{xc} (117)

Next, if expressions (114) are differentiated with respect to the time, they become the following expressions. Here, it is assumed that μₙ, F_{zn}, and β do not change in a minute time.

$$\begin{matrix}[ Expression 18 ] \\ {F}_{x1}^{′} = \frac{1}{{k}_{b}} {μ}_{1} {F}_{z 1} {S}_{1}^{′} & ( 118 \text{-} 1 ) \\ {F}_{x 2}^{′} = \frac{1}{{k}_{b}} {μ}_{2} {F}_{z 2} {S}_{2}^{′} & ( 118 \text{-} 2 ) \\ {F}_{x3}^{′} = \frac{1}{{k}_{b}} {μ}_{3} {F}_{z3} {S}_{3}^{′} & ( 118 \text{-} 3 ) \\ {F}_{x 4}^{′} = \frac{1}{{k}_{b}} {μ}_{4} {F}_{z 4} {S}_{4}^{′} & ( 118 \text{-} 4 )\end{matrix}$$

Expressions (117) and (118) are set to simultaneous equations as follows:

$$[ Expression 19 ]$$

$$\begin{matrix}{F}_{x1}^{′} = \frac{1}{{k}_{b}} {μ}_{1} {F}_{z 1} \cdot {S}_{1}^{′} & ( 119 \text{-} 1 ) \\ {F}_{x 2}^{′} = \frac{1}{{k}_{b}} {μ}_{2} {F}_{z 2} \cdot {S}_{2}^{′} & ( 119 \text{-} 2 ) \\ {F}_{x 3}^{′} = \frac{1}{{k}_{b}} {μ}_{3} {F}_{z 3} \cdot {S}_{3}^{′} & ( 119 \text{-} 3 ) \\ {F}_{x 4}^{′} = \frac{1}{{k}_{b}} {μ}_{4} {F}_{z 4} \cdot {S}_{4}^{′} & ( 119 \text{-} 4 ) \\ {F}_{xc}^{′} = M {α}_{xc}^{′} & ( 119 \text{-} 5 )\end{matrix}$$

A method of finding the road friction coefficient of each wheel by solving simultaneous equations (119) is shown. That is, at the traveling time in a straight line, the road friction coefficient μₙ of each wheel and the drive force Fₓₙ of each wheel are found using the slip ratio Sₙ of each wheel, the longitudinal load F_{zn} imposed on each wheel, and the inertial force M_{α} caused by the car body mass M. An easy and precise calculation method using the direct measurement value of the longitudinal load for each wheel is described later. To begin with, a method of finding the longitudinal load by calculation and finding the road friction coefficient based on the longitudinal load is shown.

Since the number of variables is too many, it is once assumed that the four wheels are equal in road friction coefficient, and the road friction coefficient is set to μₙ.

[Expression 20]
μₙ=μ₁=μ₂=μ₃=μ₄ (120)

Next, load sharing ratio fₙ (n=1, 2, 3, 4) is used. This load sharing ratio is thought of as a constant in a minute time. Since the load sharing ratio is the sharing ratio of loads imposed on the wheels of the vehicle weight M, the longitudinal load of each wheel is found as F_{zn}=fₙMg.cosβ (see FIG. 9). Using the load sharing ratio, expressions (119) become the following expressions:

$$[ Expression 21 ]$$

$$\begin{matrix}{F}_{x 1}^{′} = \frac{1}{{k}_{b}} {μ}_{n} {f}_{1} Mg cos β \cdot {S}_{1}^{′} & ( 121 \text{-} 1 ) \\ {F}_{x 2}^{′} = \frac{1}{{k}_{b}} {μ}_{n} {f}_{2} Mg cos β \cdot {S}_{2}^{′} & ( 121 \text{-} 2 ) \\ {F}_{x 3}^{′} = \frac{1}{{k}_{b}} {μ}_{n} {f}_{3} Mg cos β \cdot {S}_{3}^{′} & ( 121 \text{-} 3 ) \\ {F}_{x 4}^{′} = \frac{1}{{k}_{b}} {μ}_{n} {f}_{4} Mg cos β \cdot {S}_{4}^{′} & ( 121 \text{-} 4 ) \\ {F}_{xc}^{′} = M {α}_{xc}^{′} & ( 121 \text{-} 5 ) \\ {f}_{1} + {f}_{2} + {f}_{3} + {f}_{4} = 1 & ( 121 \text{-} 6 )\end{matrix}$$

Next, torque distribution ratio k_{dn} (n=1, 2, 3, 4) to the wheels is used. This torque distribution ratio k_{dn} is the ratio of distributing torque T_{c} of the running gear to the wheels and is the value found as the running gear of the automobile distributes the torque. The torque of each wheel becomes Tₙ=k_{dn}T_{c}.

The relation of k_{d1}+k_{d2}+k_{d3}+k_{d4}=1 holds. Since the torque of each wheel is the product of the drive force Fₓₙ of each wheel and the tire real radius R of each wheel, the following expression holds:

[Expression 22]
Tₙ=Fₓₙ·Rₙ (122)

This expression is transformed as follows:

[Expression 23]
Fₓₙ=Tₙ/Rₙ=k_{dn}·Tₒ/Rₙ (123)

Since the drive force of the car body at the traveling time in a straight line is the sum of the drive forces of the wheels, the following expression holds:

$$[ Expression 24 ]$$

$${F}_{xc} = {\sum }_{n = 1}^{4} {F}_{xn} = {\sum }_{n = 1}^{4} \frac{{k}_{dn}}{{R}_{n}} {T}_{c} \qquad ( 124 )$$

If expressions (123) and (124) are differentiated with respect to the time, the following expression is obtained. Here, it is assumed that k_{dn} and Rₙ do not change in a minute time.

$$[ Expression 25 ]$$

$$\begin{matrix}{F}_{xn}^{′} = \frac{{k}_{dn}}{{R}_{n}} {T}_{c}^{′} & ( 125 \text{-} 1 ) \\ {F}_{xc}^{′} = {\sum }_{n = 1}^{4} \frac{{k}_{dn}}{{R}_{n}} {T}_{c}^{′} & ( 125 \text{-} 2 )\end{matrix}$$

If expression (125-1) is assigned to expressions (121-1 to 121-6) and further expression (125-2) is added, the following result:

$$\begin{matrix}[ Expression 26 ] & \\ \frac{{k}_{d1}}{{R}_{1}} {T}_{c}^{′} = \frac{1}{{k}_{b}} {μ}_{n} {f}_{1} Mg cos β {S}_{1}^{′} & ( 126 \text{-} 1 ) \\ \frac{{k}_{d2}}{{R}_{2}} {T}_{c}^{′} = \frac{1}{{k}_{b}} {μ}_{n} {f}_{2} Mg cos β {S}_{2}^{′} & ( 126 \text{-} 2 ) \\ \frac{{k}_{d3}}{{R}_{3}} {T}_{c}^{′} = \frac{1}{{k}_{b}} {μ}_{n} {f}_{3} Mg cos β {S}_{3}^{′} & ( 126 \text{-} 3 ) \\ \frac{{k}_{d4}}{{R}_{4}} {T}_{c}^{′} = \frac{1}{{k}_{b}} {μ}_{n} {f}_{4} Mg cos β {S}_{4}^{′} & ( 126 \text{-} 4 ) \\ {F}_{xc}^{′} = M {α}_{xC}^{′} & ( 126 \text{-} 5 ) \\ {f}_{1} + {f}_{2} + {f}_{3} + {f}_{4} = 1 & ( 126 \text{-} 6 ) \\ {F}_{xc}^{′} = {\sum }_{n = 1}^{4} \frac{{k}_{dn}}{{R}_{n}} {T}_{c}^{′} & ( 126 \text{-} 7 )\end{matrix}$$

Expression (126-5) is assigned to expression (126-7) as follows:

$$\begin{matrix}[ Expression 27 ] & \\ {T}_{c}^{′} = {F}_{xc}^{′} / {\sum }_{n = 1}^{4} \frac{{k}_{dn}}{{R}_{n}} = M {α}_{xc}^{′} / {\sum }_{n = 1}^{4} \frac{{k}_{dn}}{{R}_{n}} & ( 127 )\end{matrix}$$

If expression (127) is assigned to expressions (126-1) to (126-4), simultaneous equations become the following expressions:

$$\begin{matrix}[ Expression 28 ] & \\ \frac{{k}_{d1}}{{R}_{1}} \cdot M {α}_{xc}^{′} / {\sum }_{n = 1}^{4} \frac{{k}_{dn}}{{R}_{n}} = \frac{1}{{k}_{b}} {μ}_{n} {f}_{1} Mg cos β {S}_{1}^{′} & ( 128 \text{-} 1 ) \\ \frac{{k}_{d2}}{{R}_{2}} \cdot M {α}_{xc}^{′} / {\sum }_{n = 1}^{4} \frac{{k}_{dn}}{{R}_{n}} = \frac{1}{{k}_{b}} {μ}_{n} {f}_{2} Mg cos β {S}_{2}^{′} & ( 128 \text{-} 2 ) \\ \frac{{k}_{d3}}{{R}_{3}} \cdot M {α}_{xc}^{′} / {\sum }_{n = 1}^{4} \frac{{k}_{dn}}{{R}_{n}} = \frac{1}{{k}_{b}} {μ}_{n} {f}_{3} Mg cos β {S}_{3}^{′} & ( 128 \text{-} 3 ) \\ \frac{{k}_{d4}}{{R}_{4}} \cdot M {α}_{xc}^{′} / {\sum }_{n = 1}^{4} \frac{{k}_{dn}}{{R}_{n}} = \frac{1}{{k}_{b}} {μ}_{n} {f}_{4} Mg cos β {S}_{4}^{′} & ( 128 \text{-} 4 ) \\ {f}_{1} + {f}_{2} + {f}_{3} + {f}_{4} = 1 & ( 128 \text{-} 5 )\end{matrix}$$

If expression (128-1) is transformed to the form representing f₁ using μₙ, it becomes the following expression:

$$\begin{matrix}[ Expression 29 ] & \\ {f}_{1} = ( \frac{{k}_{d1}}{{R}_{1}} \cdot {α}_{xc}^{′} / {\sum }_{n = 1}^{4} \frac{{k}_{dn}}{{R}_{n}} ) / \frac{1}{{k}_{b}} {μ}_{n} g cos β {S}_{1}^{′} & ( 129 )\end{matrix}$$

Likewise, expressions (128-2) to (128-4) are transformed, whereby f₂ to f₄ can also be represented using μₙ. If (f₁ to f₄) are assigned to expression (128-5), the unknown becomes only μₙ and μₙ is found.

As μₙ thus found is assigned to expressions (128-1) to (128-4), the load sharing ratio among the wheels, f₁ to f₄, is found. Since fₙ found here is found by assuming that the wheels are equal in road friction coefficient, several measurements are conducted and are averaged and fₙ is given as a constant as in the following expressions:

$$\begin{matrix}[ Expression 30 ] & \\ {f}_{1} = \frac{1}{n} {\sum }_{n = 1}^{n} {f}_{1 n} & ( 130 \text{-} 1 ) \\ {f}_{2} = \frac{1}{n} {\sum }_{n = 1}^{n} {f}_{2 n} & ( 130 \text{-} 2 ) \\ {f}_{3} = \frac{1}{n} {\sum }_{n = 1}^{n} {f}_{3 n} & ( 130 \text{-} 3 ) \\ {f}_{4} = \frac{1}{n} {\sum }_{n = 1}^{n} {f}_{4 n} & ( 130 \text{-} 4 )\end{matrix}$$

Thus, fₙ is found.

Next, using fₙ, μ₁, μ₂, μ₃, and μ₄ are found from expressions of replacing μₙ in expressions (128-1) to (128-4) with μ₁, μ₂, μ₃, and μ₄.

$$\begin{matrix}[ Expression 31 ] & \\ {μ}_{1} = \frac{{k}_{d1}}{{R}_{1}} \cdot {α}_{xc}^{′} / {\sum }_{n = 1}^{4} \frac{{k}_{dn}}{{R}_{n}} \cdot \frac{1}{{k}_{b}} {f}_{1} g cos β {S}_{1}^{′} & ( 131 \text{-} 1 ) \\ {μ}_{2} = \frac{{k}_{d2}}{{R}_{2}} \cdot {α}_{xc}^{′} / {\sum }_{n = 1}^{4} \frac{{k}_{dn}}{{R}_{n}} \cdot \frac{1}{{k}_{b}} {f}_{2} g cos β {S}_{2}^{′} & ( 131 \text{-} 2 ) \\ {μ}_{3} = \frac{{k}_{d3}}{{R}_{3}} \cdot {α}_{xc}^{′} / {\sum }_{n = 1}^{4} \frac{{k}_{dn}}{{R}_{n}} \cdot \frac{1}{{k}_{b}} {f}_{3} g cos β {S}_{3}^{′} & ( 131 \text{-} 3 ) \\ {μ}_{4} = \frac{{k}_{d4}}{{R}_{4}} \cdot {α}_{xc}^{′} / {\sum }_{n = 1}^{4} \frac{{k}_{dn}}{{R}_{n}} \cdot \frac{1}{{k}_{b}} {f}_{4} g cos β {S}_{4}^{′} & ( 131 \text{-} 4 )\end{matrix}$$

From these expressions, the road friction coefficients of the wheels μ₁, μ₂, μ₃, and μ₄ can be found. That is, they are found if f₁, f₂, f₃, and f₄ are assigned to the expressions.

As shown above, at the traveling time in a straight line, the road friction coefficient μₙ of each wheel and the drive force Fₓₙ of each wheel can be found using the slip ratio Sₙ of each wheel, the longitudinal load F_{zn} imposed on each wheel, and the inertial force M_{α} caused by the car body mass M.

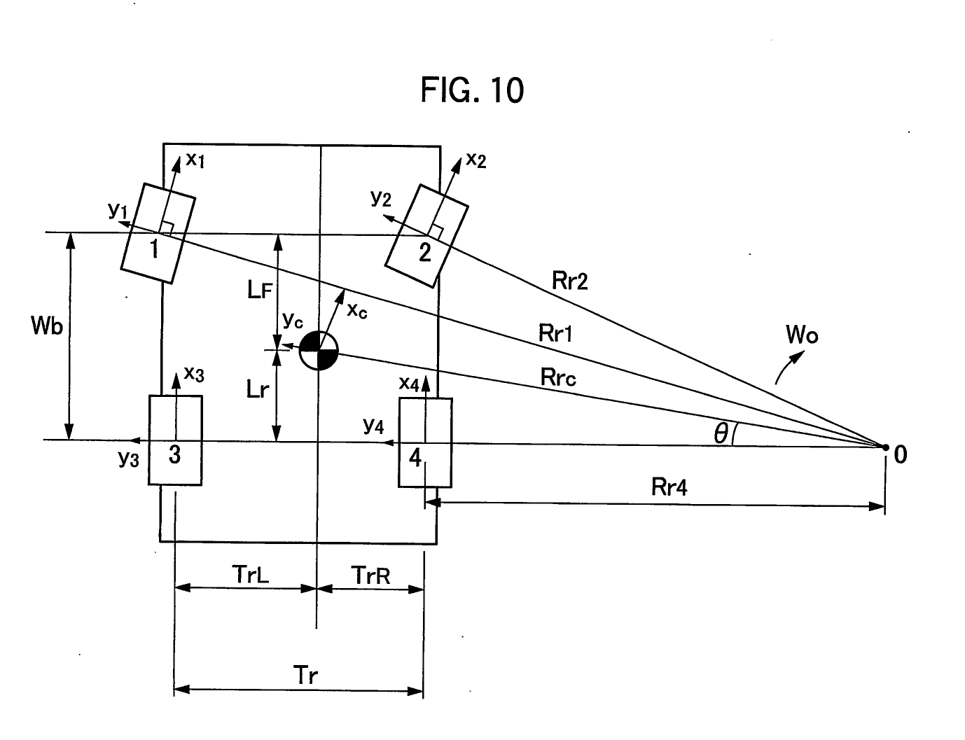

Next, with reference to FIG. 10, at the curve running time, the road friction coefficient μₙ of each wheel and resultant force F_{ω}n of the drive force Fₓₙ and side force F_{yn} can be found using output α_{yn} of the acceleration sensor in the lateral direction of each wheel attached to each axle unit of the vehicle, the slip ratio Sₙ of each wheel, the longitudinal load F_{zn} imposed on each wheel, and the inertial force M_{α} caused by the car body mass.

A method of finding the road friction coefficient for each wheel at the curve running time will be discussed. At the curve running time, as at the traveling time in a straight line, the relational expression of the slip ratio of each wheel and the drive force and the equation of motion at the center of gravity of the vehicle are set to simultaneous equations, which are then solved. To do this, the acceleration at the center of gravity is found and further to consider the acceleration at the center of gravity, turning radius Rᵣₙ (n=1, 2, 3, 4, c) of each wheel and center of gravity is found for use. To find the turning radius Rᵣₙ, etc., Ackerman theory and formula of circular motion are used. The Ackerman theory is a theory indicating that each line connecting each wheel and center of gravity and center O is perpendicular to the traveling direction of each wheel and center of gravity.

From the formula of circular motion, the following relational expressions hold for the y-direction acceleration α_{yn} (n=1, 2, 3, 4, c), the turning radius Rᵣₙ (n=1, 2, 3, 4, c), and x-direction ground speed Vₓₙ (n=1, 2, 3, 4, c) of each wheel and center of gravity:

[Expression 32]
α_{y1}=Vₓ₁²/Rᵣ₁ (132-1)
α_{y2}=Vₓ₂²/Rᵣ₂ (132-2)
α_{y3}=Vₓ₃²/Rᵣ₃ (132-3)
α_{y4}=Vₓ₄²/Rᵣ₄ (132-4)
α_{yc}=V_{xc}²/R_{rc} (132-5)

From these relational expressions, the turning radius Rᵣₙ (n=1, 2, 3, 4, c) of each wheel is found as follows:

[Expression 33]
Rᵣ₁=Vₓ₁²/α_{y1} (133-1)
Rᵣ₂=Vₓ₂²/α_{y2} (133-2)
Rᵣ₃=Vₓ₃²/α_{y3} (133-3)
Rᵣ₄=Vₓ₄²/α_{y4} (133-4)

Here, α_{yn} is found from the acceleration sensor 221 in the y direction (lateral direction) of each wheel and Vₓₙ is found by performing the above-described calculation from the acceleration sensor 221 in the x direction (traveling direction) of each wheel and the rotation sensor 222 and therefore Rᵣₙ is found in expressions (133-1) to (133-4).

Next, the turning radius R_{rc} of center of gravity is found. If the center-of-gravity position is assumed and given, the turning radius R_{rc} of center of gravity is found geometrically from expression (134) given below. In a method of directly finding the longitudinal load on each wheel described later, the center-of-gravity position is found by calculation and need not be assumed. Here, Rᵣ₄ is the distance between the turning center and rear wheel 4, T_{rR} is the distance in the lateral direction between the center of gravity and the rear wheel, and Lᵣ is the distance in the longitudinal direction between the center of gravity and the rear wheel.

[Expression 34]
R_{rc}=\sqrt{(Rᵣ₄+T_{rR})²+Lᵣ²} (134)

From the formula of circular motion, the following relational expressions hold for the y-direction acceleration, the turning radius Rᵣₙ, and turning rotation angular speed θₒ of each wheel and center of gravity:

[Expression 35]
α_{y1}=Rᵣ₁ω₀² (135-1)
α_{y2}=Rᵣ₂ω₀² (135-2)
α_{y3}=Rᵣ₃ω₀² (135-3)
α_{y4}=Rᵣ₄ω₀² (135-4)
α_{yc}=R_{rc}ω₀² (135-5)

The turning rotation angular speed ωₒ shown in the figure is a common value to the wheels and the center of gravity and therefore expressions (135-1) to (135-4) become as follows:

$$\begin{matrix}[ Expression 36 ] & \\ {ω}_{0}^{2} = \frac{{α}_{y1}}{{R}_{r1}} = \frac{{α}_{y2}}{{R}_{r2}} = \frac{{α}_{y3}}{{R}_{r3}} = \frac{{α}_{y4}}{{R}_{r4}} & ( 136 )\end{matrix}$$

If this expression is assigned to expression (135-5), the y-direction acceleration α_{yn} of the center of gravity is found in the following expression:

$$\begin{matrix}[ Expression 37 ] & \\ {α}_{yc} = \frac{{R}_{rc}}{{R}_{r1}} \cdot {α}_{y1} = \frac{{R}_{rc}}{{R}_{r2}} \cdot {α}_{y2} = \frac{{R}_{rc}}{{R}_{r3}} \cdot {α}_{y3} = \frac{{R}_{rc}}{{R}_{r4}} \cdot {α}_{y4} & ( 137 \text{-} 1 ) \\ {α}_{yc} = {\sum }_{n = 1}^{4} ( {α}_{yn} / {R}_{rn} ) \cdot \frac{{R}_{rc}}{4} & ( 137 \text{-} 2 )\end{matrix}$$

Any term of expression (137-1) may be used and the average of the terms may be used as in expression (137-2).

Next, the x-direction acceleration α_{xc} of the center of gravity is found. The following relational expressions hold for the x-direction ground speed Vₓₙ, the turning rotation angular speed ωₒ, and the turning radius Rᵣₙ of each wheel and center of gravity:

[Expression 38]
Vₓ₁=ω₀Rᵣ₁ (138-1)
Vₓ₂=ω₀Rᵣ₂ (138-2)
Vₓ₃=ω₀Rᵣ₃ (138-3)
Vₓ₄=ω₀Rᵣ₄ (138-4)
V_{xc}=ω₀R_{rc} (138-5)

If these expressions are differentiated, the following result. Here, it is considered that Rᵣₙ does not change in a minute time.

[Expression 39]
αₓ₁=ω′₀Rᵣ₁ (139-1)
αₓ₂=ω′₀Rᵣ₂ (139-2)
αₓ₃=ω′₀Rᵣ₃ (139-3)
αₓ₄=ω′₀Rᵣ₄ (139-4)
α_{xc}=ω′₀R_{rc} (139-5)

Here, the wheels and the center of gravity are equal in the turning rotation angular speed ω and angular acceleration ωₒ′ and therefore expressions (139-1) to (139-4) become as follows:

$$\begin{matrix}[ Expression 40 ] & \\ {ω}_{0}^{′} = \frac{{α}_{x1}}{{R}_{r1}} = \frac{{α}_{x2}}{{R}_{r2}} = \frac{{α}_{x3}}{{R}_{r3}} = \frac{{α}_{x4}}{{R}_{r4}} & ( 140 )\end{matrix}$$

If ωₒ′ is assigned to expression (139-5), the x-direction acceleration of the center of gravity is found as follows:

$$\begin{matrix}[ Expression 41 ] & \\ {α}_{xc} = \frac{{R}_{rc}}{{R}_{r1}} {α}_{x1} = \frac{{R}_{rc}}{{R}_{r2}} {α}_{x2} = \frac{{R}_{re}}{{R}_{r3}} {α}_{x3} = \frac{{R}_{rc}}{{R}_{r4}} {α}_{x4} & ( 141 \text{-} 1 ) \\ {α}_{xc} = {R}_{rc} {\sum }_{n = 1}^{4} ( {α}_{xn} / {R}_{rn} ) / 4 & ( 141 \text{-} 2 )\end{matrix}$$

At this time, any term of expression (141-1) may be used and the average of the terms maybe used as in expression (141-2).

Thus, the x-direction acceleration and y-direction acceleration of the center of gravity, α_{xc} and α_{yc}, are found. At the curve running time, the relational expression of the slip ratio Sₙ and the drive force Fₓₙ of each wheel and the equation of motion of the vehicle at the center of gravity and further simultaneous equations to which a moment balance expression around the turning center is added are solved, whereby the road friction coefficient of each wheel is found. The method is as follows:

At the curve running time, generally the following expressions also hold for the drive force Fₓₙ acting in the x direction of each wheel, the slip ratio Sₙ, the road friction coefficient μₙ, the longitudinal load Fₓₙ of each wheel, and the road gradient angle β:

[Expression 42]
Fₓ₁=1/k_{b}·μ₁F_{z1}·S₁ (142-1)
Fₓ₂=1/k_{b}μ₂F_{z2}·S₂ (142-2)
Fₓ₃=1/k_{b}μ₃F_{z3}·S₃ (142-3)
Fₓ₄=1/k_{b}μ₄F_{z4}·S₄ (142-4)

Considering the inertial force caused by the vehicle weight M, the equation of motion at the center of gravity of the vehicle is represented by the following expression:

[Expression 43]
F_{xc}=M(α_{xc}+g·sin β) (143)

If run resistance of air resistance, etc., is set to R_{w} and is added to the equation of motion, the expression becomes as follows:

[Expression 44]
F_{xc}=M(α_{xc}+g·sin β)+R_{W} (144)

If this expression is differentiated, the constant term R_{w} disappears. Assuming that the road gradient angle β does not change in a minute time, the gravity component also disappears as in the following expression:

[Expression 45]
F′_{xc}=Mα′_{xc} (145)

If expressions (142) are differentiated with respect to the time, they become the following expressions. Here, it is assumed that μₙ, F_{zn}, and β do not change in a minute time.

[Expression 46]
F′ₓ₁=1/k_{b}·μ₁F_{z1}·S′₁ (146-1)
F′ₓ₂=1/k_{b}·μ₂F_{z2}·S′₂ (146-2)
F′ₓ₃=1/k_{b}·μ₃F_{z3}·S′₃ (146-3)
F′ₓ₄=1/k_{b}·μ₄F_{z4}·S′₄ (146-4)

At the curve running time, moment balance around the turning center is considered and its expression is added to simultaneous equations. That is, the sum total of the products of the drive force Fₓₙ and the turning radius Rᵣₙ of each wheel equals the product of the drive force Fₓₒ of the vehicle and the turning radius R_{rc} of the center of gravity and therefore the following expression holds:

[Expression 47]
Fₓ₁·Rᵣ₁+Fₓ₂·Rᵣ₂+Fₓ₃·Rᵣ₃+Fₓ₄·Rᵣ₄=F_{xc}·R_{rc} (147)

Expression (147) is transformed.

$$\begin{matrix}[ Expression 48 ] & \\ {F}_{x1} \frac{{R}_{r1}}{{R}_{rc}} + {F}_{x2} \frac{{R}_{r2}}{{R}_{rc}} + {F}_{x3} \frac{{R}_{r3}}{{R}_{rc}} + {F}_{x4} \frac{{R}_{r4}}{{R}_{rc}} = {F}_{xc} & ( 148 )\end{matrix}$$

In expression (148), if Rᵣ₁/R_{rc}=h₁, Rᵣ₂/R_{rc}=h₂, Rᵣ₃/R_{rc}=h₃, Rᵣ₄/R_{rc}=h₄, are set and power vector ratio is set, the following expression results:

[Expression 49]
h₁Fₓ₁+h₂Fₓ₂+h₃Fₓ₃+h₄Fₓ₄=F_{xc} (149)

Expression (149) is differentiated with respect to the time. Here, it is assumed that the power vector ratio does not change in a minute time.

[Expression 50]
h₁F′ₓ₁+h₂F′ₓ₂+h₃F′ₓ₃+h₄F′ₓ₄=F′_{xc} (150)

At the curve running time, in addition to the relational expression of the drive force Fₓₙ and the slip ratio Sₙ of each wheel (expression (146)) and the equation of motion at the center of gravity (expression (145)), if simultaneous equations with the moment expression around the turning center (expression (150)) are solved as shown below, the road friction coefficient μₙ of each wheel is found:

[Expression 51]
F′ₓ₁=1/k_{b}·μ₁F_{z1}·S′₁ (151-1)
F′ₓ₂=1/k_{b}·μ₂F_{z2}·S′₂ (151-2)
F′ₓ₃=1/k_{b}·μ₃F_{z3}·S′₃ (151-3)
F′ₓ₄=1/k_{b}·μ₄F_{z4}·S′₄ (151-4)
F′_{xc}=Mα′_{xc} (151-5)
h₁F′ₓ₁+h₂F′ₓ₂+h₃F′ₓ₃+h₄F′ₓ₄=F′_{xc} (151-6)

A method of solving expression (151) and finding the road friction coefficient μₙ of each wheel is shown below.

To begin with, if it is once assumed that the four wheels are equal in road friction coefficient, and the road friction coefficient is set to μm, expressions (151) become as follows:

[Expression 52]
F′ₓ₁=1/k_{b}·μₘF_{z1}·S′₁ (152-1)
F′ₓ₂=1/k_{b}·μₘF_{z2}·S′₂ (152-2)
F′ₓ₃=1/k_{b}·μₘF_{z3}·S′₃ (152-3)
F′ₓ₄=1/k_{b}·μₘF_{z4}·S′₄ (152-4)
F′_{xc}=Mα′_{xc} (152-5)
h₁F′ₓ₁+h₂F′ₓ₂h₃F′ₓ₃+h₄F′ₓ₄=F′_{xc} (152-6)

Next, the load sharing ratio fₙ of each wheel is used. Considering that the load sharing ratio is a constant in a minute time and F_{zn}=fₙMg·cosβ and therefore the following expressions result:

[Expression 53]
F′ₓ₁=1/k_{b}·μₘf₁Mg·cos β·S′₁ (153-1)
F′ₓ₂=1/k_{b}·μₘf₂Mg·cos β·S′₂ (153-2)
F′ₓ₃=1/k_{b}·μₘf₃Mg·cos β·S′₃ (153-3)
F′ₓ₄=1/k_{b}·μₘf₄Mg·cos β·S′₄ (153-4)
F′_{xc}=Mα′_{xc} (153-5)
h₁F′ₓ₁+h₂F′ₓ₂+h₃F′ₓ₃+h₄F′ₓ₄=F′_{xc} (153-6)
f₁+f₂+f₃+f₄=1 (153-7)

Using the torque distribution ratio kdₙ of the ratio of distributing torque T_{c} of the running gear to the wheels, the following relations hold:

[Expression 54]
T₁=kd₁T_{c} (154-1)
T₂=kd₂T_{c} (154-2)
T₃=kd₃T_{c} (154-3)
T₄=kd₄T_{c} (154-4)
kd₁+kd₂+kd₃+kd₄=1 (154-5)

Since the torque Tₙ of each wheel is the product of the drive force Fₓₙ and the tire real radius R of each wheel, the following expressions hold:

[Expression 55]
T₁=Fₓ₁·R₁ (155-1)
T₂=Fₓ₂·R₂ (155-2)
T₃=Fₓ₃·R₃ (155-3)
T₄=Fₓ₄·R₄ (155-4)

Therefore, using the torque Tₙ of the running gear, the drive force Fₓₙ of each wheel is represented as follows:

[Expression 56]
Fₓ₁=k_{d1}·T_{c}/R₁ (156-1)
Fₓ₂=k_{d2}·T_{c}/R₂ (156-2)
Fₓ₃=k_{d3}·T_{c}/R₃ (156-3)
Fₓ₄=k_{d4}·T_{c}/R₄ (156-4)

Next, expressions (156) are differentiated. Here, it is assumed that K_{dn} and Rₙ do not change in a minute time.

[Expression 57]
F′ₓ₁=k_{d1}/R₁·T′_{c} (157-1)
F′ₓ₂=k_{d2}/R₂·T′_{c} (157-2)
F′ₓ₃=k_{d3}/R₃·T′_{c} (157-3)
F′ₓ₄=k_{d4}/R₄·T′_{c} (157-4)

If the expressions are assigned to the simultaneous equations of expressions (153), the following result:

[Expression 58]
k_{d1}/R₁·T′_{c}=1/k_{b}·μₘf₁Mg·cos β·S′₁ (158-1)
k_{d2}/R₂·T′_{c}=1/k_{b}·μₘf₂Mg·cos β·S′₂ (158-2)
k_{d3}/R₃·T′_{c}=1/k_{b}·μₘf₃Mg·cos β·S′₃ (158-3)
k_{d4}/R₄·T′_{c}=1/k_{b}·μₘf₄Mg·cos β·S′₄ (158-4)
F′_{xc}=Mα′_{xc} (158-5)
F′_{xc}=h₁·k_{d1}/R₁·T′_{c}+h₂·k_{d2}/R₂·T′_{c}+h₃k_{d3}/R₃·T′_{c}h₄·k_{d4}/R₄·T′_{c} (158-6)
f₁+f₂+f₃+f₄=1 (158-7)

From expressions (158-5) and (158-6), Tc′ is represented as follows:

$$\begin{matrix}[ Expression 59 ] & \\ {T}_{c}^{′} = M {α}_{xc}^{′} / {\sum }_{n = 1}^{4} ( {h}_{n} \cdot {k}_{dn} / {R}_{n} ) & ( 159 )\end{matrix}$$

If expression (159) is assigned to expressions (158-1) to (158-4), the vehicle weight M disappears on both sides and simultaneous equations are represented as follows:

$$\begin{matrix}[ Expression 60 ] & \\ {k}_{d1} / {R}_{1} \cdot {α}_{xc}^{′} / {\sum }_{n = 1}^{4} ( {h}_{n} \cdot {k}_{dn} / {R}_{n} ) = 1 / {k}_{b} \cdot {μ}_{m} {f}_{1} g \cdot cos β \cdot {S}^{′} & ( 160 \text{-} 1 ) \\ {k}_{d2} / {R}_{2} \cdot {α}_{xc}^{′} / {\sum }_{n = 1}^{4} ( {h}_{n} \cdot {k}_{dn} / {R}_{n} ) = 1 / {k}_{b} \cdot {μ}_{m} {f}_{2} g \cdot cos β \cdot {S}_{2}^{′} & ( 160 \text{-} 2 ) \\ {k}_{d3} / {R}_{3} \cdot {α}_{xc}^{′} / {\sum }_{n = 1}^{4} ( {h}_{n} \cdot {k}_{dn} / {R}_{n} ) = 1 / {k}_{b} \cdot {μ}_{m} {f}_{3} g \cdot cos β \cdot {S}_{3}^{′} & ( 160 \text{-} 3 ) \\ {k}_{d4} / {R}_{4} \cdot {α}_{xc}^{′} / {\sum }_{n = 1}^{4} ( {h}_{n} \cdot {k}_{dn} / {R}_{n} ) = 1 / {k}_{b} \cdot {μ}_{m} {f}_{4} g \cdot cos β \cdot {S}_{4}^{′} & ( 160 \text{-} 4 ) \\ {f}_{1} + {f}_{2} + {f}_{3} + {f}_{4} = 1 & ( 160 \text{-} 5 )\end{matrix}$$

If expressions (160-1) to (160-4) are transformed, fₙ is represented as follows:

$$\begin{matrix}[ Expression 61 ] & \\ {f}_{n} = {k}_{dn} / {R}_{n} \cdot {α}_{xc}^{′} / {\sum }_{n = 1}^{4} ( {h}_{n} \cdot {k}_{dn} / {R}_{n} ) / ( 1 / {k}_{b} \cdot {μ}_{m} \cdot g \cdot cos β \cdot {S}_{n}^{′} ) & ( 161 )\end{matrix}$$

They are assigned to expression (160-5) to find μₘ. Then, the found value of μₘ is assigned to expression (161) to find the load sharing ratio fₙ of each wheel. The found load sharing ratio fₙ is assigned to simultaneous equations.

Since the unknown is only μₘ in the following expressions, the road friction coefficient of each wheel can also be found at the curve running time:

$$\begin{matrix}[ Expression 62 ] & \\ {k}_{d1} / {R}_{1} \cdot {α}_{xc}^{′} / {\sum }_{n = 1}^{4} ( {h}_{n} \cdot {k}_{dn} / {R}_{n} ) = 1 / {k}_{b} \cdot {μ}_{1} {f}_{1} g \cdot cos β \cdot {S}_{1}^{′} & ( 162 \text{-} 1 ) \\ {k}_{d2} / {R}_{2} \cdot {α}_{xc}^{′} / {\sum }_{n = 1}^{4} ( {h}_{n} \cdot {k}_{dn} / {R}_{n} ) = 1 / {k}_{b} \cdot {μ}_{2} {f}_{2} g \cdot cos β \cdot {S}_{2}^{′} & ( 162 \text{-} 2 ) \\ {k}_{d3} / {R}_{3} \cdot {α}_{xc}^{′} / {\sum }_{n = 1}^{4} ( {h}_{n} \cdot {k}_{dn} / {R}_{n} ) = 1 / {k}_{b} \cdot {μ}_{3} {f}_{3} g \cdot cos β \cdot {S}_{3}^{′} & ( 162 \text{-} 3 ) \\ {k}_{d4} / {R}_{4} \cdot {α}_{xc}^{′} / {\sum }_{n = 1}^{4} ( {h}_{n} \cdot {k}_{dn} / {R}_{n} ) = 1 / {k}_{b} \cdot {μ}_{4} {f}_{4} g \cdot cos β \cdot {S}_{4}^{′} & ( 162 \text{-} 4 )\end{matrix}$$

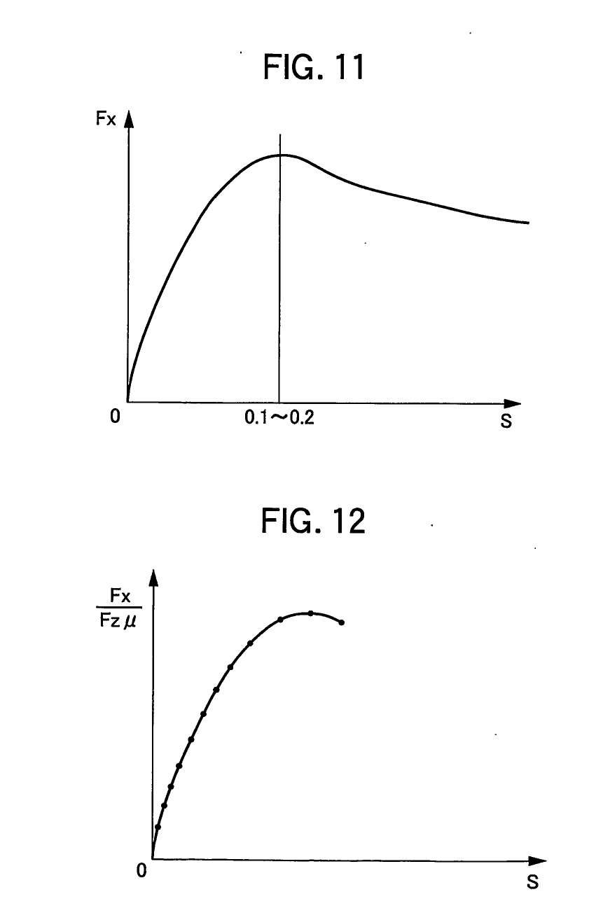

Next, the relational expression of the drive force Fₓₙ and the slip ratio Sₙ of each wheel will be discussed. In the method, to find the road friction coefficient of each wheel, it is assumed that the drive force Fₓₙ of each wheel is proportional to the slip ratio Sₙ; in fact, however, it is considered that the drive force (braking force) Fₓₙ fluctuates like a curve relative to fluctuation of the slip ratio Sₙ, as shown in FIG. 11. When the slip ratio Sₙ is 0, 1 to 0, 2, the drive force indicates the maximum value. When the slip ratio Sₙ is beyond the range, the drive force decreases and each wheel actually starts to slip. As the slip ratio Sₙ increases, the drive force Fₓₙ of each wheel increases almost linearly a little before each wheel actually slips. In the method, the gradient is set to 1/k_{b} as a constant determined by the rubber material of the tire, the tread pattern, the structure, etc. As S becomes large, the gradient a little changes; in the method, however, both Fₓₙ and Sₙ are differentiated and therefore it is considered that a line results instantaneously and an error is small.

To find the relationship between Fₓₙ and Sₙ more precisely, a method of storing the relationship between the drive force Fₓₙ and the slip ratio Sₙ, Fₓₙ/Fₓₙ μₙ=f (Sₙ) in memory as data is also available as an alternative method. In this case, the drive force Fₓₙ and the slip ratio Sₙ are represented by the following relational expression:

[Expression 63]
Fₓₙ=μₙFₓₙf(sₙ) (163)

Also in this case, as with the case where linear approximation is conducted, if differentiation is performed and simultaneous equations are solved, the road friction coefficient of each wheel can be found.

[Expression 64]
F′ₓ₁=μ₁F_{z1}f′(s₁) (164-1)
F′ₓ₂=μ₂F_{z2}f′(s₂) (164-2)
F′ₓ₃=μ₃F_{z3}f′(s₃) (164-3)
F′ₓ₄=μ₄F_{z4}f′(s₄) (164-4)
F′_{xc}=Mα′_{xc} (164-5)

At this time, to find differentiation of f (Sₙ), f′ (Sₙ), Δf (Sₙ) of difference of f (Sₙ) at minute time interval Δt is found and is divided by Δt, for example, as represented by the following expression:

$$\begin{matrix}[ Expression 65 ] & \\ {f}_{( {S}_{n} )}^{′} = \frac{{f}_{( {S}_{n t + Δ t} )} - {f}_{( {S}_{n t} )}}{Δ t} = \frac{Δ {f}_{( {S}_{n} )}}{Δ t} & ( 165 )\end{matrix}$$

It is better to store the drive force Fₓₙ for a larger number of pieces of data of the slip ratio Sₙ; otherwise, linear interpolation or interpolation like a curve may be performed, as shown in FIG. 12. Specifically, the slip ratio at which a wheel will start to slip is about 0.1 to 0.2 and thus the slip ratio S is divided into 200 to 500 points and Fₓ/F_{z}μ corresponding to each of the points is stored. At this time, if two bytes are required for storing one point, all data can be stored in memory of 0.4K to 1K bytes; the precise relationship can be found at high speed with memory of a very small capacity.

Next, fluctuation of the longitudinal load F_{zn} of each wheel will be discussed.

The road friction coefficient is found by assuming that the longitudinal load of each wheel and the center-of-gravity position are constant; in fact, however, the longitudinal load fluctuates because of any of the following causes, etc.:

1. Back-and-forth longitudinal load move of car body caused by pitching;

2. Side-to-side longitudinal load move of car body caused by rolling;

3. Longitudinal load move caused by reaction moment of drive force;

4. Longitudinal load move when suspension acts because of uneven spots on the road surface, etc.

The center-of-gravity position of the vehicle also moves with fluctuation of the longitudinal load Fₓₙ of each wheel and needs to be corrected. However, the need for correction is eliminated in a method of directly measuring Fₓₙ for use (described later).

Correction methods of the longitudinal load and the center-of-gravity position are shown below.

The load sharing ratio is corrected considering the fluctuation of the longitudinal load of each wheel mentioned above is corrected and again shown below.

Simultaneous equations are solved to find the road friction coefficient.

[Expression 66]

(At the traveling time in a straight line)

$$\begin{matrix}{μ}_{1} = {k}_{d1} / {R}_{1} \cdot {α}_{xc}^{′} / {\sum }_{n = 1}^{4} ( {k}_{dn} / {R}_{n} ) \cdot 1 / {k}_{b} \cdot {f}_{1} g \cdot cos β \cdot {S}_{1}^{′} & ( 166 \text{-} 1 ) \\ {μ}_{2} = {k}_{d2} / {R}_{2} \cdot {α}_{xc}^{′} / {\sum }_{n = 1}^{4} ( {k}_{dn} / {R}_{n} ) \cdot 1 / {k}_{b} \cdot {f}_{2} g \cdot cos β \cdot {S}_{2}^{′} & ( 166 \text{-} 2 ) \\ {μ}_{3} = {k}_{d3} / {R}_{3} \cdot {α}_{xc}^{′} / {\sum }_{n = 1}^{4} ( {k}_{dn} / {R}_{n} ) \cdot 1 / {k}_{b} \cdot {f}_{3} g \cdot cos β \cdot {S}_{3}^{′} & ( 166 \text{-} 3 ) \\ {μ}_{4} = {k}_{d4} / {R}_{4} \cdot {α}_{xc}^{′} / {\sum }_{n = 1}^{4} ( {k}_{dn} / {R}_{n} ) \cdot 1 / {k}_{b} \cdot {f}_{4} g \cdot cos β \cdot {S}_{4}^{′} & ( 166 \text{-} 4 )\end{matrix}$$

[Expression 67]
(At the curve running time)

$$\begin{matrix}{μ}_{1} = {k}_{d1} / {R}_{1} \cdot {α}_{xc}^{′} / {\sum }_{n = 1}^{4} ( {h}_{n} \cdot {k}_{dn} / {R}_{n} ) \cdot 1 / {k}_{b} \cdot {f}_{1} g \cdot cos β \cdot {S}_{1}^{′} & ( 167 \text{-} 1 ) \\ {μ}_{2} = {k}_{d2} / {R}_{2} \cdot {α}_{xc}^{′} / {\sum }_{n = 1}^{4} ( {h}_{n} \cdot {k}_{dn} / {R}_{n} ) \cdot 1 / {k}_{b} \cdot {f}_{2} g \cdot cos β \cdot {S}_{2}^{′} & ( 167 \text{-} 2 ) \\ {μ}_{3} = {k}_{d3} / {R}_{3} \cdot {α}_{xc}^{′} / {\sum }_{n = 1}^{4} ( {h}_{n} \cdot {k}_{dn} / {R}_{n} ) \cdot 1 / {k}_{b} \cdot {f}_{3} g \cdot cos β \cdot {S}_{3}^{′} & ( 167 \text{-} 3 ) \\ {μ}_{4} = {k}_{d4} / {R}_{4} \cdot {α}_{xc}^{′} / {\sum }_{n = 1}^{4} ( {h}_{n} \cdot {k}_{dn} / {R}_{n} ) \cdot 1 / {k}_{b} \cdot {f}_{4} g \cdot cos β \cdot {S}_{4}^{′} & ( 167 \text{-} 4 )\end{matrix}$$

As calculation is repeated more than once (for example, three times or so) for convergence, the accuracy of μₙ can be enhanced.

Next, the specific correction methods of the longitudinal load are shown for the cases described above.

1. Back-and-forth longitudinal load move caused by pitching

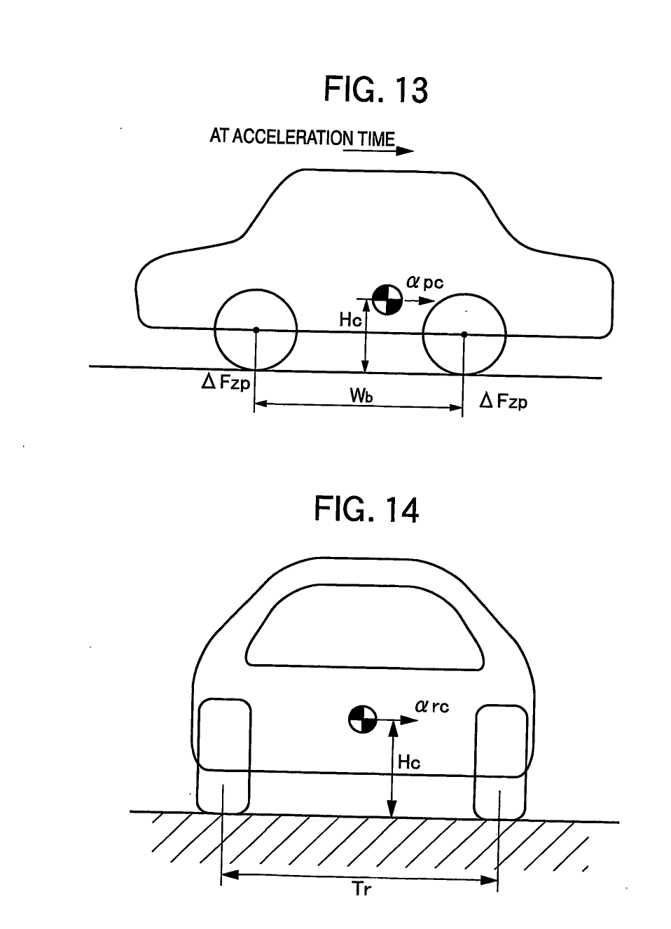

As shown in FIG. 13, letting the center-of-gravity height be H_{c}, the wheel base be W_{b}, and the acceleration contributing to pitching be α_{pc}, from the moment balance, the back-and-forth longitudinal load move caused by pitching, ΔF_{zp} is found from the following expression. Here, H_{c} and W_{b} are known values and how to find α_{pc} is described later.

[Expression 68]
Mα_{pc}H_{c}=ΔF_{zp}W_{b} (168)

Expression (168) is transformed:

[Expression 69]
ΔF_{zp}=Mα_{pc}H_{c}/W_{b} (169)

Change of the back-and-forth load sharing ratio caused by pitching, Δfₚ, is found by dividing ΔF_{zp} found in expression (169) by the vehicle weight M and thus becomes as in the following expression:

[Expression 70]
Δfₚ=ΔF_{zp}/M=α_{pc}H_{c}/W_{b} (170)

At the acceleration time (when α_{pc} is a positive value), the absolute value of Δfₚ is subtracted from the front wheel and is added to the rear wheel for correction. In contrast, at the deceleration time (when α_{pc} is a negative value), the absolute value of Δfₚ is added to the front wheel and is subtracted from the rear wheel for correction. Considering the sign of Δfₚ, correction may be made according to the following expressions at the acceleration time and the deceleration time: (Fₙ′ is a value before correction.)

[Expression 71]

(Front wheel)
f₁=f′₁−Δfₚ (171-1)
f₂=f′₂−Δfₚ (171-2)
(Rear wheel)
f₃=f′₃−Δfₚ (171-3)
f₄=f′₄−Δfₚ (171-4)

2. Side-to-side longitudinal load move caused by rolling

As shown in FIG. 14, letting the center-of-gravity height be H_{c}, the wheel red be Tᵣ, and the acceleration contributing to rolling be α_{rc}, from the moment balance, the side-to-side longitudinal load move caused by rolling, ΔF_{zr} is found from the following expression. Here, H_{c} and Tᵣ are known values and how to find α_{rc} is described later.

[Expression 72]
Mα_{rc}H_{c}=ΔF_{zr}Tᵣ (172)

If expression (172) is transformed, ΔF_{zr} is found from the following expression:

[Expression 73]
ΔF_{zr}=Mα_{rc}H_{c}/Tᵣ (173)

Change of the load sharing ratio of the left and right wheels caused by rolling, Δf_{zr}, is found by dividing ΔF_{zr} by the vehicle weight M and is found as in the following expression:

[Expression 74]
Δfᵣ=ΔF_{zr}/M=α_{rc}H_{c}/Tᵣ (174)

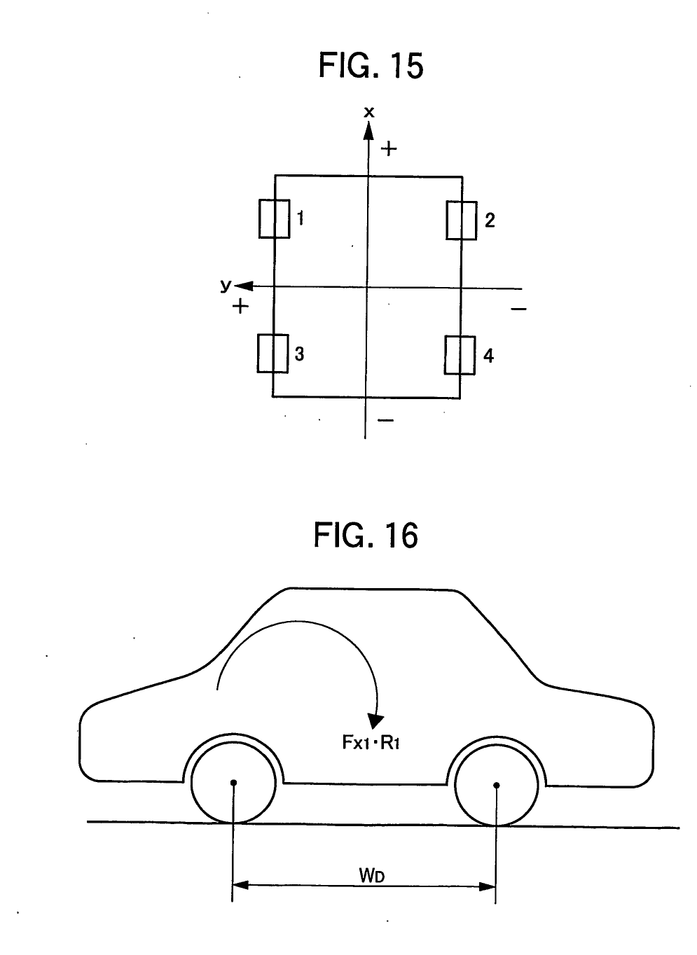

If positive and negative of the x and y directions are determined as shown in FIG. 15, when the vehicle curves in the right direction, α_{rc} becomes a positive value and the absolute value of Δf_{zr} is added to left wheels 1 and 3 and is subtracted from right wheels 2 and 4 for correction.

In contrast, when the vehicle curves in the left direction, α_{rc} becomes a negative value and the absolute value of Δf_{zr} is subtracted from left wheels 1 and 3 and is added to right wheels 2 and 4 for correction. Considering the sign of Δf_{zr}, the change of the load sharing ratio caused by rolling may be corrected according to the following expressions when the vehicle curves in the left direction and in the right direction: fₙ′ is the load sharing ratio of each wheel before correction.

[Expression 75]

(Left wheels)
f₁=f′₁+Δf_{zr} (175-1)
f₂=f′₂+Δf_{zr} (175-2)
(Right wheels)
f₃=f′₃+Δf_{zr} (175-3)
f₄=f′₄+Δf_{zr} (175-4)

3. Back-and-forth longitudinal load move caused by reaction moment of drive force

As shown in FIG. 16, the longitudinal load move of each wheel is also changed by the reaction moment of the drive force acting on each wheel. For example, longitudinal load F_{z1} of wheel 1 is decreased by the reaction moment of drive force Fₓ₁ (ΔF_{1, 1}), and is increased by the reaction moment of drive force Fₓ₃ acting on wheel 3 (ΔF_{1, 3}). Considering the moment balance, the following expressions hold among ΔF_{1, 1,} ΔF_{1, 3}, the real radius R₁ of wheel, and the wheel base W_{b}:

[Expression 76]
Fₓ₁·R₁=W_{b}·ΔF_{1,1} (176-1)
Fₓ₃·R₃=W_{b}·ΔF_{1,3} (176-2)

If expressions (176) are transformed and the relation of Fₓₙ=Mαₓₙ is used,

[Expression 77]
ΔF_{1,1}=Fₓ₁·R₁/W_{b}=Mαₓ₁·₁/W_{b} (177-1)
ΔF_{1,3}=Fₓ₃·R₃/W_{b}=Mαₓ₃·₃/W_{b} (177-2)

The value found in expression (177) is divided by the vehicle weight M and is added to, subtracted from load sharing ratio f₁′ before correction, whereby correction of the back-and-forth load sharing ratio based on the drive force reaction of wheel 1 is made as in the following expression:

[Expression 78]
f₁=f′₁−ΔF_{1,1}/M+ΔF_{1,3}/M=f′₁−(αₓ₁·R₁−αₓ₃·R₃)/W_{b} (178)

Likewise, correction of the back-and-forth load sharing ratio based on the drive force reaction of each wheel is made as in the following expressions:

[Expression 79]
f₁=f′₁−(αₓ₁·R₁−αₓ₃·R₃)/W_{b} (179-1)
f₂=f′₂−(αₓ₂·R₂−αₓ₄·R₄)/W_{b} (179-2)
f₃=f′₃−(αₓ₃·R₃−αₓ₁·R₁)/W_{b} (179-3)
f₄=f′₄−(αₓ₄·R₄−αₓ₂·R₂)/W_{b} (179-4)

4. Change of longitudinal load caused by uneven spots on road surface, etc.

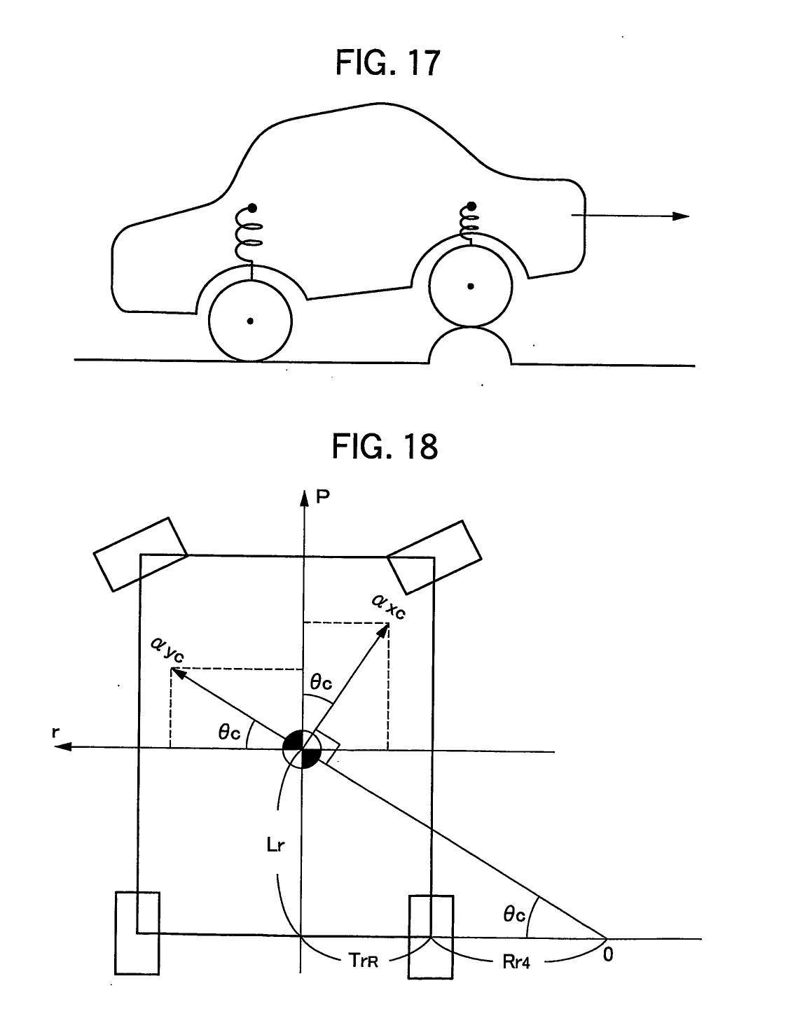

As shown in FIG. 17, when the vehicle passes through uneven spots on the road surface, etc., the suspension acts and thus the longitudinal load of each wheel fluctuates. In this case, z-direction (longitudinal direction) acceleration sensor 221 is attached to each wheel for detecting z-(longitudinal) direction acceleration α_{zn} caused by uneven spots on the road surface, etc., and integration is performed twice in a minute time to find z-(longitudinal) direction displacement e_{z} of each wheel.

[Expression 80]
e_{z}=∫∫α_{z}dt² (180)

The displacement e_{z} found in expression (180) is multiplied by spring constant k of the suspension to find longitudinal load change ΔF_{ze} of each wheel as in the following expression:

[Expression 81]
ΔF_{ez}=ke_{z} (181)

ΔF_{ez} thus found is added to or subtracted from the longitudinal load of each wheel before correction for correction:

Next, a method of finding the acceleration α_{rc}, α_{pc} contributing to pitching, rolling will be discussed.

To find the longitudinal loads of each wheel caused by pitching and rolling, traveling direction acceleration of the center of gravity, α_{xc}, and lateral direction acceleration α_{yc} need to be converted into the pitching and rolling directions, as shown in FIG. 18. Here, the acceleration of the center of gravity is found according to expression (137), expression (141), etc. If turning time angle θ_{c}=0, the traveling time in a straight line can be considered like the curve running time. Here, the turning time angle θ_{c} refers to the angle difference between the center-of-gravity traveling direction and the car body direction and is found from the following expression:

$$\begin{matrix}[ Expression 82 ] & \\ {θ}_{c} = {tan}^{- 1} \frac{{L}_{r}}{{R}_{r4} + {T}_{rR}} & ( 182 )\end{matrix}$$

At this time, the pitching acceleration α_{rc}, the rolling acceleration α_{pc} is found in the following expression from the center-of-gravity acceleration α_{xc}, d_{yc}, and θ_{c}:

[Expression 83]
α_{cp}=α_{cx}·cosθ_{c}+α_{cy}·sin θ_{c} (183-1)
α_{cr}=α_{cy}·cosθ_{c}+α_{cx}·sin θ_{c} (183-2)

α_{rc}, α_{pc} thus found is assigned to expression (170), (174) and correction to the change of the load sharing ratio caused by pitching, rolling is made.

Next, correction of the center-of-gravity position will be discussed.

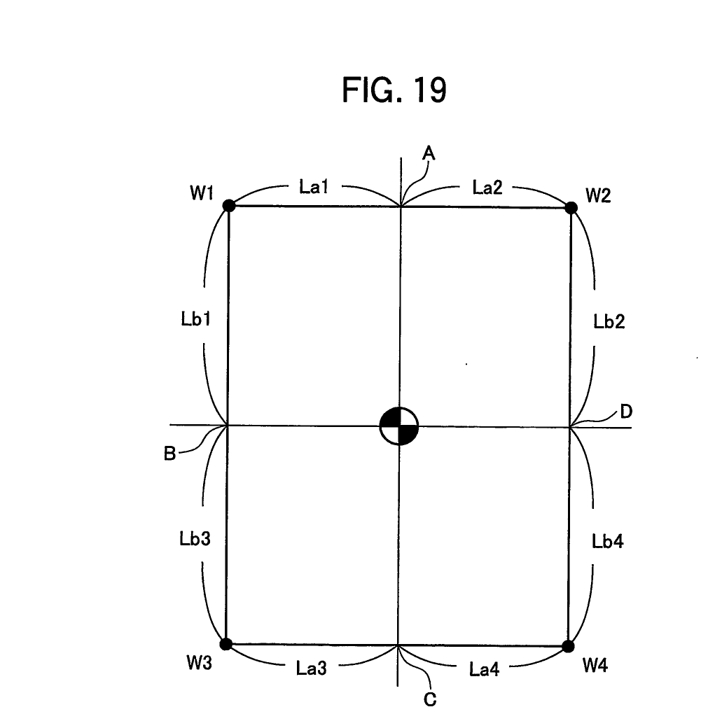

As described above, the load sharing ratio subjected to correction of each wheel is found and thus the center-of-gravity position of the vehicle is found. A method of correcting the center-of-gravity position is as follows: Here, center-of-gravity distribution ratio Lₙ is used. The center-of-gravity distribution ratio has the following relationship with the load sharing ratio, as shown in FIG. 19:

$$\begin{matrix}[ Expression 84 ] & \\ {L}_{a1} \text{:} {L}_{a2} = \frac{1}{{f}_{1}} \text{:} \frac{1}{{f}_{2}} & ( 184 \text{-} 1 ) \\ {L}_{a3} \text{:} {L}_{a4} = \frac{1}{{f}_{3}} \text{:} \frac{1}{{f}_{4}} & ( 184 \text{-} 2 ) \\ {L}_{b1} \text{:} {L}_{b3} = \frac{1}{{f}_{1}} \text{:} \frac{1}{{f}_{3}} & ( 184 \text{-} 3 ) \\ {L}_{b2} \text{:} {L}_{b4} = \frac{1}{{f}_{2}} \text{:} \frac{1}{{f}_{4}} & ( 184 \text{-} 4 )\end{matrix}$$

Points A, B, C, and D in FIG. 19 are found from the center-of-gravity distribution ratio Lₙ. The intersection point of the two lines connecting A and C and B and D is found as the center of gravity. Thus, the center-of-gravity position can also be corrected.

Next, a measurement method of longitudinal load will be discussed.

So far the longitudinal load of each wheel is found from calculation using the load sharing ratio. However, if the load is measured on a pan section, etc., of the suspension, the longitudinal load of each wheel is found with higher accuracy and thus the road friction coefficient of each wheel is found with high accuracy.

(1) Method of measuring load on pan section (which may be disk or ring) of spring of suspension

1. Measuring method with load cell

2. Method of filling a can with oil, placing a spring reception plate on a lid of the can, attaching a pressure sensor to the can, and measuring oil pressure

3. Method of placing a spring pan at the center on a metal disk supporting the circumference, abutting a projection of a pressure sensor against a part below the center on the metal disk, giving displacement to the projection, and measuring as pressure

4. Method of sandwiching pressure sensitive conductive rubber between metal and metal each shaped like a donut shaped like a horizontal U letter in cross section, placing a spring pan thereon, and measuring distortion of the rubber in the electric conductivity of the rubber

(2) Method of measuring displacement of spring of suspension

1. Method of measuring resistance change with a slide resistance displacement gage placed in parallel with a shock absorber

2. Method of winding coil around the inside or outside of a shock absorber and measuring change of inductive resistance (inductance) between the coil and a piston rod going in and out of the coil

3. Method of measuring the move amount in hole element with a magnetic linear encoder contained in a piston rod of a shock absorber

In the method of measuring displacement of spring of suspension, the value provided by multiplying measured displacement e_{z} by spring coefficient k_{z} is the load.

(1) 2. Measurement method of longitudinal load using a pressure sensor particularly among the measurement methods of the longitudinal load of each wheel described above is as follows:

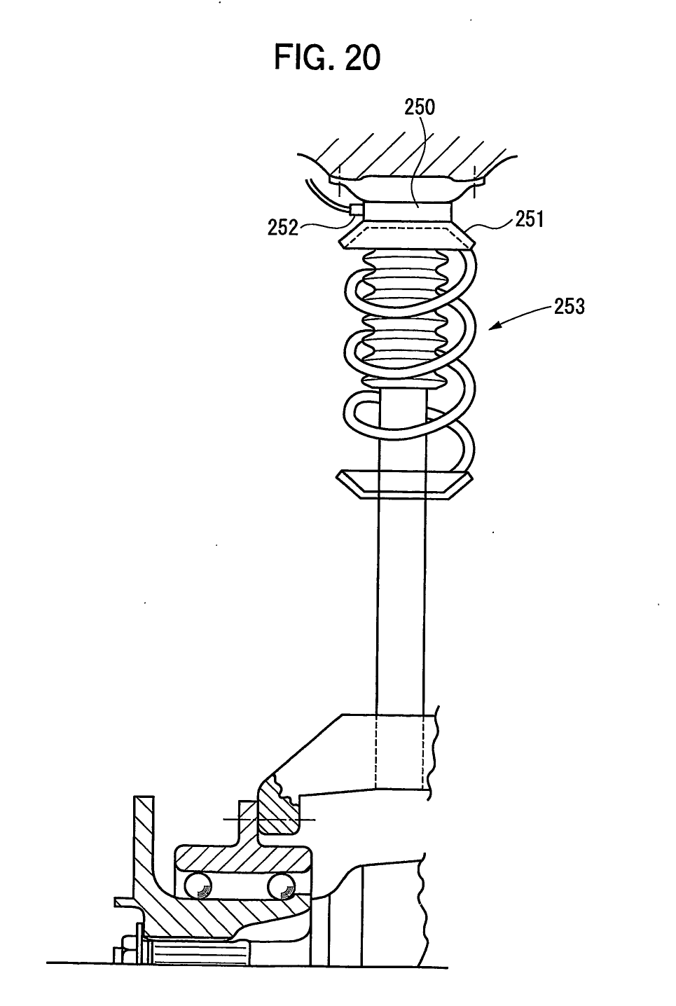

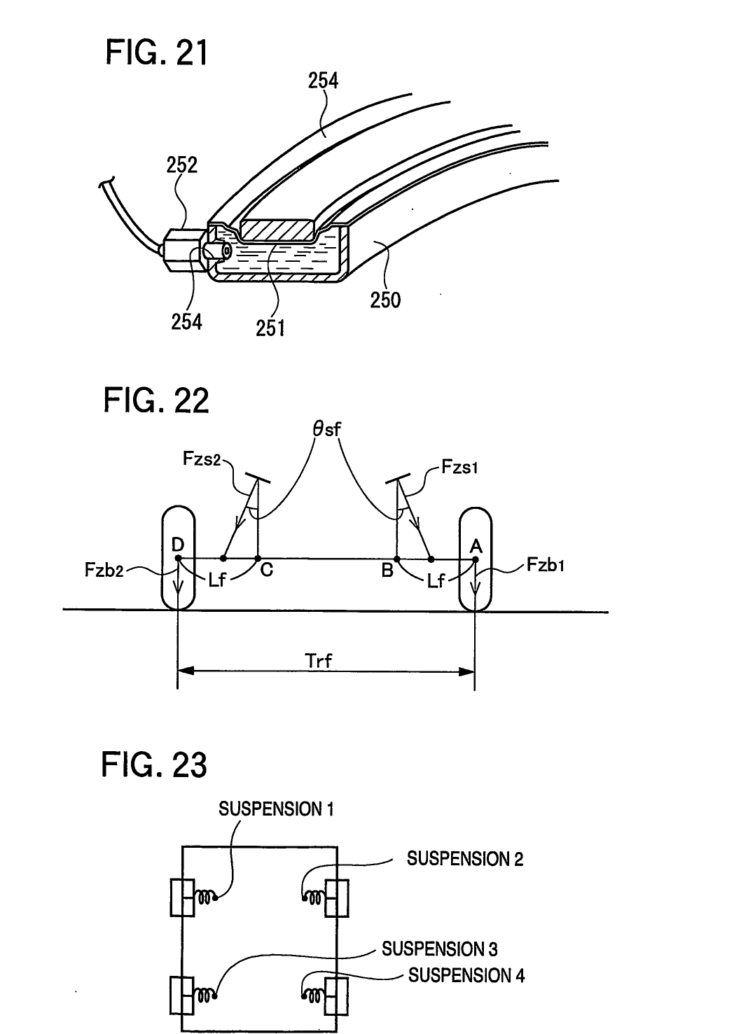

Specifically, as shown in FIGS. 20 and 21, a donut-shaped can 250 with a diaphragm lid on the top is filled with oil, a pressure sensor 252 is attached to a side of the can, and a load reception plate 251 is placed on the can. The donut-shaped can 250 is placed on a pan section 254 of a suspension 253 and load can be measured from output of the pressure sensor 252. The donut-shaped can 250 is threaded as a screw 255 for the pressure sensor and oil is filled therethrough and then the pressure sensor 252 is attached. In the load measurement method, the load reception plate 251 exists over the full periphery and thus if offset load exists, the total value of the longitudinal loads can be measured. If the donut-shaped can 250 is formed with a step, the load reception plate 251 is fitted and becomes stable. Letting the area of the load reception plate 251 be S and the measurement value of the pressure sensor 252 be P, longitudinal load F_{zsn} is found in the following expression:

[Expression 85]
F_{zsn}=S·P (185)

Any of the following sensors can be used as the pressure sensor 252 used with the method:

1. Vehicle-installed pressure sensor manufactured by Nagano keiki kabushikikaisha

This pressure sensor manufactured by Nagano keiki kabushikikaisha is used for a pressure sensitive part formed with a distortion gage by plasma CVD on a metal diaphragm through an insulating film and is excellent in durability and stability. The metal diaphragm is welded to the main body in one piece and thus is fitted for a vehicle-installed part. Further, the metal diaphragm is excellent in vibration resistance and shock resistance because it does not contain any moving part. It can also be miniaturized as the minimum 5 mm and is inexpensive and thus is used as a brake liquid pressure measurement sensor of each wheel or an automobile engine. (Reference patent document: JP-A-2002-168711)

2. Pressure sensor manufactured by kabushikikaisha Denso

This pressure sensor manufactured by kabushikikaisha Denso uses a sensor element having a diffused resistor formed in a thin diaphragm part provided by working silicon. It is a linear output pressure sensor having a wide use temperature range of −30° C. to 120° C., containing a temperature compensation circuit, and involving electromagnetic wave countermeasures. The measurement pressure range is 7 Mpa, which is larger than the possible maximum pressure 5 Mpa received by a suspension pan section to which the pressure sensor is attached. As application examples to automobiles, the pressure sensor is used for refrigerant pressure measurement of an air conditioning system, pressure measurement of a suspension system, etc.

Next, a direction of finding the longitudinal load of each wheel from the direct measurement value of load on the pan section of each suspension is shown. The method is shown with reference to FIG. 22 by taking the left and right front wheels as an example.

As shown in FIG. 22, T_{r, f}, L_{f}, and θ_{sf} are taken and the load measurement value on the suspension pan section of wheel 1 is F_{zs1} and the load measurement value on the suspension pan section of wheel 2 is F_{zs2}. The left and right are considered to be symmetrical. At this time, as the load F_{zs1}, the load proportional to the reciprocal of the distance from the action point is distributed to sprung loads F_{zb1} and F_{zb2} received by wheels 1 and 2.

That is, the load is distributed in proportion to the reciprocal of AB:BD in FIG. 22. Likewise, as the load F_{zs2}, the load proportional to the reciprocal of AC:CD is distributed to wheels 1 and 2 and therefore F_{zb1} and F_{zb2} in FIG. 22 are found according to the following expressions considering θ_{sf}:

$$[ Expression 86 ]$$

$$\begin{matrix}{F}_{zb1} = {F}_{zs1} \cdot cos {θ}_{sf} \frac{{T}_{r , f} - {L}_{f}}{{T}_{r , f}} + {F}_{zs2} \cdot cos {θ}_{sf} \frac{{L}_{f}}{{T}_{r , f}} & ( 186 \text{-} 1 ) \\ {F}_{zb2} = {F}_{zs2} \cdot cos {θ}_{sf} \frac{{L}_{f}}{{T}_{r , f}} + {F}_{zs2} \cdot cos {θ}_{sf} \frac{{T}_{r , f} - {L}_{f}}{{T}_{r , f}} & ( 186 \text{-} 2 )\end{matrix}$$

Likewise, for the rear wheels, F_{zb3} and F_{zb4} are also found from the following expressions:

$$\begin{matrix}[ Expression 87 ] & \\ {F}_{zb3} = {F}_{zs3} \cdot cos {θ}_{sr} \frac{{T}_{r , r} - {L}_{r}}{{T}_{r , r}} + {F}_{zs4} \cdot cos {θ}_{sr} \frac{{L}_{r}}{{T}_{r , r}} & ( 187 \text{-} 1 ) \\ {F}_{zb4} = {F}_{zs4} \cdot cos {θ}_{sr} \frac{{L}_{r}}{{T}_{r , r}} + {F}_{zs4} \cdot cos {θ}_{sr} \frac{{T}_{r , r} - {L}_{r}}{{T}_{r , r}} & ( 187 \text{-} 2 )\end{matrix}$$

Further, unsprung load Wₛₗₙ is added and the longitudinal load F_{zn} of each wheel is found in the following expressions:

[Expression 88]
F_{z1}=F_{zb1}Wₛₗ₁ (188-1)
F_{z2}=F_{zb2}Wₛₗ₂ (188-2)
F_{z3}=F_{zb3}Wₛₗ₃ (188-3)
F_{z4}=F_{zb4}Wₛₗ₄ (188-4)

As an alternative method, considering the correlation among the four wheels, the load measurement on the suspension pan section F_{zsn} and the sprung load F_{zbn} of each wheel are represented by the following expressions using correction coefficient C_{m, n} (m, n=1, 2, 3, 4):

[Expression 89]
F_{zb1}=C_{1,1}F_{zs1}+C_{2,1}F_{zs2}+C_{3,1}F_{zs3}+C_{4,1}F_{zs4} (189-1)
F_{zb2}=C_{1,2}F_{zs1}+C_{2,2}F_{zs2}+C_{3,2}F_{zs3}+C_{4,2}F_{zs4} (189-2)
F_{zb3}=C_{1,3}F_{zs1}+C_{2,3}F_{zs2}+C_{3,3}F_{zs3}+C_{4,3}F_{zs4} (189-3)
F_{zb4}=C_{1,4}F_{zs1}+C_{2,4}F_{zs2}+C_{3,4}F_{zs3}+C_{4,4}F_{zs4} (189-4)

A method of finding the correction coefficient C_{m, n} at this time is shown below with reference to FIG. 23.

To begin with, in a state in which each wheel receives only the load of the vehicle weight, constant load ΔF_{zsn} is added to the suspension sections in order and load fluctuation of each wheel is measured. For example, when ΔF_{zs1} is added to front wheel left suspension 1, if it is considered that the load of suspension 1 is ΔF_{zs1}, relatively it can be considered that the load of suspension 2, 3, 4 is zero. Therefore, F_{zs1}=ΔF_{zs1} and F_{zs2}=F_{zs3}=F_{zs4}=0 in expressions (189) and the correction coefficients C_{1, 1}, C_{1, 2}, C_{1, 3}, and C_{1, 4} are found.

Likewise, if the load ΔF_{zsn} is added to suspension 2, 3, 4, the correction coefficient C_{m, n} is found.

To find the correction coefficient with higher accuracy, if 16 different loads ΔF_{zsn} are appropriately added to the suspension, simultaneous equations made up of 16 expressions are formed and therefore 16 correction coefficients C_{m, n} are found.

Thus, if the values of C_{m, n} are stored, the sprung load F_{zbn} of each wheel is found from the measurement load ΔF_{zsn} on the suspension pan section and further the unsprung load Wₛₗₙ, is added and the longitudinal load F_{zn} of each wheel is found as in the following expressions:

[Expression 90]
F_{z1}=F_{zb1}+Wₛₗ₁ (190-1)
F_{z2}=F_{zb2}+Wₛₗ₂ (190-2)
F_{z3}=F_{zb3}+Wₛₗ₃ (190-3)
F_{z4}=F_{zb4}+Wₛₗ₄ (190-4)

If the longitudinal load F_{zn} of each wheel is found from the measurement load on the suspension section, the road friction coefficient μₙ of each wheel can also be found using the found longitudinal load F_{zn} imposed on each wheel, the slip ratio Sₙ of each wheel, and the inertial force Mα caused by the car body mass M at the traveling time in a straight line. At the curve running time, if the y-(lateral) direction acceleration α_{yn} detected by the acceleration sensor in the lateral direction of each wheel is further used, the road friction coefficient of each wheel can be found. Specifically, the road friction coefficient of each wheel can also be found by solving the following simultaneous equations:

$$\begin{matrix}[ Expression 91 ] & \\ {F}_{x1}^{′} = \frac{1}{{k}_{b}} {μ}_{1} {F}_{z1} \cdot cos β \cdot {S}_{1}^{′} & ( 191 \text{-} 1 ) \\ {F}_{x2}^{′} = \frac{1}{{k}_{b}} {μ}_{2} {F}_{z2} \cdot cos β \cdot {S}_{2}^{′} & ( 191 \text{-} 2 ) \\ {F}_{x3}^{′} = \frac{1}{{k}_{b}} {μ}_{3} {F}_{z3} \cdot cos β \cdot {S}_{3}^{′} & ( 191 \text{-} 3 ) \\ {F}_{x4}^{′} = \frac{1}{{k}_{b}} {μ}_{4} {F}_{z4} \cdot cos β \cdot {S}_{4}^{′} & ( 191 \text{-} 4 ) \\ {F}_{xc}^{′} = M {α}_{xc}^{′} & ( 191 \text{-} 5 ) \\ {h}_{1} {F}_{x1}^{′} + {h}_{2} {F}_{x2}^{′} + {h}_{3} {F}_{x3}^{′} + {h}_{4} {F}_{x4}^{′} = {F}_{xc}^{′} . & ( 191 \text{-} 6 )\end{matrix}$$

At the traveling time in a straight line, the sum of hₙ in expression (191-6),
[Expression 92]

$$[ Expression 92 ] \\ {\sum }_{n = 1}^{4} {h}_{n}$$

becomes 1.

The drive force Fₓₙ and torque Tₙ of each wheel have the following relationship using the real radius Rₙ:

$$\begin{matrix}[ Expression 93 ] & \\ {F}_{xn} = \frac{{T}_{n}}{{R}_{n}} & ( 192 )\end{matrix}$$

If expression (192) is differentiated, it becomes the following expression:

$$\begin{matrix}[ Expression 94 ] & \\ {F}_{xn}^{′} = \frac{{T}_{n}^{′}}{{R}_{n}} & ( 193 )\end{matrix}$$

Using the torque distribution ratio k_{dn}, the torque Tₙ of each wheel is represented using the torque T_{c} of the running gear as follows:

[Expression 95]
T′ₙ=k_{dn}T′_{c} (194)

If expression (189) is differentiated, it becomes the following expression:

[Expression 96]
T′ₙ=k_{dn}T′_{c} (195)

From expressions (188) and (190), Fₓₙ′ can be represented by the following expression:

$$\begin{matrix}[ Expression 97 ] & \\ {F}_{xn}^{′} = \frac{{k}_{dn}}{{R}_{n}} {T}_{c}^{′} & ( 196 )\end{matrix}$$

If this expression is assigned to expression (186-6), the following expression results:

$$\begin{matrix}[ Expression 98 ] & \\ {\sum }_{n = 1}^{4} \frac{{k}_{dn} \cdot {h}_{n}}{{R}_{n}} {T}_{c}^{′} = {F}_{xc}^{′} & ( 197 )\end{matrix}$$

Therefore,

$$\begin{matrix}[ Expression 99 ] & \\ {T}_{c}^{′} = 1 / {\sum }_{n = 1}^{4} \frac{{k}_{dn} \cdot {h}_{n}}{{R}_{n}} \cdot {F}_{xc}^{′} & ( 198 )\end{matrix}$$

If the expression is assigned to expression (191) and expression (186-5) is used, Fₓₙ′ of each wheel can be represented by the following expression:

$$\begin{matrix}[ Expression 100 ] & \\ {F}_{xn}^{′} = {k}_{dn} / {R}_{n} / {\sum }_{n = 1}^{4} \frac{{k}_{dn} \cdot {h}_{n}}{{R}_{n}} \cdot M {α}_{xc}^{′} & ( 199 )\end{matrix}$$

M in expression (194) is found according to the following expression:

$$\begin{matrix}[ Expression 101 ] & \\ M = {\sum }_{n = 1}^{4} {F}_{zn} & ( 200 )\end{matrix}$$

Thus, the unknown is only μₙ in expressions (186-1) to (186-4) and therefore the road friction coefficient of each wheel is found in the following expression:

$$\begin{matrix}[ Expression 102 ] & \\ {μ}_{n} = {k}_{dn} / {R}_{n} / {\sum }_{n = 1}^{4} \frac{{k}_{dn} \cdot {h}_{n}}{{R}_{n}} \cdot M {α}_{xc}^{′} / 1 / {k}_{b} \cdot {F}_{zn} \cdot cos β \cdot {S}_{n} & ( 201 )\end{matrix}$$

If the longitudinal load F_{zn} of each wheel is found from the measurement load on the suspension section, Fₓₙ and F_{yn} of each wheel are found with higher accuracy using the acceleration αₓₙ and the acceleration α_{yn} of each wheel as follows:

$$\begin{matrix}[ Expression 103 ] & \\ {F}_{xn} = \frac{{F}_{zn}}{g} {α}_{xn} & ( 202 \text{-} 1 ) \\ {F}_{yn} = \frac{{F}_{zn}}{g} {α}_{yn} & ( 202 \text{-} 1 )\end{matrix}$$

If the load on the suspension section is measured, the fluctuation of the longitudinal load caused by rolling, pitching, reaction moment of drive force found by calculation is contained in the measurement value and therefore it is made possible to find the road friction coefficient with higher accuracy. Further, in this case, it is made possible to always find the center-of-gravity position with higher accuracy by solving the following expressions with fₙ in expression (184) replaced with F_{zn}:

$$\begin{matrix}[ Expression 104 ] & \\ {L}_{a1} \text{:} {L}_{a2} = \frac{1}{{F}_{z1}} \text{:} \frac{1}{{F}_{z2}} & ( 202 \text{-} 11 ) \\ {L}_{a3} \text{:} {L}_{a4} = \frac{1}{{F}_{z3}} \text{:} \frac{1}{{F}_{z4}} & ( 202 \text{-} 12 ) \\ {L}_{b1} \text{:} {L}_{b3} = \frac{1}{{F}_{z1}} \text{:} \frac{1}{{F}_{z3}} & ( 202 \text{-} 13 ) \\ {L}_{b2} \text{:} {L}_{b4} = \frac{1}{{F}_{z2}} \text{:} \frac{1}{{F}_{z4}} & ( 202 \text{-} 14 )\end{matrix}$$

Next, a control method will be discussed.

To begin with, the control method at the traveling time in a straight line is as follows: At the traveling time in a straight line, the limit slip ratio can be found (predicted) and brake control of ABS, etc., and drive force control of TCS, etc., can be performed.

Here, the limit slip ratio is the slip ratio at which each wheel slips.

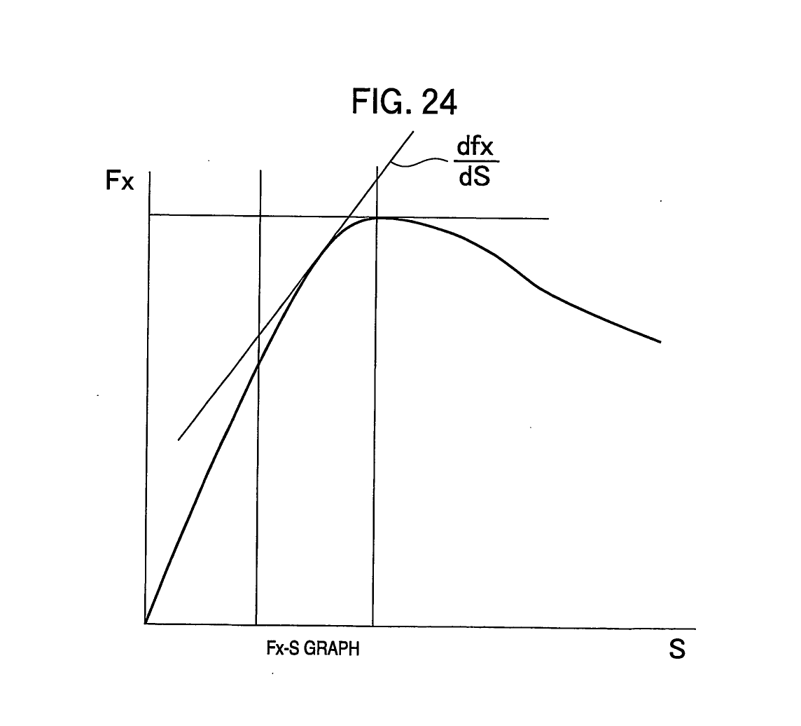

As shown in FIG. 24, if S is small in the Fₓ-S characteristic drawing, Fₓ increases almost linearly with an increase in S and then increases moderately, indicates the maximum value, and decreases.

S when Fₓ indicates the maximum value is the limit slip ratio. If S is greater than that, it indicates a slip state.

Thus, the gradient of the Fₓ-S curve is measured and control is performed so that the limit slip ratio is not exceeded.

Specifically, the gradient of the Fₓ-S curve is measured, namely, is measured. If the slip ratio S is small, the value is almost constant; when the slip ratio S becomes large and approaches the limit slip ratio, dFₓ/dS lessens. Thus, the value of ½, ⅓, ⅕, 1/10, 1/20, etc., of the value of dFₓ/dS, for example, as compared with the preceding calculation value is preset and when the value becomes the setup value, the brake, the engine throttle, or the like is opened/closed, etc., for control.

If the limit slip ratio is obvious, the above-described control may be performed so that the slip ratio S does not exceed the limit slip ratio.

Next, a stability control method at the curve running time is as follows:

At the curve running time, side force F_{gn} also acts in the lateral (g) direction of the wheel and thus the wheels cannot directly be controlled and therefore prediction is conducted and each wheel is prevented from slipping.

As the method, for example, time increase ratio dFw/dt of force Fw acting on each wheel is measured and the force acting in several seconds is predicted. If the force is larger than the force by which each wheel slips, the brake, the engine throttle, or the like is opened/closed, etc., for control.

A specific method is as follows:

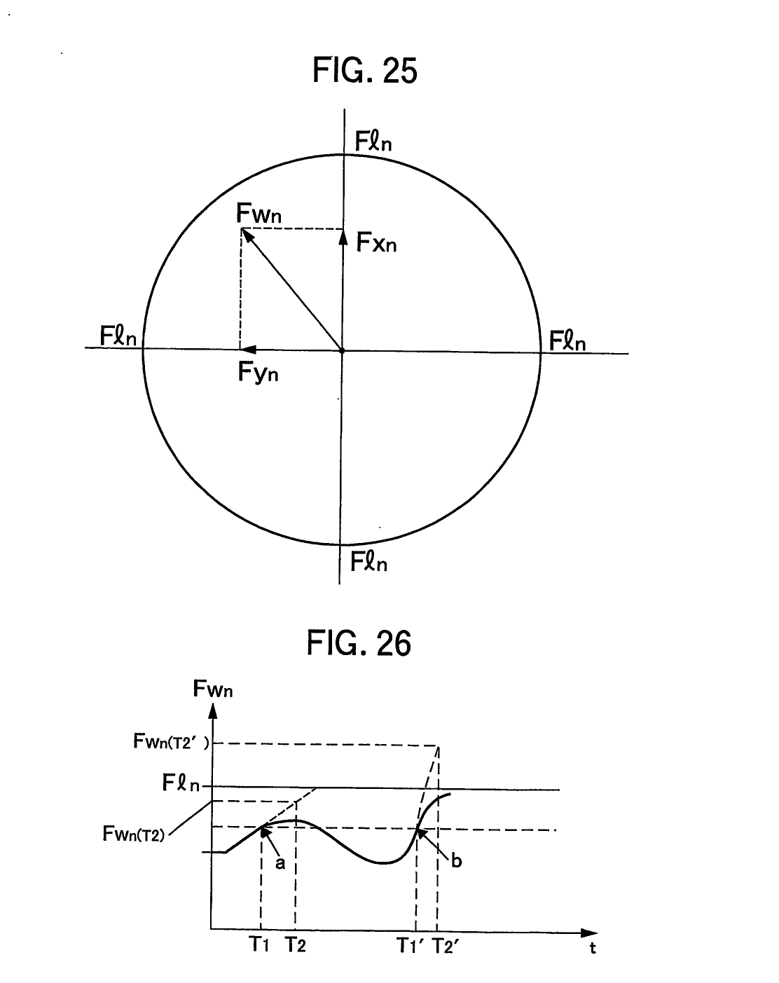

To begin with, the rule of a friction circle is shown. The rule of a friction circle holds at each wheel and indicates the relationship between resultant force F_{wn} of the drive force Fₓₙ of each wheel and side force F_{yn} and slit limit force Fₗₙ, as shown in FIG. 25. That is, when F_{w} becomes larger than the friction circle with radius Fₗₙ, the wheel starts to slip. Here, the force Fₗₙ where each wheel starts to slip is found in the following expression:

[Expression 105]
Fₗₙ=μₙF_{zn}·cos β=μₙfₙMg·cos β (203)

On the other hand, the force acting on each wheel is represented as follows: The drive force Fₓₙ acting in the x direction is found in the following expressions:

$$\begin{matrix}[ Expression 106 ] & \\ {F}_{x1} = \frac{1}{{k}_{b}} {μ}_{1} {F}_{z1} \cdot {S}_{1} = \frac{1}{{k}_{b}} {μ}_{1} {f}_{1} Mg \cdot cos β \cdot {S}_{1} & ( 204 \text{-} 1 ) \\ {F}_{x2} = \frac{1}{{k}_{b}} {μ}_{2} {F}_{z2} \cdot {S}_{2} = \frac{1}{{k}_{b}} {μ}_{2} {f}_{2} Mg \cdot cos β \cdot {S}_{2} & ( 204 \text{-} 2 ) \\ {F}_{x3} = \frac{1}{{k}_{b}} {μ}_{3} {F}_{z3} \cdot {S}_{3} = \frac{1}{{k}_{b}} {μ}_{3} {f}_{3} Mg \cdot cos β \cdot {S}_{3} & ( 204 \text{-} 3 ) \\ {F}_{x4} = \frac{1}{{k}_{b}} {μ}_{4} {F}_{z4} \cdot {S}_{4} = \frac{1}{{k}_{b}} {μ}_{4} {f}_{4} Mg \cdot cos β \cdot {S}_{4} & ( 204 \text{-} 4 )\end{matrix}$$

The side force F_{yn} acting in the y direction of each wheel is found from the following expressions:

[Expression 107]
F_{y1}=f₁α_{y1}M (205-1)
F_{y2}=f₂α_{y2}M (205-2)
F_{y3}=f₃α_{y3}M (205-3)
F_{y4}=f₄α_{y4}M (205-4)

Therefore, the resultant force F_{w} acting on each wheel is found from the following expression:

$$\begin{matrix}[ Expression 108 ] & \\ {F}_{ω n} = \sqrt{{F}_{xn}^{2} + {F}_{yn}^{2}} = \sqrt{{( \frac{1}{{k}_{b}} {μ}_{n} {f}_{n} g \cdot cos β \cdot {S}_{n} )}^{2} + {( {f}_{n} {α}_{yn} )}^{2}} \cdot M & ( 206 )\end{matrix}$$

Thus, the resultant force F_{wn} of each wheel (vector sum of the drive force Fₓₙ and the side force F_{yn}) is found using the slip ratio Sₙ of each wheel, the longitudinal load F_{zn}, and the y-(lateral) direction acceleration α_{yn}. Since no force is received in the y-(lateral) direction at the traveling time in a straight line, the resultant force F_{wn} and the drive force Fₓₙ become equal and the y-(lateral) direction acceleration α_{yn} need not be used. If α_{yn}≅0, the resultant force F_{wn} of each wheel may be found using expression (106).

As is obvious from the rule of a friction circle, if the resultant force F_{wn} is Fln or less at each wheel, the wheel does not slip. Therefore, when the following expression holds, each wheel does not slip:

$$\begin{matrix}[ Expression 109 ] & \\ \sqrt{{( \frac{1}{{k}_{b}} {μ}_{n} g \cdot cos β \cdot {S}_{n} )}^{2} + {( {α}_{yn} )}^{2}} \cdot M \cdot {f}_{n} \leq {μ}_{n} {f}_{n} Mf \cdot cos β & ( 207 )\end{matrix}$$

fₙ and M exist on both sides of expression (202) and thus when fₙ and M disappear and the following expression holds, the wheel does not slip:

$$\begin{matrix}[ Expression 110 ] & \\ \sqrt{{( \frac{1}{{k}_{b}} {μ}_{n} g \cdot cos β \cdot {S}_{n} )}^{2} + {( {α}_{yn} )}^{2}} \leq {μ}_{n} g \cdot cos β & ( 208 )\end{matrix}$$

At the curve running time, control is performed so that expression (203) holds. A specific method is as follows:

As shown in FIG. 26, measurement of (dF_{wn}/dt) _{(T1)} is conducted at time T₁ and force F_{wn(T2)} acting on each wheel at time T₂ in t seconds (for example, 0.5 seconds, 1 seconds, 2 seconds) is predicted as in the following expression:

$$\begin{matrix}[ Expression 111 ] & \\ {F}_{ω n}^{( {T}_{2} )} = {F}_{ω n}^{( {T}_{1} )} + {( \frac{ⅆ {F}_{ω n}}{ⅆ t} )}_{( {T}_{1} )} \cdot t & ( 209 )\end{matrix}$$

When F_{wn(T2)}≧Fₗₙ, the brake, the engine throttle, etc., is controlled at time T₁ for preventing each wheel from slipping.

Referring to FIG. 26, for point a, the gradient (dF_{wn}/dt)_{(T1)} is small and thus F_{wn(T2)}<Fₗₙ at time T₂ and therefore no control is performed; for point b, the gradient (dF_{wn}/dt)_{(T1)} is large and it is predicted that F_{wn(T2)}≧Fₗₙ at time T₂′ and therefore the above-described control is performed.

Next, removal of the effect of kingpin angle (inclination), caster angle, camber angle, yaw angle will be discussed.

If the measurement value of the acceleration sensor 221 is affected by the kingpin angle (inclination), caster angle, camber angle, yaw angle, etc., of the automobile, the experimental value may be previously stored and the effect may be removed.

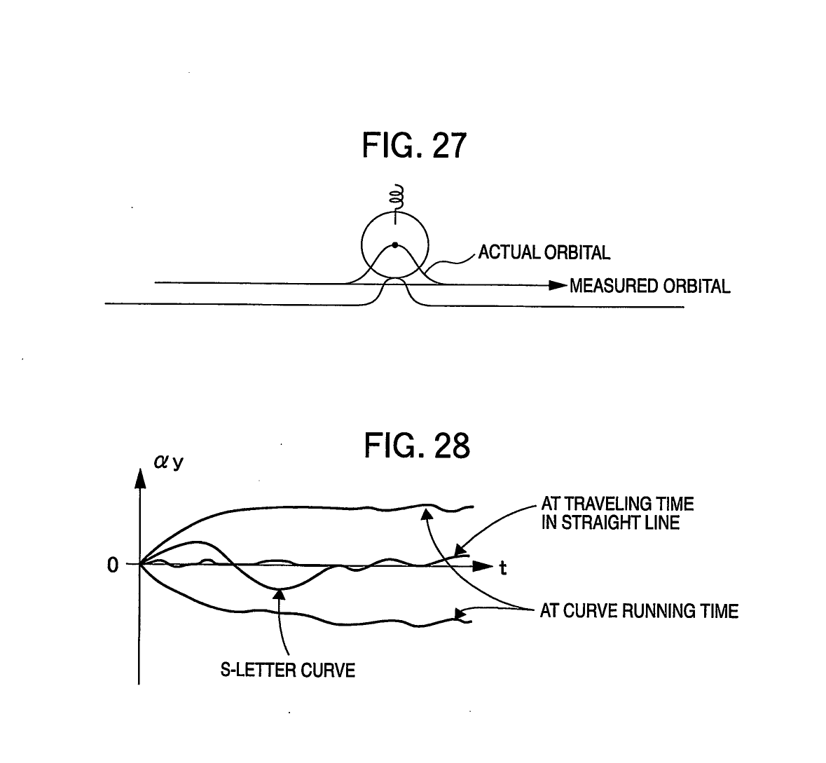

As shown in FIG. 27, when the vehicle passes through uneven spots on the road surface, etc., the suspension expands and contracts, an error occurs in the measurement value, and an error occurs in the ground speed, the slip ratio, etc. In this case, the z-direction acceleration sensor 221 can be attached to each wheel support member (axle unit, also called axle unit), vibration caused by uneven spots on the road surface, etc., can be detected, and correction can be made for finding the ground speed and the slip ratio with high accuracy.

If the z-direction acceleration sensor 221 is also attached to the car body, the difference is measured, whereby the vibration component caused by uneven spots on the road surface, etc., can be removed with higher accuracy.

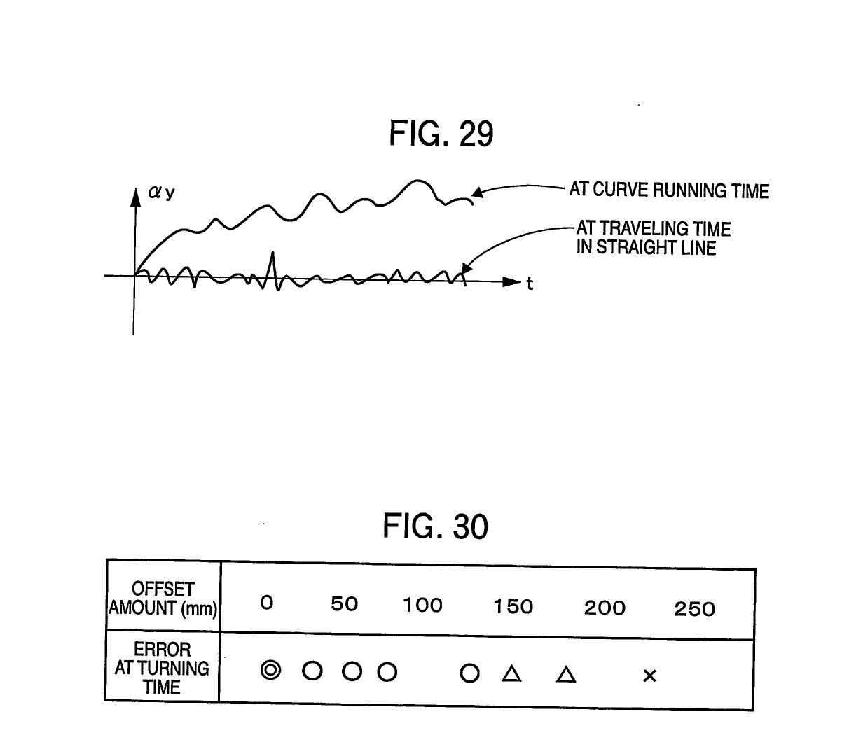

Next, a concept of applying to warning display against dozing at the wheel will be discussed. (Each wheel need not necessarily be provided with) As shown in FIGS. 28 and 29, the y-(lateral) direction acceleration of the vehicle becomes as in FIG. 28 at the traveling time in a straight line, at the curve running time, and on an S-letter curve. However, it is considered that dozing at the wheel becomes as shown in FIG. 29.

Thus, at the traveling time in a straight line and at the curve running time, for an approximate curve for one constant time (a line at the traveling time in a straight line), its deflection and period are measured, and if there is a probability of dozing at the wheel, the driver can be warned of dozing at the wheel.

Next, the acceleration sensor 221 will be discussed.

Generally, it is considered that acceleration of an automobile becomes the maximum at the time of very fast start or harsh braking, which is about ±0.5 G. Thus, the measurement range of an accelerometer needs to be larger than the value. At low speed, high resolution becomes necessary to deal with minute acceleration change; when the vehicle runs at high speed, high responsivity becomes necessary.

The acceleration sensor 221 will be discussed in detail below:

1. ADXL202E manufactured by Analog Devices kabushiki kaisha

This sensor is a two-axis acceleration sensor having a measurement range of ±2 G. It operates at 5 v and outputs a digital signal or an amplified analog signal. The data transfer speed can be varied by a connection capacitor in the range of 0.01 Hz to 5 KHz. The relationship between the responsivity and resolution is as follows: 60 Hz-2 mg, 20 Hz-1 mg, 5 Hz-0.5 mg. Shock resistance is 1000 g and heatresistant temperature is −65° C. to 150° C. High-speed response is possible. The sensor has a small size of 5 mm×5 mm×2 mm and is available at a low price of about 500 yen and is used in various fields. If the two sensors are used, x, y direction acceleration and angular acceleration around the x, y axis can be found.

2. Three-axis acceleration sensor of piezoresistance type manufactured by Hitachi Kinzoku kabushiki kaisha

A stress occurs in piezoresistance by the force produced by the action of acceleration, and acceleration is detected. Three one-axis acceleration sensors and two two-axis acceleration sensors can be assembled for detecting acceleration in three axis directions at the same time and also detecting a gradient. The sensor has a measurement range of ±3 G and has a very small package size of 4.8×4.8×1.25 mm.

3. Three-axis acceleration sensor of piezoresistance type manufactured by Hokuriku Denki Kougyou

This sensor can detect acceleration in three axis directions at the same time like the sensor manufactured by Hitachi Kinzoku. The sensor has a measurement range of ±2 G and has a size of 5.2×5.6×1.35 mm.

(Relevant patent documents) JP-A-2003-240795 JP-A-2002-243759

The acceleration sensors 221 include those of piezoresistance type, capacitance type, piezoelectric type, etc., according to the measurement principle including the above-described acceleration sensors; any of the acceleration sensors may be used in the method.

Next, the sensor attachment position will be discussed.

The acceleration sensor 221 measures the behavior of each wheel and thus ideally is attached to the center part of the tire width. At the traveling time in a straight line, the acceleration sensor may be attached to the axle unit. At the curve running time, if the acceleration sensor deviates from the tire width center, an error occurs in the measured acceleration and thus an error also occurs in the ground speed Vₙ and the slip ratio Sₙ of each wheel. Therefore, it is desirable that the acceleration sensor 221 should be attached within the rim width of the tire wheel.

Various simulations are conducted by changing the attachment position of the acceleration sensor 221 (the distance between the tire center and the acceleration sensor attachment position is the offset amount) and it is found that the acceleration sensor may be attached within a given width from the tire width center at the practical level, as shown in FIG. 30. The offset effect is almost the same on the inside and outside of the car body.

Therefore, it is desirable that the acceleration sensor 221 should be attached within 150 mm from the tire center. If the acceleration sensor 221 cannot be attached within the rim width of the tire wheel or within 150 mm from the tire center, a method of correcting the offset amount from the turning angle of the tire and finding the ground speed Vₙ and the slip ratio Sₙ can also be used as shown below. If the acceleration sensor 221 is attached within the rim width or within 150 mm from the tire center, acceleration can be found with higher accuracy if correction calculation is performed.

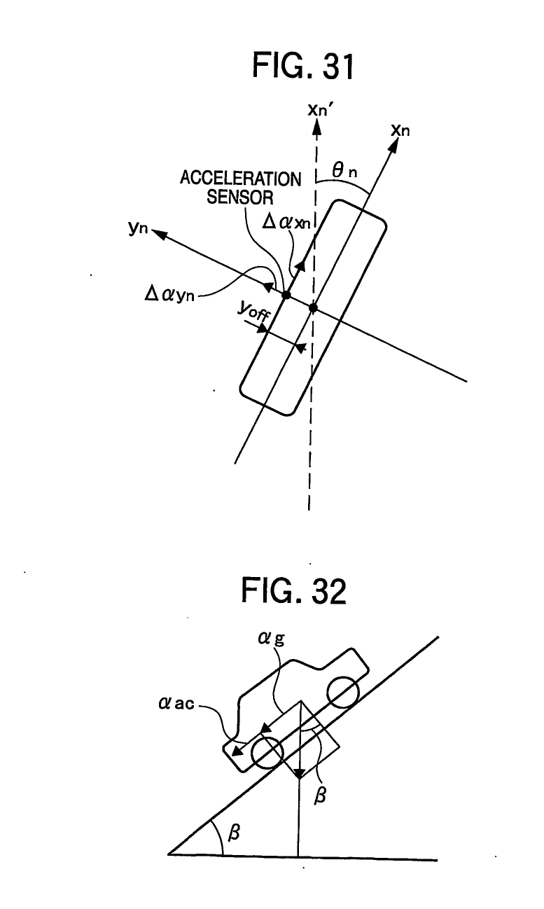

The case where the acceleration sensor 221 is attached to wheel n (n=1, 2, 3, 4) at a position y_{off} (mm) from the tire center as shown in FIG. 31 will be discussed.

When the wheel n travels in Xn′ direction and turns to Xn direction, slip angle θn of each wheel is found from the turn angle of the steering wheel. At this time, at the sensor attachment position, acceleration Δα shown in the following expression acts as compared with the tire center and thus is subtracted for correction.

[Expression 112]
Δα_{Xn}=y_{off}·θₙ¹ (210)
[Expression 113]
Δα_{Yn}=y_{off}·(θ′ₙhu 2 (211)

That is, at the sensor attachment position, acceleration occurs by circular motion with the radius y_{off} with the tire center position as the center. Since circumferential acceleration acts in the Xn direction and centrifugal acceleration occurs in Yn direction, the acceleration found in the expression is subtracted from the measurement value for correction.

Next, the accuracy of the acceleration sensor 221 and the rotation sensor 222 will be discussed.

It is considered that acceleration of an automobile is about ±0.5 g at the time of very fast start or harsh braking and acceleration of each wheel is almost similar to that of the automobile. Thus, assuming that the acceleration to be controlled is in the range of 1 g and that accuracy of 1/200 to 1/500 is required, resolution of 5 mg to 2 mg becomes necessary. For the automobile, acceleration rapidly changes at the time of harsh braking, etc., and if the absolute value of the acceleration is large, high responsivity is required and at low speed time, etc., highly accurate control is required. The acceleration sensor manufactured by Analog Devices has variable responsivity in the range of 0.01 Hz to 5 kHz as the capacitor is changed, and also has resolution that can be changed accordingly. Thus, if the absolute value of the acceleration detected is large, high responsivity is required for the acceleration sensor and thus responsivity may be set to 60 Hz and the resolution at the time becomes 2 mg. The responsivity may further be raised. When high accuracy is required, if the responsivity is set to 5 Hz, the resolution becomes 0.5 mg.

Next, a z-direction accelerometer (angular speed sensor) will be discussed.

As z-direction acceleration is measured,

(1) measurement of road surface gradient; and

(2) measurement of vibration caused by uneven spots on road surface, etc. are made possible. In fact, to measure the road surface gradient, output data of the z-direction acceleration is stored several times and is averaged, whereby fine acceleration data disappears and large acceleration change is output and the road surface gradient is found. In contrast, to measure vibration caused by uneven spots on road surface, etc., averaging processing may be skipped or if averaging processing is performed, the number of data pieces may be lessened. A plurality of accelerometers different in the number of data pieces of the z-direction acceleration to be averaged may be installed. If a three-axis angular sensor, a six-axis motion sensor, etc., is installed, control can be performed with higher accuracy.

Next, a calculation method of the load sharing ratio fₙ of two-axis drive (FF, FR) will be discussed.

For a two-wheel drive car such as FF or FR, the load sharing ratio fₙ is found according to the following method: At the braking time and at the neutral time, namely, when no drive force is transmitted from the running gear of the automobile to each wheel, the braking force Fₓₙ of each wheel is found from the brake liquid pressure of each wheel as shown in FIG. 8. The following expression holds for the braking force Fₓₙ of each wheel and the slip ratio Sₙ:

$$\begin{matrix}[ Expression 114 ] & \\ {F}_{x1} = \frac{1}{{k}_{b}} {μ}_{1} {F}_{z1} \cdot {S}_{1} & ( 212 \text{-} 1 ) \\ {F}_{x2} = \frac{1}{{k}_{b}} {μ}_{2} {F}_{z2} \cdot {S}_{2} & ( 212 \text{-} 2 ) \\ {F}_{x3} = \frac{1}{{k}_{b}} {μ}_{3} {F}_{z3} \cdot {S}_{3} & ( 212 \text{-} 3 ) \\ {F}_{x4} = \frac{1}{{k}_{b}} {μ}_{4} {F}_{z4} \cdot {S}_{4} & ( 212 \text{-} 4 )\end{matrix}$$

If the expressions are transformed, the following expressions result:

$$\begin{matrix}[ Expression 115 ] & \\ {F}_{z1} = {F}_{x1} / \frac{1}{{k}_{b}} {μ}_{1} \cdot {S}_{1} & ( 213 \text{-} 1 ) \\ {F}_{z2} = {F}_{x2} / \frac{1}{{k}_{b}} {μ}_{2} \cdot {S}_{2} & ( 213 \text{-} 2 ) \\ {F}_{z3} = {F}_{x3} / \frac{1}{{k}_{b}} {μ}_{3} \cdot {S}_{3} & ( 213 \text{-} 3 ) \\ {F}_{z4} = {F}_{x4} / \frac{1}{{k}_{b}} {μ}_{4} \cdot {S}_{4} & ( 213 \text{-} 4 )\end{matrix}$$

Here, temporarily the wheels are considered to be equal in friction coefficient, which is μₘ as in the following expression:

[Expression 116]
μₘ=μ₁=μ₂=μ₃=μ₄ (214)

If this expression is assigned to simultaneous equations (213),

$$\begin{matrix}[ Expression 117 ] & \\ {F}_{z1} = {F}_{x1} / \frac{1}{{k}_{b}} {μ}_{m} \cdot {S}_{1} & ( 215 \text{-} 1 ) \\ {F}_{z2} = {F}_{x2} / \frac{1}{{k}_{b}} {μ}_{m} \cdot {S}_{2} & ( 215 \text{-} 2 ) \\ {F}_{z3} = {F}_{x3} / \frac{1}{{k}_{b}} {μ}_{m} \cdot {S}_{3} & ( 215 \text{-} 3 ) \\ {F}_{z4} = {F}_{x4} / \frac{1}{{k}_{b}} {μ}_{m} \cdot {S}_{4} & ( 215 \text{-} 4 )\end{matrix}$$

From these expressions, the load sharing ratio of the wheels is found as follows:

[Expression 118]
f₁:f₂:f₃:f₄=F_{z1}:F_{z2}:F_{z3}:F_{z4}=Fₓ₁/S₁:Fₓ₂/S₂:Fₓ₃/S₃:Fₓ₄/S₄ (216)

The whole braking force is F_{b}=Fₓ₁+Fₓ₂+Fₓ₃+Fₓ₄ and the braking force ratio of the wheels is bₙ.

[Expression 119]
b₁=Fₓ₁/F_{b}, b₂=Fₓ₂/F_{b}, b₃=Fₓ₃/F_{b}, b₄=Fₓ₄/F_{b} (217)

Using the ratio, the load sharing ratio is as follows:

[Expression 120]
f:f₂:f₃:f₄=b₁/S₁:b₂/S₂:b₃/S₃:b₄/S₄ (218)

If coefficient k is multiplied, it is considered that fn=k(bₙ/Sₙ) This is assigned to f₁+f₂+f₃+f₄=1.

$$\begin{matrix}[ Expression 121 ] & \\ k \frac{{b}_{1}}{{S}_{1}} + k \frac{{b}_{2}}{{S}_{2}} + k \frac{{b}_{3}}{{S}_{3}} + k \frac{{b}_{4}}{{S}_{4}} = 1 & ( 219 )\end{matrix}$$

If expression (219) is arranged, k is found as in the following expressions:

$$\begin{matrix}[ Expression 122 ] & \\ k ( \frac{{b}_{1}}{{S}_{1}} + \frac{{b}_{2}}{{S}_{2}} + \frac{{b}_{3}}{{S}_{3}} + \frac{{b}_{4}}{{S}_{4}} ) = 1 & ( 220 ) \\ [ Expression 123 ] & \\ k = 1 / {\sum }_{n = 1}^{4} \frac{{b}_{n}}{{S}_{n}} & ( 221 )\end{matrix}$$

Since k is found, the load sharing ratio of the wheels is found as follows:

$$\begin{matrix}[ Expression 124 ] & \\ {f}_{1} = \frac{{b}_{1}}{{S}_{1}} / {\sum }_{n = 1}^{4} \frac{{b}_{n}}{{S}_{n}} & ( 222 \text{-} 1 ) \\ {f}_{2} = \frac{{b}_{2}}{{S}_{2}} / {\sum }_{n = 1}^{4} \frac{{b}_{n}}{{S}_{n}} & ( 222 \text{-} 2 ) \\ {f}_{3} = \frac{{b}_{3}}{{S}_{3}} / {\sum }_{n = 1}^{4} \frac{{b}_{n}}{{S}_{n}} & ( 222 \text{-} 3 ) \\ {f}_{4} = \frac{{b}_{4}}{{S}_{4}} / {\sum }_{n = 1}^{4} \frac{{b}_{n}}{{S}_{n}} & ( 222 \text{-} 4 )\end{matrix}$$

The road friction coefficients of the wheels are found in the following expression:

$$\begin{matrix}[ Expression 125 ] & \\ {μ}_{1} = {F}_{x1} / \frac{1}{{k}_{b}} {f}_{1} Mg \cdot cos β \cdot {S}_{1} & ( 223 \text{-} 1 ) \\ {μ}_{2} = {F}_{x2} / \frac{1}{{k}_{b}} {f}_{2} Mg \cdot cos β \cdot {S}_{2} & ( 223 \text{-} 2 ) \\ {μ}_{3} = {F}_{x3} / \frac{1}{{k}_{b}} {f}_{3} Mg \cdot cos β \cdot {S}_{3} & ( 223 \text{-} 3 ) \\ {μ}_{4} = {F}_{x4} / \frac{1}{{k}_{b}} {f}_{4} Mg \cdot cos β \cdot {S}_{4} & ( 223 \text{-} 4 )\end{matrix}$$

If the liquid pressure at the braking time of each wheel is unknown, the braking force acting on each wheel may be assumed to be equal Fₓ₁=Fₓ₂=Fₓ₃=Fₓ₄=1/F_{xb}, the load sharing ratio may be found, and the road friction coefficients may be found. If the electric system (power supply) of the automobile is turned off as the engine is switched off, etc., the value of the load sharing ratio is also stored for use at the later calculation time.

Next, alternative methods of finding the slip ratio will be discussed.

The following methods are also available as alternative methods of finding the speed of each wheel and the slip ratio:

(1) Integration method

Speed change ΔV_{α} is found from true acceleration αₓ, found by excluding the gravity effect from output of the acceleration sensor 221 within minute time Δt. On the other hand, change Δω of the rotation angular speed is found from output ω of the rotation sensor 222, and the virtual radius r of each wheel is found from the ratio between ΔV_{α} and Δω. To begin with, speed change ΔV_{α} in minute time Δt from time t₁ to t₂ is found in the following expression from αₓ:

[Expression 126]
ΔV_{α}=∫ₜ₁^{t2}αₓdt (224)

Next, rotation speed change Δω in minute time Δt from time t₁ to t₂ is found in the following expression from output ω of the rotation sensor 222:

[Expression 127]
Δω=ωₜ₂−ωₜ₁ (225)

From the ratio between these two expressions, the virtual radius r of each wheel is found according to the following expression:

[Expression 128]
r=ΔV_{α}/Δω=∫ₜ₁^{t2}αₓdt/ωₜ₂−ωₜ₁ (226)

When the ratio of r in the expression is constant independently of the time and is not zero, the ground speed V of each wheel is found in the following expression:

[Expression 129]
V=rω=∫ₜ₁^{t2}αₓdt/(ωₜ₂−ωₜ₁)·ω (227)

When the ratio of r starts to change, if the time is t₁ and the ground speed at the time is Vₜ₁, the ground speed in time t is found in the following expression:

[Expression 130]
V=Vₜ₁+∫ₜ₁^{t}αₓdt (228)

The tire real radius R of each wheel in the neutral state of the vehicle as described above is found in the following expression:

$$\begin{matrix}[ Expression 131 ] & \\ R = \frac{V}{ω} & ( 229 )\end{matrix}$$

The neutral state as described above in expression (112) is when the following expression holds:

[Expression 132]
α+g·sniβ≅0 (230)

Using V and R thus found, the slip ratio S of each wheel is found and the slip state of each wheel is known.

[Expression 133]
S=1−V/Rω (231)
[Expression 134]
S=1−Rω/V (232)

The ratio between αₓ and output of the rotation sensor 222 is represented. For the virtual radius r, move distance ΔL may be found from twice integration of acceleration in minute time Δt from t₁ to t₂ and rotation angle Δθ may be found from one integration of the rotation sensor 222 as represented in the following expression. The rotation angle Δθ may be found as the rotation angle difference.

$$\begin{matrix}[ Expression 135 ] & \\ r = Δ L / Δ θ = \int {\int }_{t1}^{t2} α ⅆ {t}^{2} / {\int }_{t1}^{t2} ω ⅆ t = \int {\int }_{t1}^{t2} α ⅆ {t}^{2} / {θ}_{t2} - {θ}_{t1} & ( 233 )\end{matrix}$$

(2) Combining method

If the vehicle has a driven wheel, the slip ratio of the driven wheel is zero at the driving time and therefore the slip state of each wheel is known according to the following method:

To begin with, at the traveling time in a straight line on a flatland, at low speed, or at lowered speed, the four wheels are at the same ground speed and the ground speed of each wheel is found from the following expressions using the real radius R:

[Expression 136]
Vₓ₁=ₓ₂=Vₓ₃=Vₓ₄ (234-1)
Vₓ₁=R₁ω₁ (234-2)
Vₓ₂=R₂ω₂ (234-3)
Vₓ₃=R₃ω₃ (234-4)
Vₓ₄=R₄ω₄ (234-5)

Here, it is assumed that wheels 1 and 2 are driven wheels and the real radius R of wheel 1 is used as the reference radius. From the expressions, the real radius R of each wheel is represented by the following expressions from R₁ and the rotation angular speed ω. Here, N of a subscript indicates the neutral state.

[Expression 137]
R₁=R₁ (235-1)
R₂=(ω₁/ω₂)_{N}·R₁ (235-2)
R₃=(ω₁/ω₃)_{N}·R₁ (235-3)
R₄=(ω₁/ω₄)_{N}·R₁ (235-4)

From these expressions, the real radius Rₙ of each wheel is found as the ratio of R₁.

Next, at the traveling time in a straight line not under the above-mentioned conditions, if the virtual radius r of each wheel is used, the following expressions hold:

[Expression 138]
Vₓ₁=Vₓ₂=Vₓ₃=Vₓ₄ (236-1)
Vₓ₁=r₁ω₁ (236-2)
Vₓ₂=r₂ω₂ (236-3)
Vₓ₃=r₃ω₃ (236-4)
Vₓ₄=r₄ω₄ (236-5)

Thus, the virtual radius r of each wheel at the traveling time in a straight line is represented by the following expressions using r₁ of wheel 1:

[Expression 139]
r₁=r₁ (237-1)
r₂=(ω₁/ω₂)_{N}·r₁ (237-2)
r₃=(ω₁/ω₃)_{N}·r₁ (237-3)
r₄=(ω₁/ω₄)_{N}·r₁ (237-4)

At this time, the following expressions hold for the virtual radiuses of driven wheels 1 and 2 because the slip ratio is 0:

[Expression 140]
r₁=R₁ (238-1)
r₂=R₂=(ω₁/ω₂)_{N}·R₁ (238-2)

The virtual radiuses of drive wheels 3 and 4 are found in the following expressions using R₁:

[Expression 141]
r₃=(ω₁/ω₃)_{N}·R₁ (239-1)
r₄=(ω₁/ω₄)_{N}·R₁ (239-2)

Thus, if R₁ is determined, the ground speed Vₙ at the traveling time in a straight line is found in the following expressions:

[Expression 142]
V₁=r₁ω₁ (240-1)
V₂=r₂ω₂ (240-2)
V₃=r₃ω₃ (240-3)
V₄=r₄ω₄ (240-4)

The slip ratio Sₙ of each wheel is found in the following expressions:

[Expression 143]
S₁=0 (241-1)
S₂=0 (241-2)
S₃=1−r₃/R (241-3)
S₄=1−r₄/R (241-4)

Next, the curve running time will be discussed.

At the curve running time, Vₓ₁=Vₓ₂=Vₓ₃=Vₓ₄ does not hold and therefore the virtual radius is found in the following method. Since the driven wheel has a slip ratio of 0, the following expressions hold:

[Expression 144]
r₁=R₁ (242-1)
r₂=R₂=(ω₁ω₂)_{N}·R₁ (242-2)

For drive wheel 3, 4, if the acceleration is integrated and is added to the value Vₓ₃ before integration to find the ground speed V,

$$\begin{matrix}[ Expression 145 ] & \\ {V}_{x3} = {V}_{x3}^{′} + {\int }_{t1}^{t2} α ⅆ t & ( 243 \text{-} 1 ) \\ {V}_{x4} = {V}_{x4}^{′} + {\int }_{t1}^{t2} α ⅆ t & ( 243 \text{-} 1 )\end{matrix}$$

However, Vₓₙ is based on R₁ and thus is not real speed. If the real radius R₁ is found by a differentiation method, an integration method, or any other method, Vₓₙ can be found with higher accuracy.

The ground speed Vₙ of each wheel is divided by the rotation angular speed ω to find the virtual radius r.

[Expression 146]
r₃=Vₓ₃/ω₃ (244-1)
r₄=Vₓ₄/ω₄ (244-2)
The slip state of each wheel is thus known using the real radius Rₙ of each wheel and the virtual radius rₙ. Expressions of finding the slip ratio of each wheel are as follows:
[Expression 147]
S₁=0 (245-1)
S₂=0 (245-2)
S₃1−₃/R (245-3)
S₄1−₄/R₄ (245-4)

Although the first embodiment of the invention is described, it is to be understood that the invention is not limited to the embodiment and modification and improvement of the invention can be made as appropriate, of course.

For example, for two-wheel drive, at the traveling time of the vehicle in a straight line, circumferential speed Vcf of a driven wheel is car body speed Vd and slip ratio λd of a drive wheel is found from the car body speed Vd and circumferential speed Vcd of the drive wheel, whereby the slip ratio of the drive wheel can always be measured in real time. Accordingly, also at the driving time, the throttle valve can be closed and differential control can be performed for performing traction control so that the ideal slip ratio is not exceeded.

In the embodiment described above, the case of a single wheel is taken as an example. However, the invention can also be applied to a sub-wheel structure (so-called double tires, etc.,) with a plurality of wheels combined such as a truck. In this case, the acceleration sensor 221 is placed in the rim width between outer and inner rims with the plurality of wheels combined.

### APPLICATION EXAMPLE 1

A wheel slip measurement method of using an acceleration sensor and a wheel rotation sensor, attached to each axle unit of a vehicle and combining the number of revolutions detected by the rotation sensor and the acceleration detected by the acceleration sensor to find a slip state of the axle unit.

### APPLICATION EXAMPLE 2

A method of using an acceleration sensor in the traveling direction of each wheel and a wheel rotation sensor, attached to each axle unit of a vehicle and combining rotation angular speed ω detected by the rotation sensor and acceleration α detected by the acceleration sensor to find ground speed V of each wheel according to V=(α/ωα)·ω.

### APPLICATION EXAMPLE 3

A method in application example 2 wherein as the acceleration, for an acceleration sensor using a force produced by acceleration and measuring the acceleration, true acceleration α is found according to α=αₐ+g sinβ using output αₐ of the acceleration sensor, road surface gradient angle β, and gravity acceleration

### APPLICATION EXAMPLE 4

In application example 2 or 3, a method of finding V when α/ω′ is almost constant.

### APPLICATION EXAMPLE 5

In application example 2 or 3, a method of finding ground speed V of each wheel according to V=(α/ω′)·ω′ when α/ω′ is almost constant, finding ground speed V of each wheel according to

$$V = {V}_{t1} + {\int }_{t1}^{t2} α ⅆ t \qquad [ Expression 148 ]$$

whenαx/ω′ does not become almost constant, and finding real radius R of each wheel (tire) according to R=V/ω.

### APPLICATION EXAMPLE 6

In application example 5, a method of finding the real radius R of each wheel when a neutral state is entered, namely, when the true acceleration α, the gravity acceleration g, and the road surface gradient angle β become the relation of α=−g sinβ.

### APPLICATION EXAMPLE 7

In application example 5 or 6, a method of finding slip ratio S according to S=1−V/(R·ω) at the driving time and finding slip ratio S according to S=1−(R·ω)/V at the braking time.

### APPLICATION EXAMPLE 8

A method of finding road friction coefficient μ of each wheel and drive force Fₓ of each wheel using slip ratio Sₙ of each wheel, longitudinal load F_{z} imposed on each wheel, and inertial force Mα caused by car body mass M.

### APPLICATION EXAMPLE 9

A method of finding road friction coefficient μ of each wheel and resultant force F_{ω} of drive force Fₓ of each wheel and side force of each wheel using output α_{y} of an acceleration sensor in a lateral direction of each wheel attached to each axle unit of a vehicle, slip ratio S of each wheel, longitudinal load F_{z} imposed on each wheel, and inertial force M_{α} caused by car body mass M at the curve running time.

### APPLICATION EXAMPLE 10

A method of using an acceleration sensor in the traveling direction of each wheel, attached to each axle unit of a wheel and a rotation sensor of a wheel and combining rotation angular speed ω detected by the rotation sensor and acceleration α detected by the acceleration sensor to find ground speed V of each wheel according to

$$V = r ω = {\int }_{t1}^{t2} α ⅆ t / ( {ω}_{t2} - {ω}_{t1} ) \cdot ω \qquad [ Expression 149 ]$$

or finding the ratio between

$${\int }_{t1}^{t2} α ⅆ t \qquad [ Expression 150 ]$$

and (ωₜ₂−θₜ₁) for controlling each wheel.

### APPLICATION EXAMPLE 11

A method of using an acceleration sensor in the traveling direction of each wheel, attached to each axle unit of a wheel having a driven wheel and a rotation sensor of a wheel and combining rotation angular speed ω detected by the rotation sensor, acceleration α detected by the acceleration sensor, the real radius of the driven wheel, and the number of revolutions of the driven wheel to find ground speed V of each wheel and slip ratio S.

### APPLICATION EXAMPLE 12

A vehicle using the method described in application example 1.

### APPLICATION EXAMPLE 13

A vehicle using the method described in application example 2.

### APPLICATION EXAMPLE 14

A vehicle using the method described in application example 3.

### APPLICATION EXAMPLE 15

A vehicle using the method described in application example 4.

### APPLICATION EXAMPLE 16

A vehicle using the method described in application example 5.

### APPLICATION EXAMPLE 17

A vehicle using the method described in application example 6.

### APPLICATION EXAMPLE 18

A vehicle using the method described in application example 7.

### APPLICATION EXAMPLE 19

A vehicle using the method described in application example 8.

### APPLICATION EXAMPLE 20

A vehicle using the method described in application example 9.

### APPLICATION EXAMPLE 21

A vehicle using the method described in application example 10.

### APPLICATION EXAMPLE 22

A vehicle using the method described in application example 11.

### APPLICATION EXAMPLE 23

An axle unit or a rolling bearing unit for axle support having an acceleration sensor for measuring acceleration in the traveling direction of a wheel and a rotation sensor for measuring the rotation angular speed of the wheel.

### APPLICATION EXAMPLE 24

The axle unit or the rolling bearing unit for axle support described in application example 23 wherein the acceleration sensor is placed inside in the axial direction from a rotation wheel.

### APPLICATION EXAMPLE 25

The axle unit described in application example 23 wherein the acceleration sensor is placed within the rim width of the wheel.

### APPLICATION EXAMPLE 26

The rolling bearing unit for axle support described in application example 23 wherein the acceleration sensor is placed within the rim width of the wheel.

### APPLICATION EXAMPLE 27

The axle unit described in application example 23 wherein the acceleration sensor is placed within 150 mm in the axial direction from the center (center line) of the rim width of the wheel.

### APPLICATION EXAMPLE 28

The rolling bearing unit for axle support described in application example 23 wherein the acceleration sensor is placed within 150 mm in the axial direction from the center (center line) of the rim width of the wheel.

### APPLICATION EXAMPLE 29

The axle unit described in application example 23 wherein output when the acceleration sensor is installed offset relative to the center (center line) of the rim width of the wheel is corrected by calculation.

### APPLICATION EXAMPLE 30

The rolling bearing unit for axle support described in application example 23 wherein output when the acceleration sensor is installed offset relative to the center (center line) of the rim width of the wheel is corrected by calculation.

### APPLICATION EXAMPLE 31

A rotation speed measurement apparatus or method of each wheel of a vehicle characterized in that each pitch error of one revolution of a rotation speed detection encoder of the wheel is stored and the rotation speed or the rotation angle is found while the pitch error is corrected at the measurement time.

### APPLICATION EXAMPLE 32

In application example 31, apparatus or method characterized in that the rotation speed detection encoder is provided with at least one reference pitch different in pitch error and each pitch error is stored in the measurement apparatus for correction based on the reference pitch.

### APPLICATION EXAMPLE 33

A vehicle control apparatus having an acceleration sensor for detecting the acceleration of a wheel of a vehicle and a number-of-revolutions detection sensor for detecting the number of revolutions of the wheel for finding the ground speed of the wheel based on the number of revolutions of the wheel detected by the number-of-revolutions detection sensor and the acceleration of the wheel detected by the acceleration sensor.

### APPLICATION EXAMPLE 34

A vehicle having a wheel unit having a stationary member, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, and an acceleration sensor being attached to the stationary member for outputting an acceleration signal responsive to the acceleration in the traveling direction of the wheel unit, a trigger signal generation unit for generating a trigger signal in response to braking of the vehicle, a storage unit for storing the circumferential speed of the wheel as the speed of an axle when the trigger signal is generated or in response to the signal from the rotation sensor before the trigger signal is generated, an integration unit for integrating the acceleration based on the acceleration signal output from the acceleration sensor from the detection time to find additional axle speed, a calculation unit for calculating the slip ratio from the additional axle speed and new detected circumferential speed of the wheel, and a brake control unit for controlling braking based on the provided slip ratio.

### APPLICATION EXAMPLE 35

A control method of a vehicle having the step of storing the circumferential speed of wheel as the speed of an axle when the trigger signal is generated or in response to the signal from the rotation sensor before the trigger signal is generated, the step of integrating the acceleration based on the acceleration signal output from the acceleration sensor from the detection time to find additional axle speed, the step of calculating the slip ratio from the additional axle speed and new detected circumferential speed of the wheel, and the step of controlling braking based on the provided slip ratio, the control method using a wheel unit having a stationary member, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, and an acceleration sensor being attached to the stationary member for outputting an acceleration signal responsive to the acceleration in the traveling direction of the wheel unit, and a trigger signal generation unit for generating a trigger signal in response to braking of the vehicle.

### APPLICATION EXAMPLE 36

A wheel unit having a stationary member, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, and an acceleration sensor being attached to the stationary member for outputting an acceleration signal responsive to the acceleration in the traveling direction of wheel, characterized in that the acceleration sensor is placed in the rim width of the wheel.

### APPLICATION EXAMPLE 37

A rolling bearing unit for wheel support having a stationary wheel, a rotation wheel, a plurality of rolling elements being placed between the stationary wheel and the rotation wheel, a sensor rotor being attached to the rotation wheel, a rotation speed sensor being attached to the stationary wheel so as to be opposed to the sensor rotor for outputting a rotation speed signal responsive to the rotation speed of the sensor rotor, and an acceleration sensor being attached to the stationary wheel for outputting an acceleration signal responsive to the acceleration in the traveling direction of wheel, characterized in that the acceleration sensor is placed in the rim width of the wheel.

### APPLICATION EXAMPLE 38

A wheel unit having a stationary member, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, and an acceleration sensor being attached to the stationary member for outputting an acceleration signal responsive to the acceleration in the traveling direction of wheel, characterized in that the acceleration sensor is placed in the rim width of the wheel or within 150 mm in the axial direction from the center line of the rim width of the wheel.

### APPLICATION EXAMPLE 39

A rolling bearing unit for wheel support having a stationary wheel, a rotation wheel, a plurality of rolling elements being placed between the stationary wheel and the rotation wheel, a sensor rotor being attached to the rotation wheel, a rotation speed sensor being attached to the stationary wheel so as to be opposed to the sensor rotor for outputting a rotation speed signal responsive to the rotation speed of the sensor rotor, and an acceleration sensor being attached to the stationary wheel for outputting an acceleration signal responsive to the acceleration in the traveling direction of wheel, characterized in that the acceleration sensor is placed in the rim width of the wheel or within 150 mm in the axial direction from the center line of the rim width of the wheel.

### APPLICATION EXAMPLE 40

A wheel unit having a stationary member of the wheel unit below a spring of a vehicle suspension, a rotation member being rotatable relative to the stationary member, a sensor rotor being attached to the rotation member, a rotation speed sensor being attached to the stationary member so as to be opposed to the sensor rotor for outputting a rotation speed signal responsive to the rotation speed of the sensor rotor, a semiconductor acceleration sensor being attached to the stationary member for outputting an acceleration signal responsive to the acceleration in the traveling direction of wheel, and an acceleration signal processing unit being attached to the wheel unit for processing the acceleration signal in the form of receiving no effect of wiring deformation and outputting the provided signal to a controller of a car body.

### APPLICATION EXAMPLE 41

A slip ratio measurement method of, at the preliminary running time of a vehicle as a drive force or a braking force does not act on a tire in a wheel, detecting preliminary traveling acceleration in the traveling direction of the wheel and preliminary rotation angular speed of the wheel, differentiating the preliminary rotation angular speed to find preliminary rotation angular acceleration of the wheel, finding the tire radius of the wheel from the preliminary rotation angular acceleration and the preliminary traveling acceleration and then at the real running time of the vehicle, further detecting real traveling acceleration in the traveling direction of the wheel and real rotation angular speed of the wheel, differentiating the real rotation angular speed to find real rotation angular acceleration of the wheel, finding the ratio between an apparent tire radius found by assuming the slip ratio to be zero and the tire radius at the preliminary running time from the real rotation angular acceleration and the real traveling acceleration, and providing the ratio as the slip ratio of the tire.

### APPLICATION EXAMPLE 42

A slip ratio measurement method of, at the preliminary running time of a vehicle as a drive force or a braking force does not act on a tire in a wheel, detecting preliminary traveling acceleration in the traveling direction of the wheel and preliminary rotation angular speed of the wheel, differentiating the preliminary rotation angular speed to find preliminary rotation angular acceleration of the wheel, integrating the preliminary traveling acceleration and the preliminary rotation angular acceleration per unit time, finding the tire radius of the wheel from the increment of the preliminary traveling speed and the preliminary rotation angular speed per unit time and then at the real running time of the vehicle, further detecting real traveling acceleration in the traveling direction of the wheel and real rotation angular speed of the wheel, differentiating the real rotation angular speed to find real rotation angular acceleration of the wheel, integrating the real traveling acceleration and the real rotation angular acceleration per unit time, finding the ratio between an apparent tire radius found by assuming the slip ratio to be zero and the tire radius at the preliminary running time from the increment of the real traveling speed and the real rotation angular speed per unit time, and providing the ratio as the slip ratio of the tire.

### APPLICATION EXAMPLE 43

A slip ratio measurement method of, at the preliminary running time of a vehicle as a drive force or a braking force does not act on a tire in a wheel, detecting preliminary rotation angular speed of each of driven and drive wheels, based on the tire radius and the preliminary rotation angular speed of any one of the driven wheels, finding the tire radius of a different wheel from the preliminary rotation angular speed ratio with the different wheel and then at the real running time of the vehicle, further detecting at least real traveling acceleration in the traveling direction of the drive wheel and real rotation angular speed, finding at least real traveling speed of the drive wheel found from the tire radius and the real rotation angular speed, detecting behavior change of the vehicle from the real traveling acceleration to generate a trigger signal, integrating at least the real traveling acceleration of the drive wheel from the generation time of the trigger signal, adding to the real traveling speed to find at least non-stationary traveling speed of the drive wheel at the non-stationary time when behavior change occurred, finding the ratio between an apparent tire radius found by assuming the slip ratio to be zero and the tire radius at the preliminary running time from the real rotation angular speed and the non-stationary traveling speed, and providing the ratio as the slip ratio of the tire.

### APPLICATION EXAMPLE 44

A control method of a vehicle of calculating the slip change rate per unit time of the slip ratio provided using the slip ratio measurement method described in any one of application examples 41 to 43 and controlling braking of the vehicle so that the slip change rate becomes equal to or less than a predetermined value.

### APPLICATION EXAMPLE 45

A slip sensor having an acceleration sensor and a rotation speed sensor provided on a wheel to use the slip ratio measurement method described in any one of application examples 41 to 43 or the control method of a vehicle described in application example 44.

### APPLICATION EXAMPLE 46

A slip sensor bearing including the slip sensor described in application example 45.

### APPLICATION EXAMPLE 47

A slip control system for controlling the running state of an automobile using the slip ratio measurement method described in any one of application examples 41 to 43 or the control method of a vehicle described in claim 44.

### APPLICATION EXAMPLE 48

A rolling bearing unit for wheel support to which the acceleration sensor and the number-of-revolutions detection sensor for use with the vehicle control apparatus described in application example 33 are attached.

### APPLICATION EXAMPLE 49

A method of using an acceleration sensor in the traveling direction of a car body attached to the car body of a vehicle and a rotation sensor of a wheel and combining rotation angular speed ω detected by the rotation sensor and acceleration α detected by the acceleration sensor to find ground speed V of the car body according to
V=(α/ω′)·ω.

### APPLICATION EXAMPLE 50

A method in application example 49 wherein as the acceleration, for an acceleration sensor using a force produced by acceleration and measuring the acceleration, true acceleration α is found according to α=αₐ+g sinβ using output αₐ of the acceleration sensor, road surface gradient angle β, and gravity acceleration g.

### APPLICATION EXAMPLE 51

In application example 49 or 50, a method of finding V when α/ω′ is almost constant.

### APPLICATION EXAMPLE 52

In application example 49 or 50, a method of finding ground speed V of the car body according to V=α/ω′ ω when α/ω′ is almost constant, finding ground speed V of the car body according to

[Expression 151]
V=Vₜ₁+∫ₜ₁^{t}adt
when α/ω′ does not become almost constant, and finding real radius R of each wheel (tire) according to R=V/ω.

### APPLICATION EXAMPLE 53

In application example 52, a method of finding the real radius R of each wheel when a neutral state is entered, namely, when the true acceleration α, the gravity acceleration g, and the road surface gradient angle β become the relation of α=−g sinβ.

### APPLICATION EXAMPLE 54

A method of using an acceleration sensor in the traveling direction of a car body attached to the car body of a wheel and a rotation sensor of a wheel and combining rotation angular speed ω detected by the rotation sensor and acceleration α detected by the acceleration sensor to find ground speed V of the car body according to

[Expression 152]
V=rω=∫ₜ₁^{t2}adt/(ωₜ₂−ωₜ₁)·ω
or finding the ratio between
[Expression 153]
∫ₜ₁^{t2}adt
and (ωₜ₂−ωₜ₁) for controlling each wheel.

### APPLICATION EXAMPLE 55

A method of using an acceleration sensor in the traveling direction of a car body attached to the car body of a wheel having a driven wheel and a rotation sensor of a wheel and combining rotation angular speed o detected by the rotation sensor, acceleration a detected by the acceleration sensor, the real radius of the driven wheel, and the number of revolutions of the driven wheel to find ground speed ω of the car body and slip ratio S of each wheel.

[Description of insisting that the priority date is Nov. 18, 2002]

(1) The variable names in the description are as follows: The wheel speed V_{w} is the tire circumferential speed V_{θ}, the slip ratio λ is the slip ratio S, and the reference wheel speed V_{T} is the ground speed V.

(2) The symbols of the description are effective only for the description.

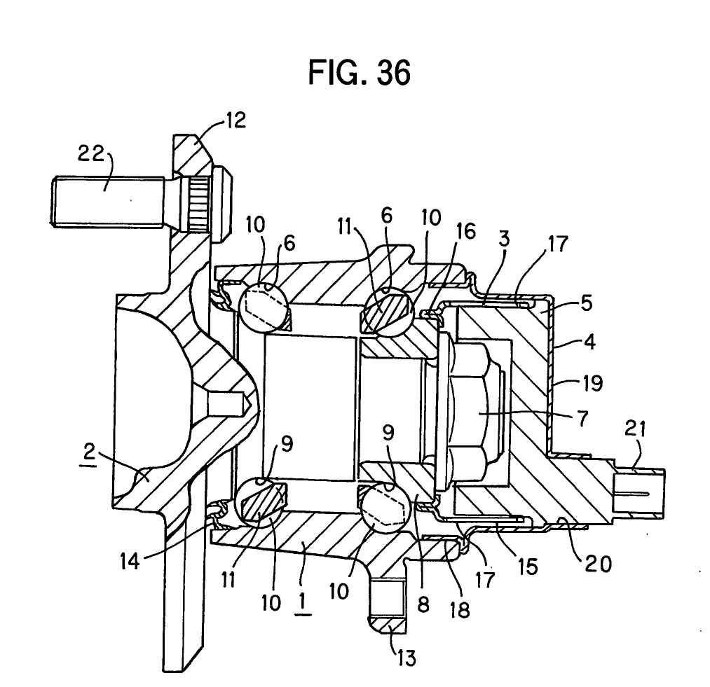

To begin with, a rolling bearing unit for wheel support with a rotation speed detector will be discussed based on FIG. 36. As shown in FIG. 36, the rolling bearing unit for wheel support with a rotation speed detector supports a hub 2 corresponding to a rotation bearing ring rotating at the use time with a wheel fixed on the inner diameter side of an outer race 1 corresponding to a stationary bearing ring not rotating at the use time in a support state on a suspension. The rotation speed of a sensor rotor 3 fixed to a part of the hub 2 can be detected by a rotation speed detection sensor unit 5 supported on a cover 4 fixed to the outer race 1. In the example shown in the figure, as the rotation speed detection sensor unit 5, an annular sensor unit opposed to the sensor rotor 3 over the full circumference is used. To support the hub 2 for rotation, the outer race 1 is formed on an inner peripheral surface with a plurality of rows of outer raceways 6 and 6 corresponding to the stationary bearing ring. Inner raceways 9 and 9 corresponding to the rotation bearing ring are provided on the outer peripheral surface of the hub 2 and the external peripheral surface of an inner race 8 outer-fitted to the hub 2 and forming the rotation bearing ring together with the hub 2 in a state in which the inner race 8 is joined and fixed to the hub 2 by a nut 7. A plurality of rolling elements 10, 10 are placed for rolling between each inner raceway 9, 9 and each outer raceway 6, 6 in a state in which they are retained by cages 11, 11 for supporting the hub 2 and the inner race 8 inside the outer race 1 for rotation.

A flange 12 to attach an axle is provided in a projection portion from the outer end part of the outer race 1 to the outside in the axial direction in the outer end part of the hub 2 (end part outside in the width direction in an assembly state into the vehicle, the left end part in FIG. 36). An attachment part 13 to attach the outer race 1 to the suspension is provided in the inner end part of the outer race 1 (end part at the center in the width direction in the assembly state into the vehicle, the right end part in FIG. 36). The gap between the outer end opening of the outer race 1 and the intermediate part outer peripheral surface of the hub 2 is closed with a sealing 14. For the rolling bearing unit for a heavy vehicle, as the plurality of rolling elements 10, 10, taper rollers may be used in place of balls as shown in the figure.

To use the rolling bearing unit for wheel support with a rotation speed detector as described above, the attachment part 13 fixed to the outer peripheral surface of the outer race 1 is joined and fixed to the suspension by a bolt (not shown) and a wheel (not shown) is fixed to the flange 12 fixed to the outer peripheral surface of the hub 2 by a stud 22 provided on the flange 12, thereby supporting the wheel for the suspension (not shown) for rotation. If the wheel rotates in this state, through holes 17 and 17 formed in a detected cylinder part 15 and a pillar part (not shown) existing between through holes 17 and 17 adjacent in the circumferential direction pass through alternately in the proximity of the end face of the detection part of the rotation speed detection sensor unit 5. Consequently, the density of the magnetic flux flowing through the rotation speed detection sensor unit 5 changes and output of the rotation speed detection sensor unit 5 changes. The frequency at which output of the rotation speed detection sensor unit 5 thus changes is proportional to the number of revolutions of the wheel. Therefore, if output of the rotation speed detection sensor unit 5 is sent to a controller 50, ABS and TCS can be controlled appropriately.

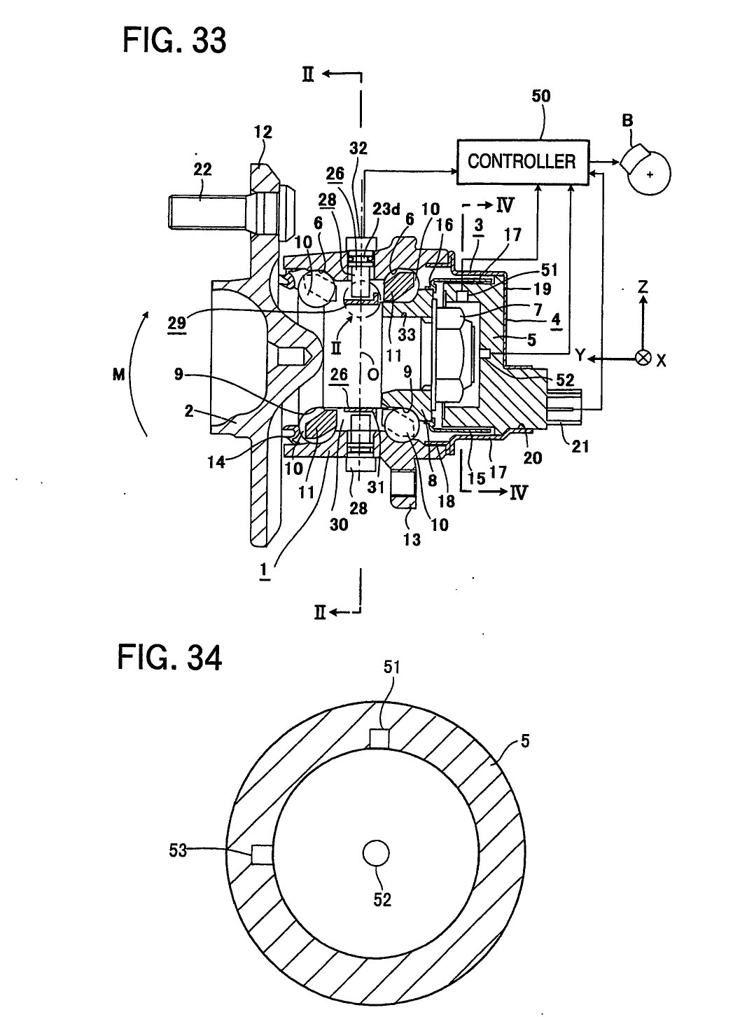

Next, a vehicle control apparatus according to a second embodiment of the invention will be discussed with reference to FIGS. 33, 34, and 35. FIG. 33 is a sectional view of the vehicle control apparatus, and FIG. 34 is a sectional view taken on line II-II in FIG. 33.

As shown in FIGS. 33 and 34, a rotation speed detection sensor unit 5 forming number-of-revolutions detection means contains an acceleration sensor 51 (for detecting acceleration in a Z (for example, vertical) direction), an acceleration sensor 52 (for detecting acceleration in a Y (for example, horizontal back-and-forth) direction), and an acceleration sensor 53 (for detecting acceleration in an X (for example, horizontal side-to-side) direction) as shown in FIG. 34 so that their axes cross each other. The acceleration sensors 51 to 53 are connected to a controller 50. The acceleration sensor can output an electric signal corresponding to the magnitude of the acceleration along the axis and, for example, may use a piezoelectric element. The configuration of the acceleration sensor is well known and therefore will not be discussed in detail below.

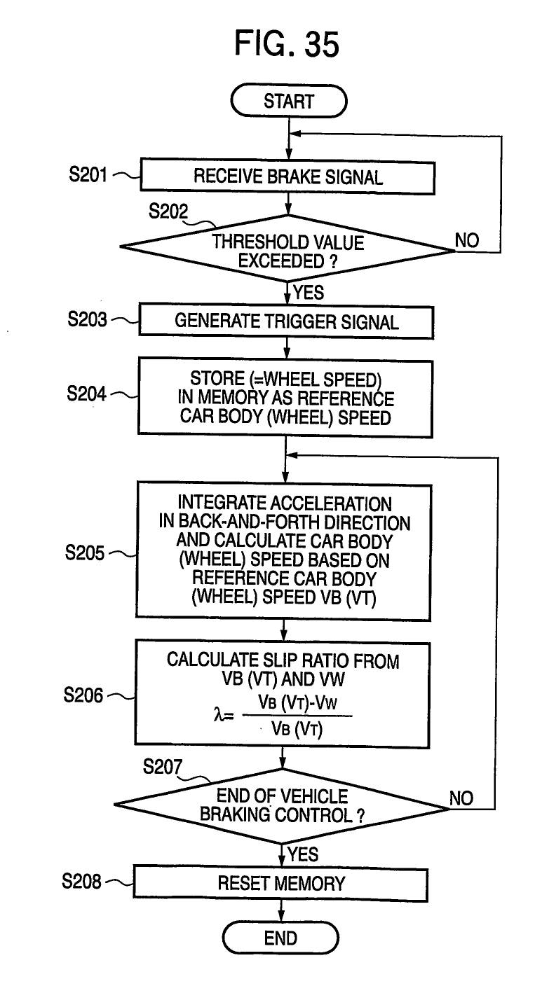

FIG. 35 is a flowchart of different control operation performed by the controller 50 of the embodiment. The different operation in the embodiment will be discussed with reference to FIG. 35.

As shown in FIG. 35, at step S201, the controller 50 receives a signal output in response to braking of the vehicle in real time and at step S202, watches whether or not which output signal exceeds a threshold value (a value predetermined by experiment, etc., and stored). For example, if a brake unit B is operated in the vehicle installing the bearing unit for axle support in the embodiment, the output signal from the acceleration sensor 53 for detecting the acceleration in the Y direction exceeds the threshold value. Thus, the controller 50 determines that predetermined attitude change occurs in the vehicle to be braked, and generates a trigger signal at step S203.

The controller 50 repeatedly stores the current wheel speed output from the rotation speed sensor unit 5 in internal memory, determines that the wheel speed output from the rotation speed sensor unit 5 just before the trigger signal is generated (at predetermined reference time) is reference speed (reference car body (wheel) speed) in response to generation of the trigger signal, and stores the speed in the internal memory (step S204). If the vehicle runs at constant speed, it is considered that the wheel speed matches the car body speed, and therefore the slip ratio can be found as shown in expressions described below with the wheel speed as the reference car body (wheel) speed.

While deceleration continues, the acceleration sensor 53 continues to detect deceleration G and thus the controller 50 integrates the output signal, whereby it is known that how much deceleration is made from the reference car body (wheel) speed (step S205). As the deceleration value is subtracted from the reference car body (wheel) speed, the current car body (wheel) speed can be estimated, so that the slip ratio can be found from the estimated car body (wheel) speed and the current wheel speed. If the slip ratio can be thus found with good accuracy, control of ABS and TCS can be performed with high accuracy. The calculation of the slip ratio is executed until it is determined that the vehicle braking control is unnecessary (for example, the vehicle speed reaches zero in deceleration) at step S207. Then, at step S208, the reference speed stored in the internal memory is reset.

Thus, if the trigger signal is generated at the start or braking time of the vehicle and the acceleration in the back-and-forth direction is integrated, precise car body (wheel) speed can be calculated and precise calculation of the slip ratio is also accomplished. That is, before the trigger signal is generated, the wheel speed and the car body speed becomes equal and therefore with the wheel speed just before generation of the trigger signal as the reference car body speed, the acceleration in the back-and-forth direction integrated after generation of the trigger signal is subtracted from the reference car body speed, whereby precise car body speed V_{B} can be found. On the other hand, letting the circumferential speed of the wheel from an encoder be V_{W}, slip ratio λ can be obtained according to the following calculation expression:
λ=(V_{B}−V_{W})/V_{B}

If the brake unit B is operated so that the slip ratio λ becomes 0.1 to 0.3, the braking distance can be suppressed to a short distance.

Since the wheels differ in direction and speed at the corning time of the vehicle, it becomes necessary to find the slip ratio of each wheel more precisely. To do this, it is advisable to contain an acceleration sensor in each bearing unit. In doing so, the precise reference wheel speed (V_{T}) of each wheel rather than the simple car body speed (V_{B}) can be found and the slit ratio of each wheel, λ_{T}, can be found in the following expression:
λ_{T}=(V_{T}−V_{W})/V_{T}

The vehicle control apparatus of the embodiment has trigger means for outputting a trigger signal in response to attitude change of the vehicle and displacement detection means for detecting the displacement amount of a rotation bearing ring and a stationary bearing ring in the rolling bearing unit for axle support for supporting the axle and finds at least one of the reaction received by the wheel from the road surface and the direction based on the displacement detected by the displacement detection means at predetermined reference time defined based on the time at which the trigger means generated the trigger signal or just before or just after the reference time and the displacement detected by the displacement detection means after the reference time. Thus, for example, even if a temperature drift, etc., occurs in the displacement sensor forming the displacement detection means, if a comparison is made between the displacement detected at the reference time and the displacement detected before or after the reference time, with the temperature drift canceled, the load change corresponding to the attitude change of the vehicle causing the trigger signal to be generated can be derived with good accuracy and accordingly it is made possible to find the reaction received by the wheel from the road surface and the direction. If the reaction received by the wheel from the road surface and the direction are found in response to the attitude change of the vehicle, to stabilize the attitude of the vehicle, control can be performed so as to give different braking forces to the wheels or give a drive force in some cases.

The vehicle control apparatus of the embodiment has an acceleration sensor for detecting the acceleration of the car body or wheel of the vehicle and number-of-revolutions detection means for detecting the number of revolutions of the wheel and can perform addition/subtraction on the current car body speed and the integration value of acceleration, for example, based on the number of revolutions of the wheel detected by the number-of-revolutions detection means and the acceleration of the car body or the wheel detected by the acceleration sensor to find the speed of the car body. Thus, the slip ratio can be derived from the found speed of the car body and the speed of the wheel, so that it is made possible to control the vehicle with high accuracy.

[Description of insisting that the priority date is Nov. 21, 2002]

(1) The variable names in the description are as follows: The wheel rotation speed V_{w} is tire circumferential speed V_{θ}, the wheel speed Vₜ (V_{T}) is ground speed V, the axle acceleration Aₜ is x-direction acceleration αₓ, the slip ratio λ is slip ratio S, and the axle rotation acceleration A_{W} is axle angular acceleration ω′.

(2) The symbols of the description are effective only for the description.

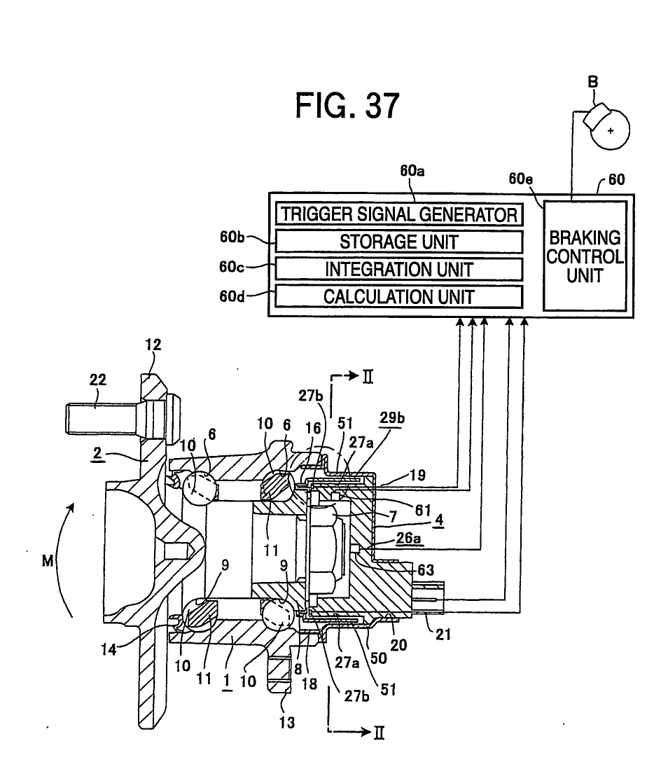

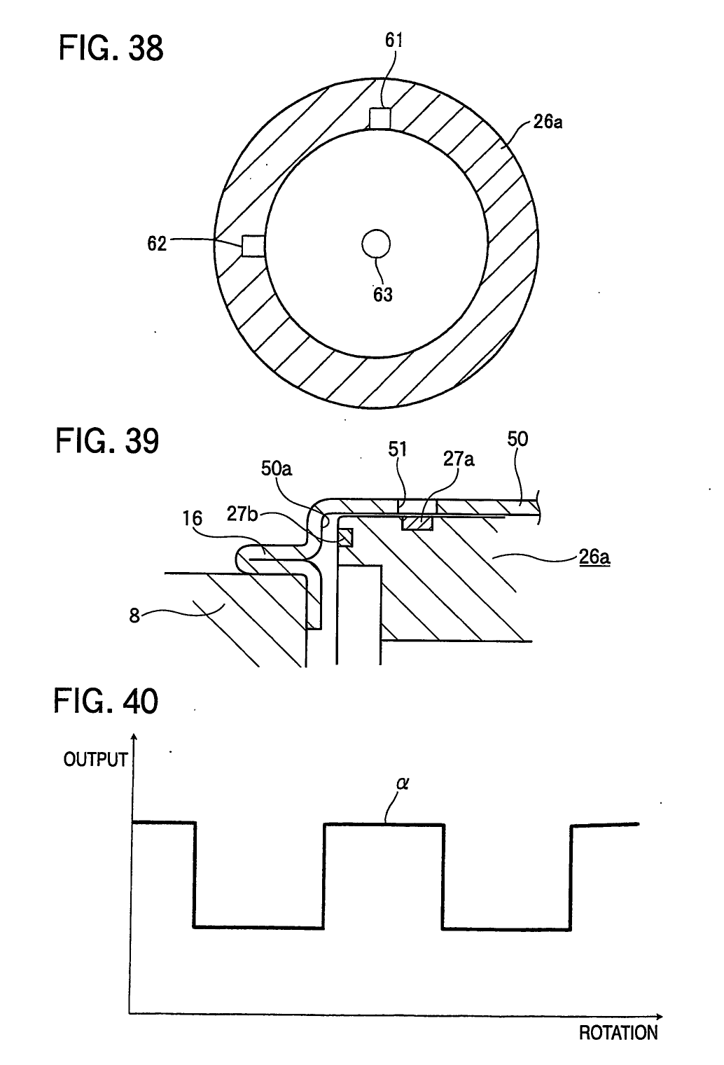

Next, a rolling unit for axle support according to a third embodiment of the invention will be discussed with reference to FIGS. 37 to 41. FIG. 37 is a sectional view of the rolling bearing unit for axle support according to the embodiment of the invention. The rolling bearing unit for axle support and a controller make up a control apparatus of a vehicle; when they are installed in the vehicle, they become a part thereof. FIG. 38 is a sectional view taken on line II-II in FIG. 37, and FIG. 39 is an enlarged view of the part indicated by arrow III in FIG. 37.

The characteristic configuration of the embodiment lies in that in FIGS. 37 to 39, the direction and magnitude of load imposed on a wheel (not shown) fixed to a hub 2 are found and ABS and TCS can be controlled appropriately and that as an acceleration sensor is contained, ABS and TCS can be controlled appropriately. Thus, in the example, not only the load imposed on the hub 2, but also the rotation speed and acceleration of the hub 2 can be detected.

In the example, of displacement measurement elements (rotation speed sensors) 27a and 27b for detecting displacement in a radial direction and displacement in a thrust direction (four each are placed with equal spacing in the circumferential direction), the displacement measurement elements 27a for detecting displacement in the radial direction make it possible to detect the rotation speed as well as displacement in the radial direction. That is, in the example, a large number of through holes 51, 51 functioning as thickness removal parts are formed with equal spacing with respect to the circumferential direction in the portions opposed closely to the displacement measurement elements 27a for detecting displacement in the radial direction in a part of a detected cylinder part (sensor rotor) 50. Each of the through holes 51, 51 is shaped like a slit long in the axial direction. The portion between the through holes 51 and 51 adjacent in the circumferential direction is formed as a pillar part functioning as a fill part.

When the detected cylinder part 50 having the through holes 51, 51 rotates, output (after waveform shaping processing) of the displacement measurement element 27a changes as indicated by solid line a in FIG. 40. That is, when each through hole 51, 51 of the detected cylinder part 50 and the displacement measurement element 27a face each other, output of the displacement measurement element 27a decreases; when the displacement measurement element 27a faces each pillar part of the portion between the through holes 51 and 51, output of the displacement measurement element 27a increases. Since the frequency at which the output of the displacement measurement element 27a changes is proportional to the rotation speed of the wheel, if an output signal (rotation speed signal) is input to the controller 60 through a harness, the rotation speed of the wheel can be found.

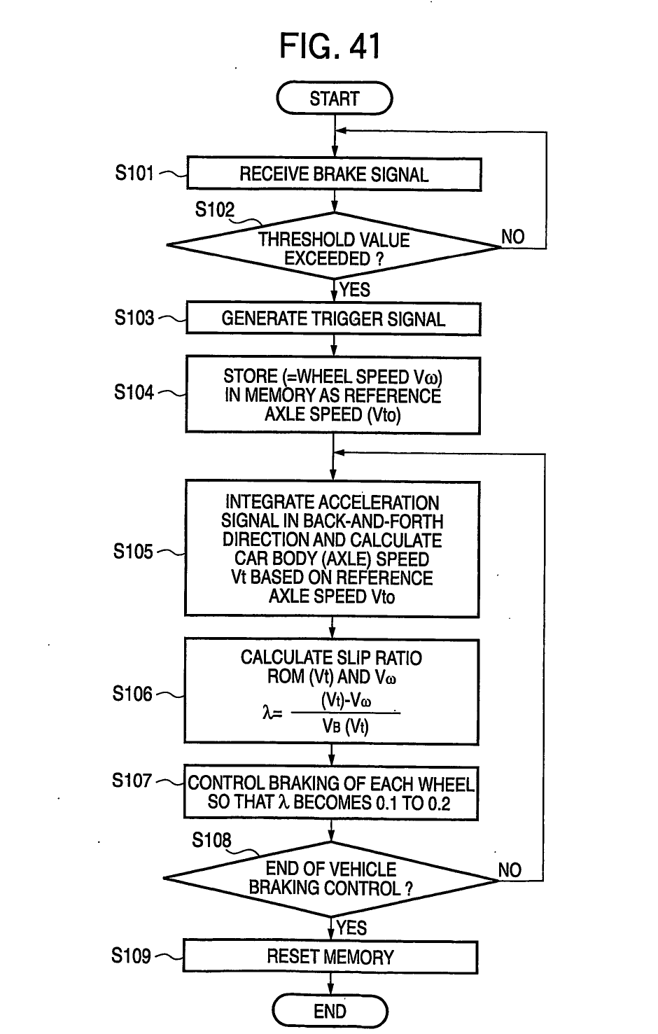

FIG. 41 is a flowchart to execute a vehicle control method of the controller 60 in the embodiment. The controller 60 has a trigger signal generator 60a, a storage unit 60b, an integration unit 60c, a calculation unit 60d, and a braking control unit 60e.

Different operation in the embodiment will be discussed with reference to FIG. 41. At step S101 in FIG. 41, the controller 60 receives a signal output in response to braking of the vehicle in real time and at step S102, watches whether or not which output signal exceeds a threshold value (a value predetermined by experiment, etc., and stored). For example, if a brake unit B is operated in the vehicle installing the bearing unit for axle support in the embodiment, the output signal from an acceleration sensor 63 for detecting the acceleration in the Y direction exceeds the threshold value. Thus, the trigger signal generator 60a of the controller 60 determines that predetermined attitude change occurs in the vehicle to be braked, and generates a trigger signal at step S103. However, a brake signal output in association with the action of the driver who steps on the brake pedal for turning on a brake lamp may be used directly as a trigger signal.

The storage unit 60b of the controller 60 repeatedly stores the current wheel rotation speed determined based on a signal output from the displacement measurement element 27a. The controller 60 finds the axle speed from wheel rotation speed V_{ω0} determined based on the signal output from the displacement measurement element 27a at the trigger signal generation time or just before the trigger signal generation time (braking reference time) in response to generation of the trigger signal, and the storage unit 60b stores the axle speed as reference axle speed Vt₀ (step S104)

While deceleration continues, the acceleration sensor 63 continues to detect deceleration G in the traveling direction and thus the integration unit 60c of the controller 60 integrates the output signal to find the integration value (additional axle speed) At and the calculation unit 60d subtracts the additional axle speed At from the stored reference axle speed Vt₀, thereby calculating the current axle speed (ground speed) Vt (step S105). Using current circumferential speed V_{ω} fond from the wheel rotation speed determined in real time based on the signal output from the displacement measurement element 27a, the calculation unit 60d slip ratio λ according to the following expression (step S106):
λ=(Vt−Vω))/Vt

Further, the braking control unit 60e of the controller 60 controls the brake unit B to give a proper press pressure to the brake pad, thereby controlling braking of each wheel so that the slip ratio S becomes 0.1 to 0.2 (step S107). The calculation of the slip ratio is executed until it is determined that the vehicle braking control is unnecessary (for example, the vehicle speed reaches zero or near to zero in deceleration) at step S108. Then, at step S109, the reference speed stored in the internal memory is reset.

Preferably, acceleration is detected for each wheel. A general acceleration sensor receives the effect of gravity if it is inclined only a little, and therefore is easily affected by the installation direction or position and outputs a signal corresponding thereto. Thus, preferably the output characteristics of the acceleration sensor at the running time or just before braking are corrected based on the wheel rotation speed and are previously stored in the memory of the controller 60. Further, if the road surface where the vehicle runs is inclined from back and forth or side to side, if the car body is inclined forward at the braking time, or if the car body is inclined from side to side at the cornering time, the acceleration sensor is affected accordingly. Thus, the change amount of the inclination needs to be found from the vertical acceleration of each wheel and the four corners of the car body and the output signals of the acceleration sensor and a rotation speed sensor need to be corrected based on the change amount. According to the correction, the correct car body speed can be found from the point in time at which a trigger signal is output. In the control, it is sufficient to detect the acceleration in the two directions of the traveling direction and the vertical direction; if the acceleration is detected in the three directions of the two directions plus the side-to-side direction, as the acceleration in the side-to-side direction is integrated, the deviation speed in the lateral direction of the wheel is found, and if the brake pad press force is adjusted so that the deviation speed is lessened as much as possible, the corning force can be controlled.

Thus, if a trigger signal is generated at the start or braking time of the vehicle and the acceleration in the back-and-forth direction is integrated, precise car body (wheel) speed can be calculated and precise calculation of the slip ratio is also accomplished. That is, before the trigger signal is generated, the wheel speed and the car body speed becomes equal and therefore with the wheel speed just before generation of the trigger signal as the reference car body speed, the acceleration in the back-and-forth direction integrated after generation of the trigger signal is subtracted from the reference car body speed, whereby precise axle speed Vt can be found.

Since the wheels differ in direction and speed at the corning time of the vehicle, it becomes necessary to find the slip ratio of each wheel more precisely. To do this, it is advisable to contain an acceleration sensor in each bearing unit. In doing so, the precise reference wheel speed (V_{T}) of each wheel rather than the simple axle speed (Vt) can be found and the slit ratio of each wheel, λ_{T}, can be found in the following expression:
λₜ=(V_{T}−V_{W})/V_{T}

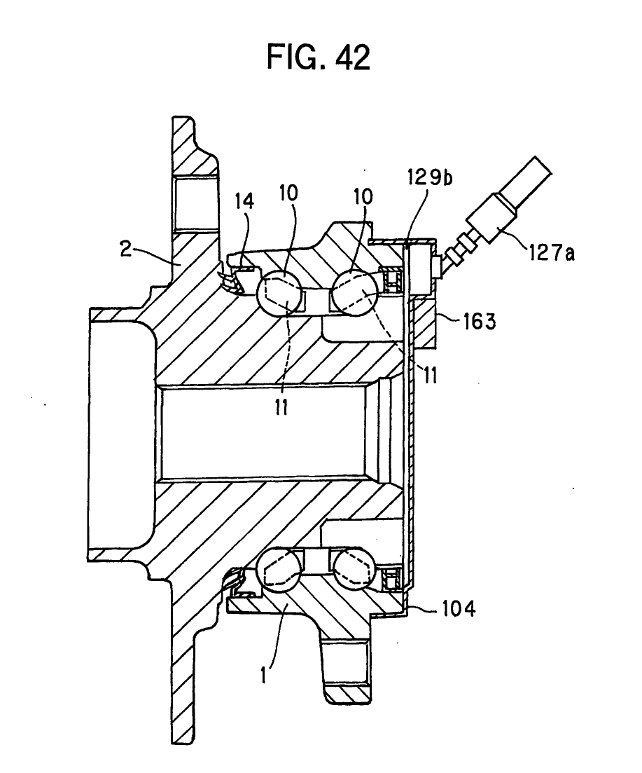

Next, a rolling unit for axle support according to a fourth embodiment of the invention will be discussed with reference to FIG. 42. FIG. 42 is a sectional view of the rolling bearing unit for axle support according to the fourth embodiment of the invention. In the embodiment, different parts from those of the embodiment in FIG. 37 will be mainly discussed and components similar to those of the embodiment in FIG. 37 are denoted by the same reference numerals and will not be discussed again. At the right end of an outer race 1 in FIG. 42, a cover member 104 is attached the current wheel rotation speed determined based on a signal output from a displacement measurement element 27a. At the right end of a hub 2 in FIG. 42, a disk-like sensor rotor 129b formed with openings with equal spacing in the circumferential direction is attached.

A rotation speed sensor 127a is attached to the cover member 104 so as to face the openings of the sensor rotor 129b. An acceleration sensor 163 is also attached to the cover member 104. The rotation speed sensor 127a for detecting the wheel rotation speed and outputting a signal responsive to the detected speed and the acceleration sensor 163 for detecting acceleration in the traveling direction of the vehicle and outputting a signal responsive to the detected acceleration are connected to a controller not shown in FIG. 42.

Using the rolling bearing unit for axle support in the embodiment, the controller (not shown) executes the control operation shown in FIG. 41.

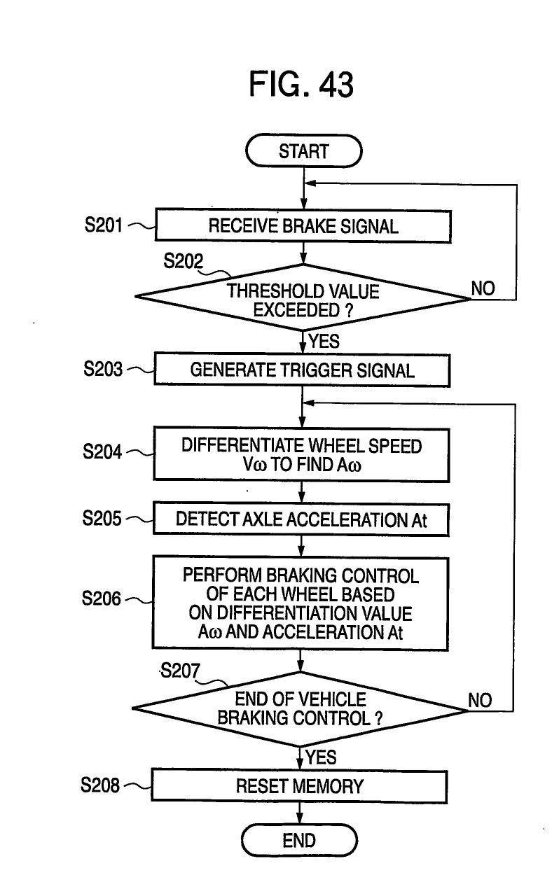

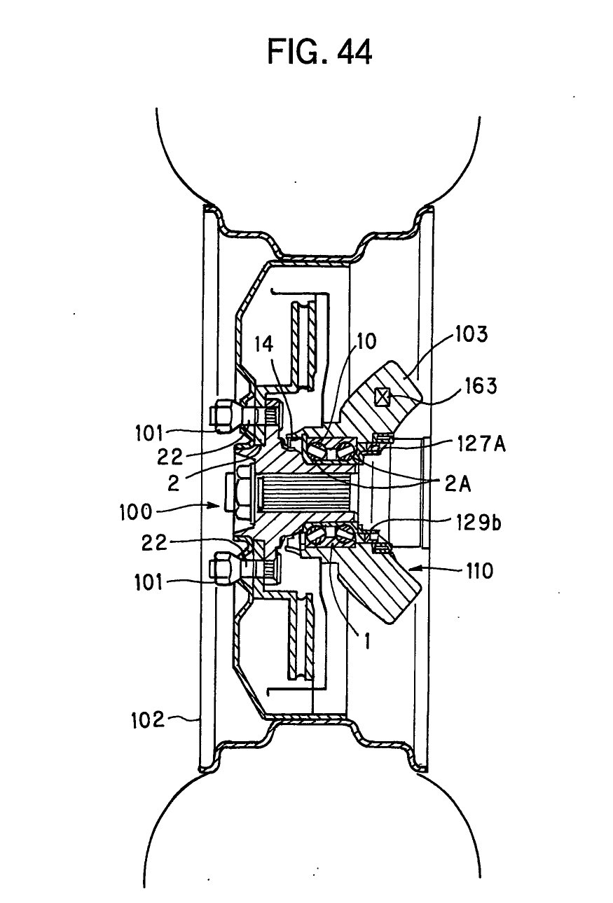

FIG. 43 is a flowchart to execute the vehicle control method of the controller using the rolling bearing unit for axle support shown in FIG. 37, FIG. 42. At step S201 in FIG. 43, the controller 60 receives a signal output in response to braking of the vehicle in real time and at step S202, watches whether or not which output signal exceeds a threshold value (a value predetermined by experiment, etc., and stored). For example, if a brake unit B is operated in the vehicle installing the bearing unit for axle support in the embodiment, the output signal from the acceleration sensor 63 (163) for detecting the acceleration in the traveling direction exceeds the threshold value. Thus, the controller 60 determines that predetermined attitude change occurs in the vehicle to be braked, and generates a trigger signal at step S203.

At the trigger signal generation time or just before the trigger signal generation time, the controller 60 continues to differentiate axle speed Vω determined from the current wheel speed determined based on a signal output from a displacement measurement element 27a and the wheel radius to find differentiation value Aω (step S204). Further, the controller determines axle acceleration At from the output signal from the acceleration sensor 63 (163) (step S205) and accomplishes the braking operation of each wheel based on the differentiation value Aω and the acceleration At (step S206).

Thus, ABS and TCS can be controlled with higher accuracy. The calculation of the slip ratio is executed until it is determined that the vehicle braking control is unnecessary (for example, the vehicle speed reaches zero in deceleration) at step S207. Then, at step S208, the reference speed stored in internal memory is reset.

Next, a rolling unit for axle support according to a fifth embodiment of the invention will be discussed with reference to FIG. 44. FIG. 44 is a sectional view of a knuckle unit and a wheel unit according to the fifth embodiment of the invention. In the embodiment, the bearing unit according to the embodiment in FIG. 37 is contained and therefore different parts from those of the embodiment in FIG. 37 will be mainly discussed and components similar to those of the embodiment in FIG. 37 are denoted by the same reference numerals and will not be discussed again.

In FIG. 44, at the left of a hub 2 of a rolling bearing unit 100, a wheel 102 is attached through a stud 22 and is fastened using a wheel nut 101. An outer race 1 of the rolling bearing unit 100 forms a stationary member together with a knuckle member 103 and is fixed to the inner peripheral surface of the knuckle member 103 for supporting a suspension (not shown) attached to a car body (not shown). Attached to the knuckle member 103 are an acceleration sensor 163 for detecting acceleration in the traveling direction of the vehicle and up and down and side to side directions of the vehicle and a rotation speed sensor 129b. The rotation speed sensor 129b is opposed to a sensor rotor 129b attached to an inner race 2A fitted to the hub 2 of the rolling bearing unit 100 (the hub 2 and the inner race 2A make up a rotation member) for detecting the number of revolutions of the hub 2, namely, the wheel. The rolling bearing unit 100 having the rotation speed sensor 129b, the knuckle member having the acceleration sensor 163 (namely, knuckle unit) 103, and the wheel make up a wheel unit 110.

The knuckle member 163 and the wheel unit 110 in the embodiment can be used to execute the vehicle control method shown in FIG. 41, FIG. 43.

According to the vehicle control method using the rolling unit for axle support according to the embodiment, for example, when a trigger signal is generated in response to braking of the vehicle, the circumferential speed of the wheel is stored as the axle speed in response to a signal from the rotation speed sensor detected at the generation time of the trigger signal or before the generation time, the acceleration based on an acceleration signal output from the acceleration sensor is integrated from the detection time to find additional axle speed, the slip ratio is calculated from the additional axle speed and new detected circumferential speed of the wheel, and braking can be controlled based on the provided slip ratio. Thus, the slip ratio can be found with higher accuracy as compared with the related art of estimating the slip ratio only from the wheel rotation speed, so that braking of the vehicle can be controlled with higher accuracy. It is made possible to store the circumferential speed of the wheel in response to the signal from the rotation speed sensor detected at the braking reference time of the generation time of the trigger signal generated in response to braking of the vehicle or just before or just after the generation time, integrate the acceleration based on the acceleration signal output from the acceleration sensor from the braking reference time, and make a comparison between the integrated acceleration and the stored circumferential speed of the wheel to find the slip ratio of the wheel. Thus, the slip ratio can be found with higher accuracy as compared with the related art of estimating the slip ratio only from the wheel rotation speed, so that braking of the vehicle can be controlled with higher accuracy.

[Description of insisting that the priority date is Nov. 26, 2002]

(1) The variable names in the description are as follows: The angular acceleration A_{θ} is axle angular acceleration ω′, the acceleration a is acceleration α, the inclination angle θ′ is road surface gradient β, the traveling acceleration Aₜ is acceleration αₓ, the acceleration V_{θ} is axle angular acceleration ω, and the wheel radius R is virtual radius r.

(2) The symbols of the description are effective only for the description.

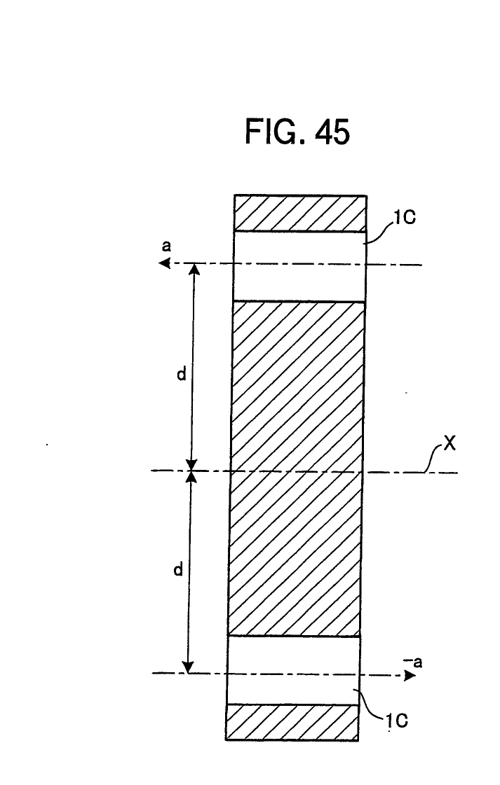

Next, an acceleration sensor used in a sixth embodiment of the invention will be discussed with reference to FIG. 45. FIG. 45 is a sectional view to show the arrangement of the acceleration sensor. In the embodiment, different parts from those of the embodiment in FIG. 33 will be mainly discussed and components similar to those of the embodiment in FIG. 33 are denoted by the same reference numerals and will not be discussed again.

Preferably, acceleration is detected for each wheel. A general acceleration sensor receives the effect of gravity if it is inclined only a little, and therefore is easily affected by the installation direction or position and outputs a signal corresponding thereto. Thus, preferably the output characteristics of the acceleration sensor at the running time or just before braking are corrected based on the wheel rotation speed and are previously stored in memory of a controller 60.

Further, if the road surface where the vehicle runs is inclined from back and forth or side to side, if the car body is inclined forward at the braking time, or if the car body is inclined from side to side at the cornering time, the acceleration sensor is affected accordingly. For example, after the brake is applied, output from a rotation speed sensor cannot be used to correct the effect of inclination of the car body or the road surface in the acceleration sensor unless the slip ratio can be found precisely. Then, it is desirable that an angular speed sensor for detecting the angular speed around the axle should be attached in the proximity of the axle and output errors of the acceleration sensor and the rotation speed sensor caused by the inclination should be corrected based on the detected angular speed. According to the correction, it is made possible to precisely integrate acceleration based on the signal from the acceleration sensor when a trigger signal is output as a brake switch is turned on, etc., or just before the trigger signal is output.

In the control, it is sufficient to find the wheel rotation speed, the acceleration in the traveling direction, and the angular speed around the axle; if a three-axis acceleration sensor capable of detecting acceleration containing that in the lateral direction and that in the vertical direction or a three-axis angular speed sensor capable of detecting angular speed around the axle containing that in the traveling direction and that in the vertical direction is used, control based on rotation and inclination of the car body is also made possible.

For example, if the acceleration in the lateral direction relative to the traveling direction is integrated, the deviation speed in the lateral direction of the wheel is found. As the brake pressure is controlled so that the speed in the lateral direction is lessened as much as possible, the corning force can also be controlled.

Further, to integrate acceleration when a trigger signal is output as the brake switch is turned on, etc., or just before the trigger signal is output, as for correction of an error caused by inclination in the back and forth or side to side direction of the car body or the road surface, the inclination of the car body or the road surface can be found according to the signals from vertical acceleration sensors provided in each wheel and the four corners of the car body and the output signal of the acceleration sensor or the rotation speed sensor can also be corrected based on the inclination.

As shown in FIG. 45, two comparatively inexpensive acceleration sensor ICs are placed distance d away from center axis X and axial acceleration a is found and angular acceleration Aθ can be found from the following expression:

$$\begin{matrix}A θ = ( acceleration difference \text{:} a - ( - a ) ) / d \\ = 2 a\end{matrix}$$

In this case, axial parallel move and inclined motion (around the axis perpendicular to the plane of the figure) can be distinguished from each other. The angular acceleration Aθ can be integrated to find angular speed VΓ and if the angular speed VΓ is integrated, inclination angle θ can be found. The inclination correction component of gravity acceleration g becomes g·sing θ.

Thus, if a trigger signal is generated at the start or braking time of the vehicle and the acceleration in the back-and-forth direction is integrated, precise car body (wheel) speed can be calculated and precise calculation of the slip ratio is also accomplished. That is, before the trigger signal is generated, the wheel speed and the car body speed becomes equal and therefore with the wheel speed just before generation of the trigger signal as the reference car body speed, the acceleration in the back-and-forth direction integrated after generation of the trigger signal is subtracted from the reference car body speed, whereby precise axle speed Vt can be found.

Since the wheels differ in direction and speed at the corning time of the vehicle, it becomes necessary to find the slip ratio of each wheel more precisely. To do this, it is advisable to contain an acceleration sensor in each bearing unit. In doing so, the precise reference wheel speed (V_{T}) of each wheel rather than the simple axle speed (Vt) can be found and the slit ratio of each wheel, λ_{T}, can be found in the following expression:
λ_{T}=(V_{T}−Vc)/V_{T}

Here, how to find wheel radius R will be discussed. As a comparison is made between axle speed increment ΔVt and wheel rotation speed increment ΔVθ, the wheel radius R can be measured in real time while the vehicle is running as follows: To begin with, the axle speed increment ΔVt and axle traveling acceleration At have the following relation:

$$Δ {V}_{t} = {\int }_{t1}^{t2} ( At ) ⅆ t \qquad [ Expression 154 ]$$

where t1 and t2 are arbitrary times.

The axle speed increment ΔVt, the wheel rotation speed increment ΔVθ, and the wheel radius R are represented by the following expression:
R=ΔVt/ΔVθ

That is, the axle traveling acceleration At and the wheel rotation speed increment ΔVθ can be used to find the wheel radius R.

Although the wheel radius R can also be found directly according to the following expression from the vehicle traveling acceleration At and wheel rotation angular speed Aθ, when At=0, Aθ=0, the solution of the following expression cannot be found and therefore preferably calculation is performed based on the measurement value provided when acceleration of a given value or more occurs. Preferably, acceleration is measured in the range in which slip is small described above. Practically, it is advisable to average a plurality of measurement value calculation results to avoid the effect of the slit ratio.
R=At/Aθ

Further, another method of finding the wheel radius R will be discussed. As a comparison is made between axle move distance increment ΔLt and wheel rotation angle increment ΔLθ, the wheel radius R can be measured as follows: To begin with, the axle move distance increment θLt and the axle traveling acceleration At have the following relation:

$$Δ {L}_{t} = \int {\int }_{t1}^{t2} ( At ) ⅆ t ⅆ t \qquad [ Expression 155 ]$$

Further, the axle move distance increment ΔLt, the wheel rotation angle increment ΔLθ, and the wheel radius R are represented by the following expression:
R=ΔVt/ΔLθ

That is, the axle traveling acceleration At and the wheel rotation angle increment ΔLθ can be used to find the wheel radius R.

For example, preferably the wheel radius R is repeatedly calculated with neither power nor the brake applied and is stored in memory and at the stop time, the wheel radius R stored just before the stop time is used to find the slip ratio λ. An error caused by the inclination of the acceleration sensor is 0.4% when the inclination is five degrees, and thus is used for correction as required. As the acceleration sensor, an acceleration sensor attached to the car body or an acceleration sensor attached to each wheel can be used.

Since the wheel radius R can be thus found in real time, precise run speed Vt and run distance Lt can be found in the following expression from wheel rotation speed Vθ:
Vt=RVθ
Lt=RLθ

Further, if the wheel radius R can be found, whether or not the air pressure of the wheel is proper can be determined. For example, the wheel radius R when the air pressure is proper is previously stored in the memory and is compared with the wheel radius R found in real time during running. When the comparison result falls below a threshold value, if a warning is given, the driver can be informed that the air pressure of the wheel lowers, preventing a burst. For example, when the wheel radius is 300 mm and the rim radius is 178 mm, it is considered that change in the wheel radius caused by a decrease in the air pressure of the wheel is in the neighborhood of 5%.

Not only the signal from the brake switch, but also change in the wheel acceleration At or wheel circumferential acceleration Ac can be used as the trigger signal. For example, when the difference between the wheel acceleration At and the wheel circumferential acceleration Ac becomes a given value or more, if a return is made to the shift point in time and this point in time is adopted as the trigger point in time, the need for using the brake signal is eliminated and therefore the trigger to find the slip ratio λd at the driving time found in the following expression can be formed:
λd=1−(Vc/Vt)

The wheel circumferential speed Vc can be differentiated to find the circumferential acceleration Ac, which can then be compared with the wheel acceleration At for controlling the brake pressure of each wheel. In this case, the slip ratio λ can be found by integrating (Ac/At) and subtracting the result from 1 (λ=1−∫(Ac/At)) and the slip ratio λd at the driving time can be found by integrating (Ac/At) and subtracting 1 from the result (λd=∫(Ac/At)−1)

According to the embodiment, the simple acceleration sensor is only attached in the proximity of each wheel, whereby precise control following the above-described expression for each wheel can be performed without receiving the effect of the suspension, etc. Since the control technique is similar to that in the related art, the system in the related art can be used.

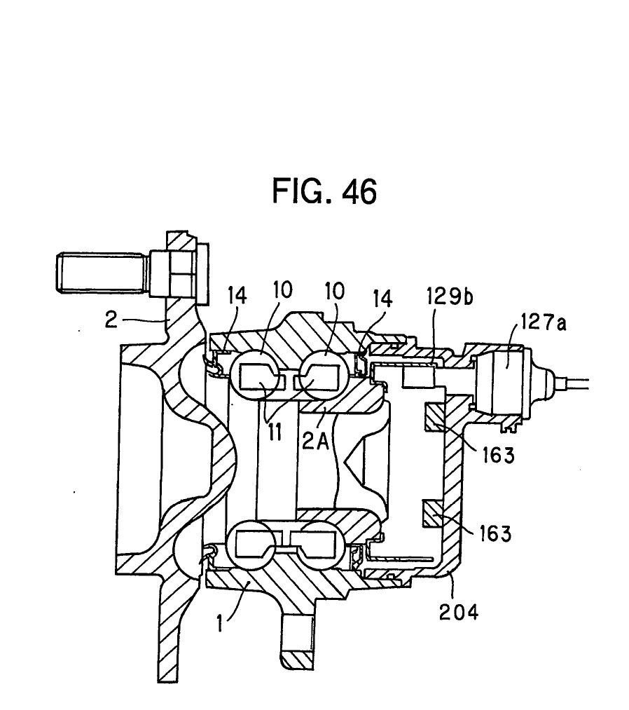

Next, a seventh embodiment of the invention will be discussed with reference to FIG. 46. FIG. 46 is a sectional view of a rolling bearing unit for axle support according to the seventh embodiment of the invention. In the embodiment, different parts from those of the embodiment in FIG. 46 will be mainly discussed and components similar to those of the embodiment in FIG. 46 are denoted by the same reference numerals and will not be discussed again. At the right end of an outer race 1 in FIG. 46, a cover member 204 is attached. At the right end of an inner race 2A rotating integrally with a hub 2, a cylindrical sensor rotor 129b formed with openings with equal spacing in the circumferential direction is attached.

A rotation speed sensor 127a having a detection part extended in the horizontal direction is attached to the cover member 204 so as to face the openings of the sensor rotor 129b from the inside in the radius direction. A pair of acceleration sensors 163 is also attached to the cover member 204 so as to become symmetrical with respect to an axis as in the arrangement shown in FIG. 45. The rotation speed sensor 127a for detecting the wheel rotation speed and outputting a signal responsive to the detected speed and the acceleration sensor 163 for detecting acceleration in the traveling direction of the vehicle and outputting a signal responsive to the detected acceleration are connected to a controller not shown in FIG. 46.

[Description of insisting that the priority date is Jan. 20, 2003]

(1) The variable names in the description are as follows: The traveling acceleration Aₓ is acceleration αₓ, the circumferential acceleration A_{c} is wheel angular acceleration ω′, the circumferential speed V_{c} is wheel angular speed ω, the slip ratio λ(λd) is slip ratio S, and the speed Vₓ is ground speed V.

(2) The symbols of the description are effective only for the description.

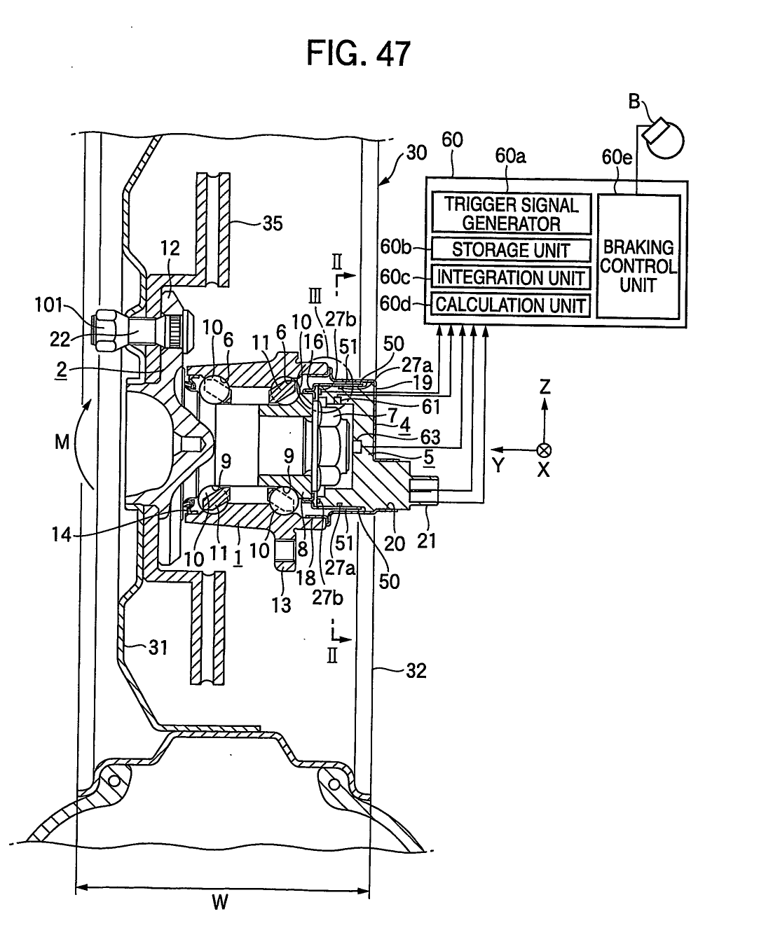

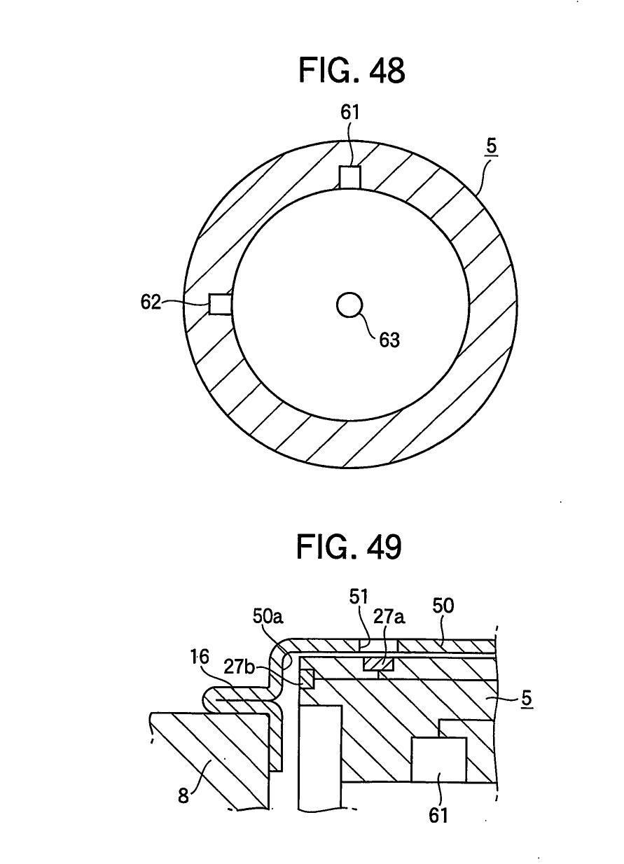

Next, an eighth embodiment of the invention will be discussed. In the embodiment, as shown in FIGS. 47 to 49, a rotation speed detection sensor unit 5 forming number-of-revolutions detection means contains an acceleration sensor 61 (for detecting acceleration in a Z (for example, vertical) direction), an acceleration sensor 62 (for detecting acceleration in a Y (for example, horizontal back-and-forth) direction), and an acceleration sensor 63 (for detecting acceleration in an X (for example, horizontal side-to-side) direction) so that their axes cross each other. The acceleration sensors 61 to 63 are connected to a controller 60.

Here, in the embodiment, each acceleration sensor 61 to 63 is placed within rim width W of a wheel rim 32 in a wheel 30, so that a detection error of the acceleration sensor particularly at the vehicle turning time can be suppressed drastically and high detection accuracy of the slip ratio can be provided.

That is, each acceleration sensor 61 to 63 may be attached to any part of a rolling bearing unit for axle support only at the traveling time in a straight line, namely, needs to be attached to a specific part of the rolling bearing unit for axle support to prevent a detection error of the slip ratio from occurring at the turning time.

Of course, ideally each acceleration sensor 61 to 63 is placed at the center of the wheel 30; in fact, however, a wheel support part, a hub, and the like are placed at the center position of the wheel 30 and each acceleration sensor 61 to 63 is attached offset rather than to the center of the wheel as shown in FIG. 47. It is difficult to attach the acceleration sensor to the center of the wheel particularly in a sub-wheel structure with two wheels combined such as a truck.

Therefore, each acceleration sensor 61 to 63, which is provided for measuring the behavior of each wheel 30, is attached within the rim width of the wheel 30, whereby a detection error at the vehicle turning time can be suppressed drastically and high detection accuracy of the slip ratio can be provided.

Each acceleration sensor 61 to 63 can output an electric signal corresponding to the magnitude of the acceleration along the axis and, for example, may use a piezoelectric element. The configuration of the acceleration sensor is well known and therefore will not be discussed in detail below.

Not only a signal from a brake switch, but also change in acceleration At in the traveling direction of the wheel (axle) or wheel circumferential acceleration Ac can be used as a trigger signal. For example, when the difference between the acceleration At in the traveling direction of the wheel and the wheel circumferential acceleration Ac becomes a given value or more, if a return is made to the shift point in time and this point in time is adopted as the trigger point in time, the need for using the brake signal is eliminated and therefore the trigger to find the slip ratio λd at the driving time found in the following expression can be formed:
λd=1−(Vc/Vx)

The wheel circumferential speed Vc can be differentiated to find the circumferential acceleration Ac, which can then be compared with the acceleration At in the traveling direction of the wheel for controlling the brake pressure of each wheel. In this case, the slip ratio λ can be found by integrating (Ac/Ax) and subtracting the result from 1 (λ=1−∫(Ac/Ax)) and the slip ratio λd at the driving time can be found by integrating (Ax/Ac) and subtracting the result from 1 (λd=1−∫(Ax/Ac)).

According to the invention, the simple acceleration sensor is only attached so that it is placed within the rim width of each wheel, whereby precise control following the above-described expression for each wheel can be performed without receiving the effect of the suspension, etc. Since the control technique is similar to that in the related art, the system in the related art can be used.

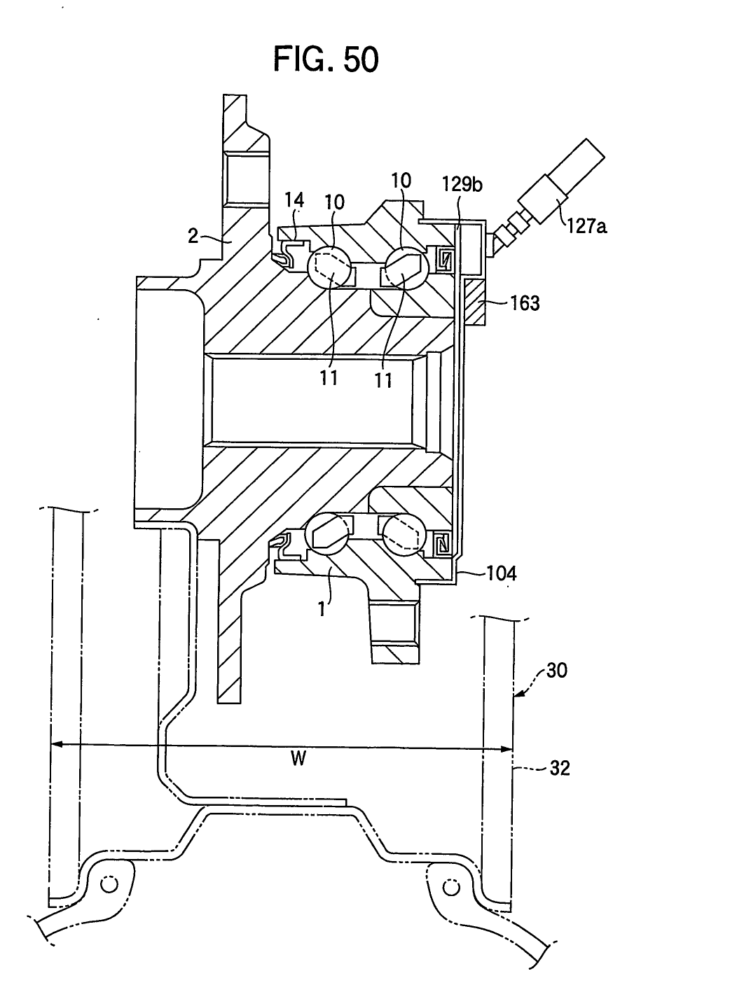

FIG. 50 is a sectional view of a rolling bearing unit for axle support according to a ninth embodiment of the invention. In the ninth embodiment, different parts from those of the eighth embodiment shown in FIG. 47 will be mainly discussed and components similar to those of the eighth embodiment are denoted by the same reference numerals and will not be discussed again.

At the right end of an outer race 1 in FIG. 50, a cover member 104 is attached. At the right end of a hub 2 in FIG. 50, a disk-like sensor rotor 129b formed with openings with equal spacing in the circumferential direction is attached.

A rotation speed sensor 127a is attached to the cover member 104 so as to face the openings of the sensor rotor 129b. An acceleration sensor 163 is also attached to the cover member 104. The rotation speed sensor 127a for detecting the rotation speed of a wheel 30 and outputting a signal responsive to the detected speed and the acceleration sensor 163 for detecting acceleration in the traveling direction of the wheel 30 and outputting a signal responsive to the detected acceleration are connected to a controller 60 (not shown).

Further, the acceleration sensor 163 is placed within rim width W of a wheel rim 32 in the wheel 30.

Using the rolling bearing unit for axle support in the ninth embodiment, the controller 60 (not shown) executes the control operation shown in FIG. 49.

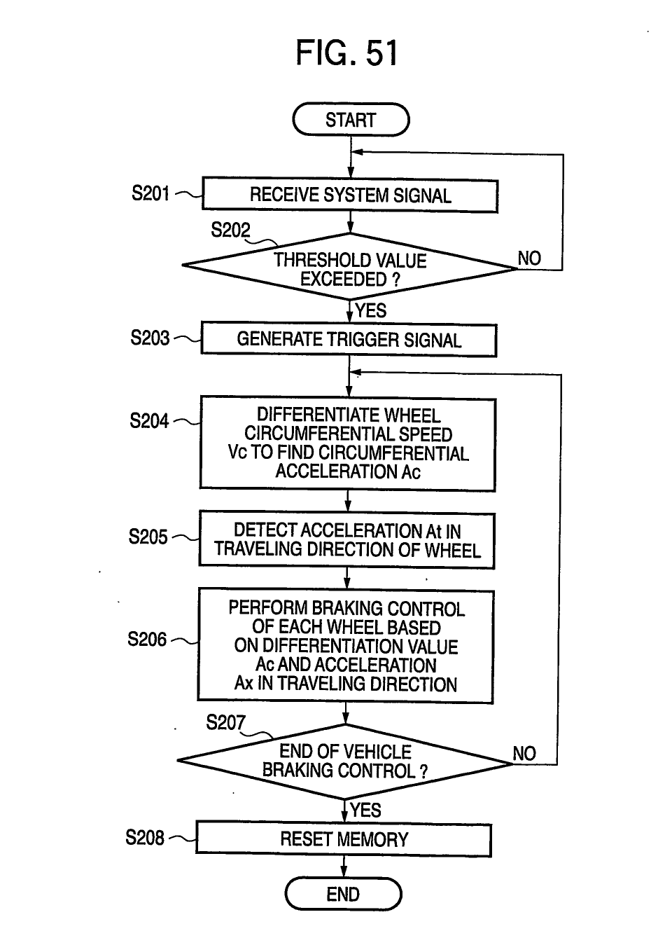

FIG. 51 is a flowchart to execute a different vehicle control method of the controller 60 using the rolling bearing unit for axle support shown in FIG. 47, FIG. 50.

At step S201 in FIG. 51, the controller 60 receives a signal output in response to braking of the vehicle in real time and at step S202, watches whether or not which output signal exceeds a threshold value (a value predetermined by experiment, etc., and stored). For example, if a brake unit B is operated in the vehicle installing the bearing unit for axle support in each embodiment described above, the output signal from the acceleration sensor 62 (163) for detecting the acceleration in the traveling direction of the wheel 30 exceeds the threshold value. Thus, the controller 60 determines that predetermined attitude change occurs in the vehicle to be braked, and generates a trigger signal at step S203.

At the trigger signal generation time or just before the trigger signal generation time, the controller 60 continues to differentiate axle speed Vω determined from the current wheel rotation speed determined based on a signal output from a displacement measurement element 27a and wheel circumferential speed Vc to find differentiation value (wheel circumferential acceleration) Ac (step S204).

Further, the controller determines acceleration Ax in the traveling direction of the axle from the output signal from the acceleration sensor 62 (163) (step S205) and controls braking of each wheel based on the differentiation value Ac and the acceleration Ax in the traveling direction (step S206).

Thus, braking control is performed for each wheel, whereby ABS and TCS can be controlled with higher accuracy. The calculation of the slip ratio is executed until it is determined that the vehicle braking control is unnecessary (for example, the vehicle speed reaches zero in deceleration) at step S207. Then, at step S208, the reference speed stored in internal memory is reset.

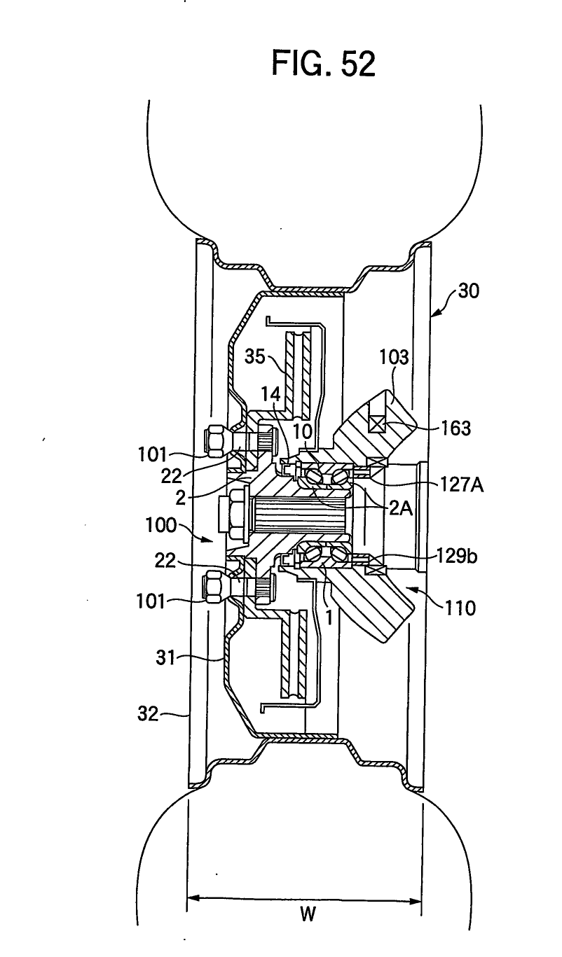

FIG. 52 is a sectional view of a knuckle unit and a wheel unit according to a tenth embodiment of the invention. In the tenth embodiment, different parts from those of the bearing unit according to the eighth embodiment shown in FIG. 47 will be mainly discussed and components similar to those of the bearing unit are denoted by the same reference numerals and will not be discussed again.

In FIG. 52, at the left of a hub 2 of a rolling bearing unit 100 in the figure, a wheel disk part 31 of a wheel 30 is attached through a stud 22 with a disk rotor 35 forming a part of a braking unit between and is fastened using a wheel nut 101.

An outer race 1 of the rolling bearing unit 100 forms a stationary member together with a knuckle member 103 and is fixed to the inner peripheral surface of the knuckle member 103 for supporting a suspension (not shown) attached to a car body (not shown).

An acceleration sensor 163 for detecting acceleration in the traveling direction of the vehicle and up and down and side to side directions of the vehicle is attached to the inside of a hole of the knuckle member 103 and a rotation speed sensor 129b is attached to the inner peripheral surface of the knuckle member 103.

The rotation speed sensor 129b is opposed to a sensor rotor 127A attached to an inner race 2A fitted to the hub 2 of the rolling bearing unit 100 (the hub 2 and the inner race 2A make up a rotation member) for detecting the number of revolutions of the hub 2, namely, the wheel 30.

A wheel unit 110 is made up of the rolling bearing unit 100 having the rotation speed sensor 129b, the knuckle member having the acceleration sensor 163 (namely, knuckle unit) 103, the braking unit containing the disk rotor 35, and the wheel 30. Further, the acceleration sensor 163 is placed within rim width W of a wheel rim 32 in the wheel 30.

That is, the knuckle member 103 and the wheel unit 110 in the tenth embodiment can be used to execute the vehicle control method shown in FIG. 49 or FIG. 51.

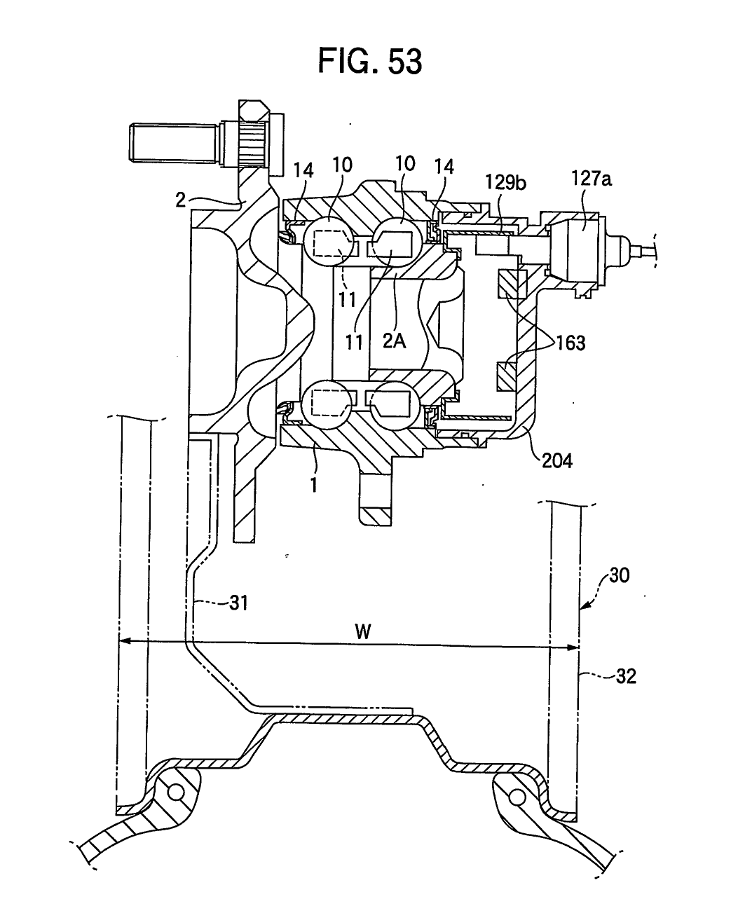

FIG. 53 is a sectional view of a rolling bearing unit for axle support according to an eleventh embodiment of the invention.

In the eleventh embodiment, different parts from those of the eighth embodiment shown in FIG. 47 will be mainly discussed and components similar to those of the eighth embodiment are denoted by the same reference numerals and will not be discussed again.

At the right end of an outer race 1 in FIG. 53, a cover member 204 is attached. At the right end of an inner race 2A rotating integrally with a hub 2, a cylindrical sensor rotor 129b formed with openings with equal spacing in the circumferential direction is attached.

A rotation speed sensor 127a having a detection part extended in the horizontal direction is attached to the cover member 204 so as to face the openings of the sensor rotor 129b from the inside in the radius direction. A pair of acceleration sensors 163 and 163 is also attached to the cover member 204 so as to become symmetrical with respect to an axis.

The rotation speed sensor 127a for detecting the rotation speed of a wheel 30 and outputting a signal responsive to the detected speed and the acceleration sensor 163 for detecting acceleration in the traveling direction of the vehicle and outputting a signal responsive to the detected acceleration are connected to a controller 60 (not shown). The acceleration sensor 163 is placed within rim width W of a wheel rim 32 in the wheel 30.

Although the invention is described with reference to the embodiments, it is to be understood that the invention is not limited to the specific embodiments and that changes and improvements can be made in the invention as appropriate, of course.

For example, for two-wheel drive, at the traveling time of the vehicle in a straight line, circumferential speed Vcf of a driven wheel is car body speed Vd and slip ratio λd of a drive wheel is found from the car body speed Vd and circumferential speed Vcd of the drive wheel, whereby the slip ratio of the drive wheel can always be measured in real time. Accordingly, also at the driving time, a throttle valve can be closed and differential control can be performed for performing traction control so that the ideal slip ratio is not exceeded.

On the other hand, at the vehicle turning time, if the circumferential speed difference between the left and right driven wheels exceeds a given value, a return is made to 0 point in time and this point in time is adopted as the turning trigger point in time. The axle speed of the left and right driven wheels at the time is stored in memory and the axle speed of each wheel from the point in time is found by calculation (integration) using the output value from the acceleration sensor attached to each driven wheel, whereby the absolute speed of each axle can be found at all times and the slip ratio of each wheel can be measured at all times from the absolute speed and the circumferential speed of each wheel.

In the embodiments described above, the case of a single wheel is taken as an example. However, the invention can also be applied to a sub-wheel structure (so-called double tires, etc.,) with a plurality of wheels combined such as a truck. In this case, the acceleration sensor is placed in the rim width between outer and inner rims with the plurality of wheels combined.

According to the rolling bearing unit for axle support of the embodiment, the acceleration sensor is placed within the rim width of the wheel, so that a measurement error of the slip ratio in each wheel at the vehicle turning time can be suppressed and the detection accuracy of the slip ratio can be made higher. [Description of insisting that the priority date is Jan. 24, 2003]

The symbols of the description are effective only for the description.

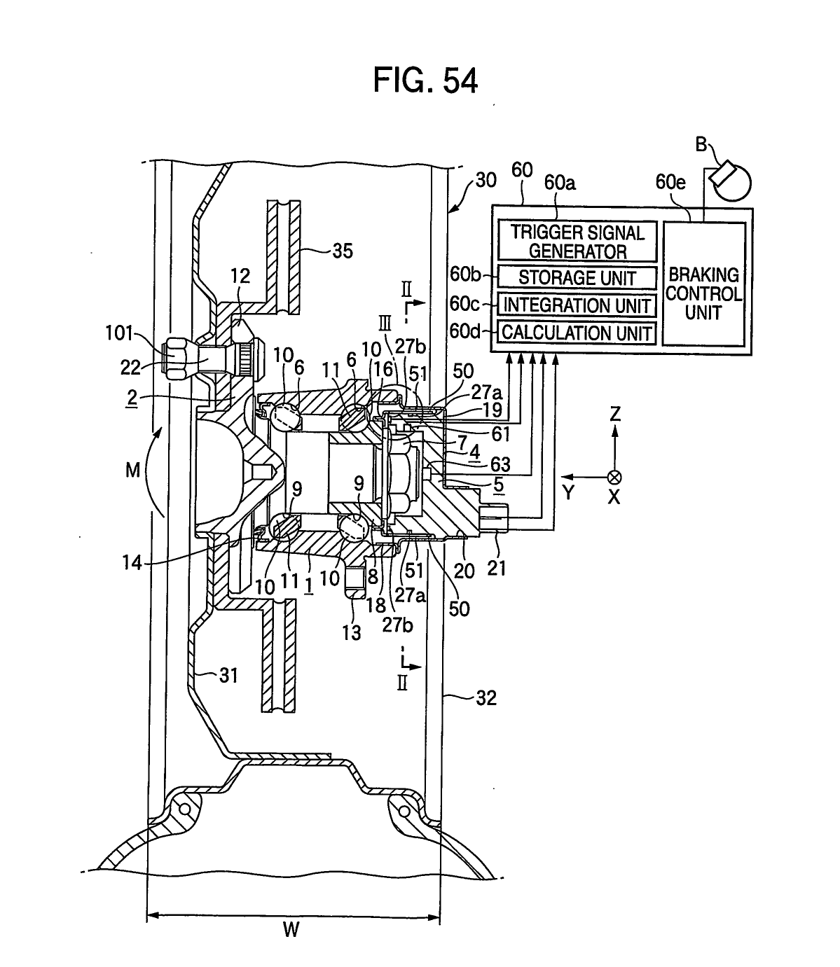

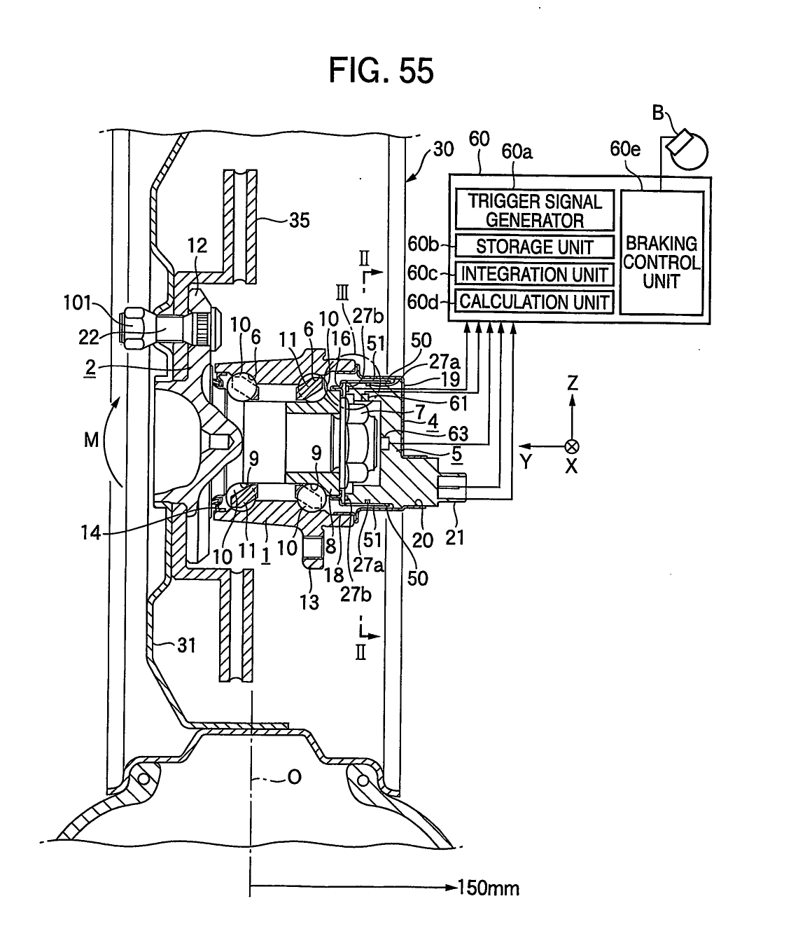

In a rolling bearing unit for axle support according to a twelfth embodiment of the invention, each acceleration sensor 61 to 63 is placed within rim width W of a wheel rim 32 in a wheel 30, as shown in FIG. 54. In second embodiment, each acceleration sensor 61 to 63 is placed within 150 mm (plus offset amount within 150 mm) on the car body side (right in FIG. 55) along the axial direction from center line O of the rim width of the wheel rim 32 in the wheel 30, as shown in FIG. 55.

Thus, a detection error of the acceleration sensor particularly at the vehicle turning time can be suppressed drastically and high detection accuracy of the slip ratio can be provided.

That is, each acceleration sensor 61 to 63 may be attached to any part of a rolling bearing unit for axle support only at the traveling time in a straight line, namely, needs to be attached to a specific part of the rolling bearing unit for axle support to prevent a detection error of the slip ratio from occurring at the turning time.

Of course, ideally each acceleration sensor 61 to 63 is placed on the center line 30 of the wheel 30; in fact, however, a wheel support part, a hub, and the like are placed at the center position of the wheel 30 and each acceleration sensor 61 to 63 is attached offset rather than to the center of the wheel as shown in FIGS. 54 and 55. It is difficult to attach the acceleration sensor to the center of the wheel particularly in a sub-wheel structure with two wheels combined such as a truck.

Therefore, each acceleration sensor 61 to 63, which is provided for measuring the behavior of each wheel 30, is attached within the rim width W of the wheel 30 as shown in the first embodiment, whereby a detection error at the vehicle turning time can be suppressed drastically and high detection accuracy of the slip ratio can be provided.

The inventor et al. conducted various simulations with the acceleration sensor attachment positions changed in more detail, and found that each acceleration sensor can be used at the practical level if it is attached within a given range from the center line O of the wheel 30 rather than being attached to the center of the wheel 30.

Table 1 given below lists comparison of slip ratio errors at the turning time with the acceleration sensor attached changing the offset amount along the axial direction from the center line O of the rim width (200 mm) of the wheel 30. In Table 1, the double circle indicates the smallest error, the circle indicates the smaller error next to the double circle, and the triangle indicates the smaller error next to the circle, which are within the allowable range of slip ratio error, and X indicates that the error is beyond the allowable range.

TABLE 1

| | Axial offset amount (mm) from center line ◯ | | | | | | | | | | |
|---|---|---|---|---|---|---|---|---|---|---|---|
| | −250 | −200 | −150 | −100 | −50 | 0 | 50 | 100 | 150 | 200 | 250 |
| Slip ratio error at turning time | X | X | Δ | ◯ | ◯ | ⊚ | ◯ | ◯ | Δ | X | X |

As seen in Table 1, it can be acknowledged that the slip ratio error can be placed within the allowable range by placing the acceleration sensor within 150 mm (namely, the minus offset amount and the plus offset amount are each within 150 mm) on the outside and the car body side along the axial direction from the center line O of the wheel 30.

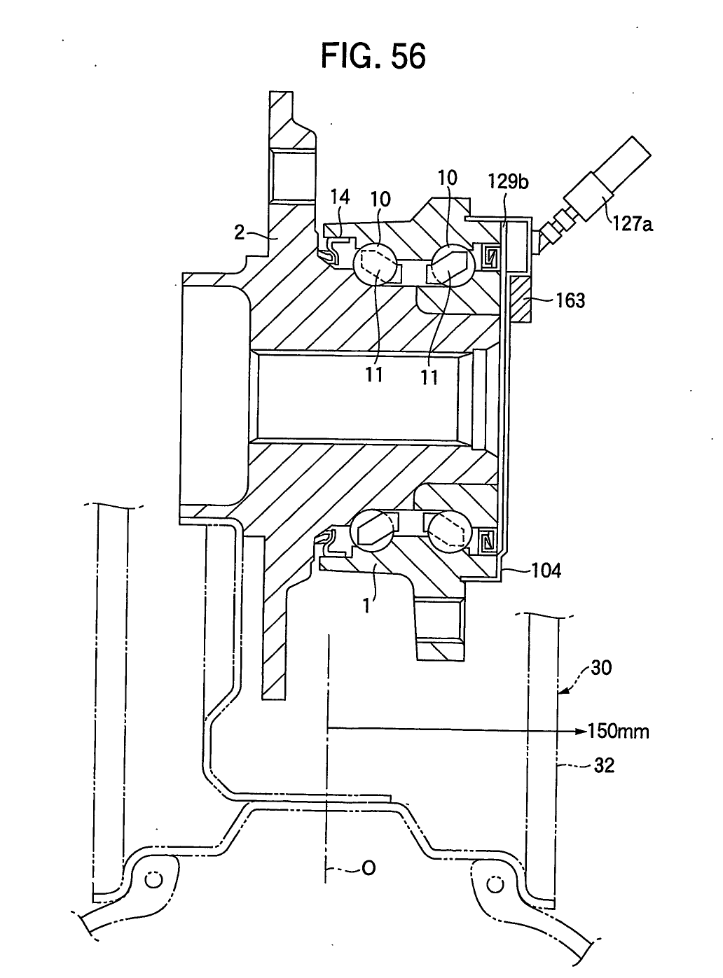

Further, in a different embodiment, the acceleration sensor 163 is placed within rim width W of a wheel rim 32 in a wheel 30. In a fourteenth embodiment, each acceleration sensor 61 to 63 is placed within 150 mm (plus offset amount within 150 mm) on the car body side (right in FIG. 56) along the axial direction from center line O of the rim width of a wheel rim 32 in a wheel 30, as shown in FIG. 56.

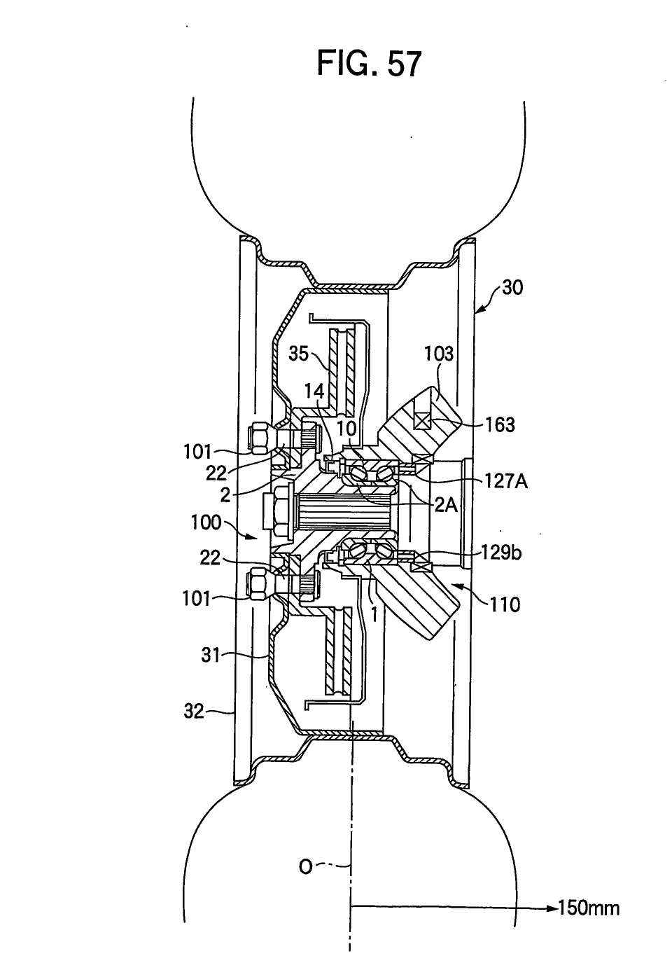

Using the rolling bearing unit for axle support in the fourteenth embodiment, a controller 60 (not shown) executes the control operation shown in FIG. 57.

Further, in a fifteenth embodiment, each acceleration sensor 61 to 63 is placed within 150 mm (plus offset amount within 150 mm) on the car body side (right in FIG. 57) along the axial direction from center line O of the rim width of a wheel rim 32 in a wheel 30, as shown in FIG. 57.

That is, knuckle member 103 and wheel unit 110 in the fifth and sixth embodiments can be used to execute vehicle control method.

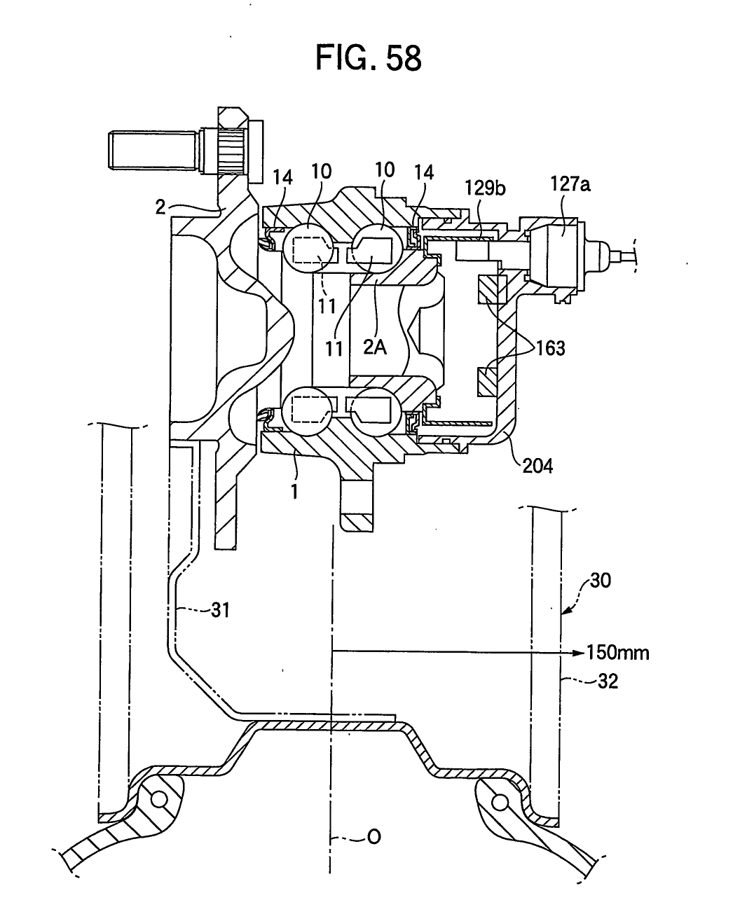

In a sixteenth embodiment, each acceleration sensor 61 to 63 is placed within 150 mm (plus offset amount within 150 mm) on the car body side (right in FIG. 58) along the axial direction from center line O of the rim width of a wheel rim 32 in a wheel 30, as shown in FIG. 58.

According to the rolling bearing unit for axle support of the embodiment, the acceleration sensor is placed within the rim width of the wheel or within 150 mm in the axial direction from the center line of the rim width of the wheel, so that a measurement error of the slip ratio in each wheel at the vehicle turning time can be suppressed and the detection accuracy of the slip ratio can be made higher.

[Description of insisting that the priority date is Jan. 31, 2003]

The symbols of the description are effective only for the description.

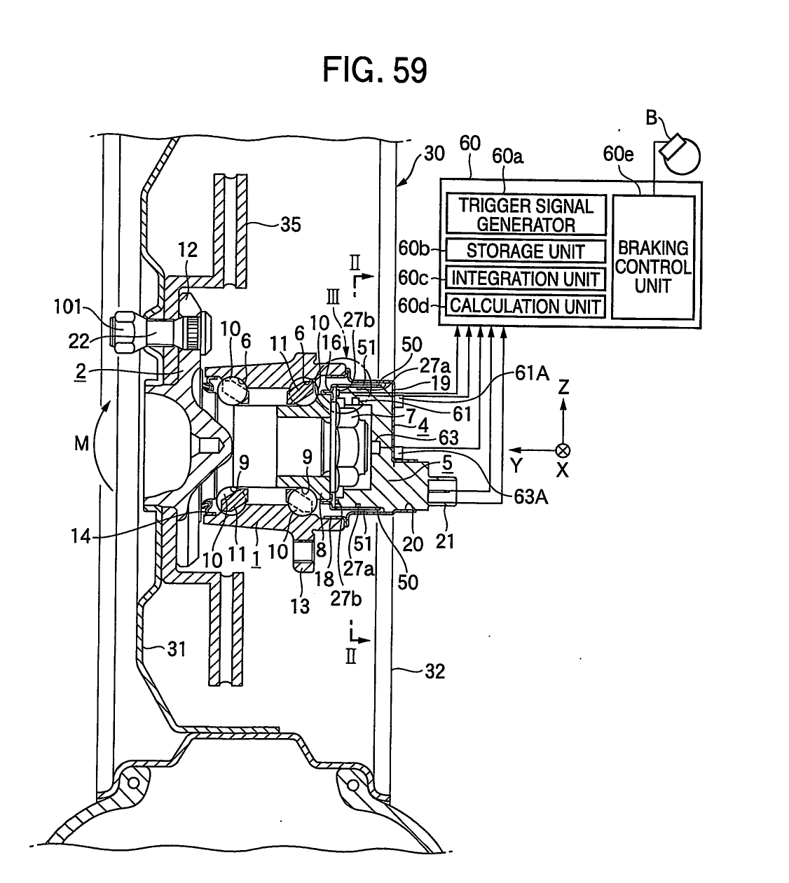

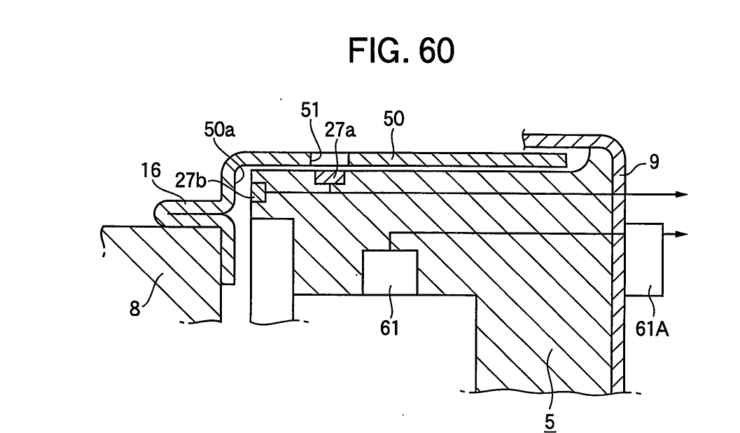

FIG. 59 is a sectional view of a rolling bearing unit for axle support according to a seventeenth embodiment of the invention, and FIG. 60 is an enlarged view of the part indicated by arrow III in FIG. 59.

In the seventeenth embodiment, components similar to are denoted by the same reference numerals and will not be discussed again.

In the seventeenth embodiment, as shown in FIGS. 59 and 60, a rotation speed detection sensor unit 5 forming number-of-revolutions detection means contains an acceleration sensor 61 (for detecting acceleration in a Z (for example, vertical) direction), an acceleration sensor 62 (for detecting acceleration in a Y (for example, horizontal back-and-forth) direction), and an acceleration sensor 63 (for detecting acceleration in an X (for example, horizontal side-to-side) direction) so that their axes cross each other; acceleration sensors each using a piezoelectric element are used as the acceleration sensors 61 to 63.

That is, speed change that can be measured by the acceleration sensors 61 to 63 is minute and accuracy is required and therefore it is desirable that a high-accuracy semiconductor acceleration sensor, such as an acceleration sensor using a piezo element or piezoelectric element or a capacitance type acceleration sensor, should be used.

However, if wiring is extended from a controller 60 of the car body to a vehicle unit below a spring of a suspension to which the acceleration sensors 61 to 63 are attached, the effect (distortion, noise, etc.,) of capacitance or wiring resistance change noise, etc., as the wiring moves whenever the car swings or turns is received, and the acceleration signal output from each acceleration sensor 61 to 63 to the controller 60 of the car body is displaced.

Then, in the seventeenth embodiment, acceleration signal processors 61A to 63A are attached to the wheel unit together with the acceleration sensors 61 to 63 and process the acceleration signals of the acceleration sensors 61 to 63 to the signals of the form not receiving the effect of deformation of the wiring and then output the provided signals to the controller 60 of the car body.

Using the wheel unit in the seventeenth embodiment, the controller 60 can execute vehicle control method.

That is, the acceleration signal undergoing processing of the corresponding acceleration signal processor 62A (not shown) from the acceleration sensor 62 in the seventeenth embodiment and output to the controller 60 of the car body does not receive the effect (distortion, noise, etc.,) of capacitance or wiring resistance change noise, etc., caused by motion (deflection) of the wiring when the car swings or turns, and the acceleration in the traveling direction of each wheel 30 can be detected precisely. For example, as the acceleration signal output from each acceleration sensor 61 to 63, an analog signal maybe converted into a digital signal or may be amplified before it is sent.

The acceleration signal processors 61A to 63A can perform amplification processing, temperature insuring circuit, tire minute vibration removal filter, digitalization processing, etc., for the acceleration signals of the acceleration sensors 61 to 63, thereby performing not only processing of converting into the form not receiving the effect of motion of the wiring, but also processing of converting into the form not receiving any other effect of electromagnetic noise of the engine, temperature change, etc.

The acceleration signal processors 61A to 63A can also be configured so as to transmit the processed signal to the controller 60 of the car body by radio.

Further, the processing power of the acceleration signal processors 61A to 63A may be supplied from the car body or may be supplied by electric power generation of wheel rotation.

According to the seventeenth embodiment of the invention, the acceleration sensor and the acceleration signal processor are only attached to a stationary member of the wheel unit below the spring of the vehicle suspension, whereby precise control following the above-described expression for each wheel unit can be performed without receiving the effect of the suspension, etc. Since the control technique is similar to that in the related art, the system in the related art can be used.

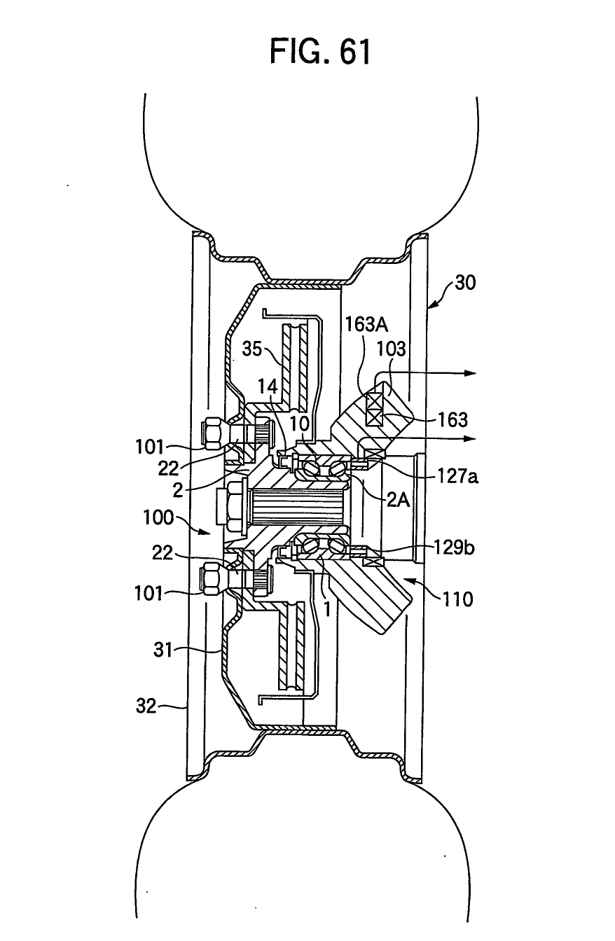

FIG. 61 is a sectional view of a wheel unit according to an eighteenth embodiment of the invention.

In the eighteenth embodiment, different parts from those of the seventeenth embodiment shown in FIG. 60 will be mainly discussed and components similar to those of the seventeenth embodiment are denoted by the same reference numerals and will not be discussed again.

In FIG. 61, at the left of a hub 2 of a rolling bearing unit 100 in the figure, a wheel disk part 31 of a wheel 30 is attached through a stud 22 with a disk rotor 35 forming a part of a braking unit between and is fastened using a wheel nut 101.

An outer race 1 of the rolling bearing unit 100 forms a stationary member together with a knuckle member 103 and is fixed to the inner peripheral surface of the knuckle member 103 for forming a spring bottom of a suspension (not shown) attached to a car body (not shown).

An acceleration sensor 163 for detecting acceleration in the traveling direction of the vehicle and up and down and side to side directions of the vehicle is attached to the inside of a hole of the knuckle member 103 and a rotation speed sensor 127a is attached to the inner peripheral surface of the knuckle member 103.

The rotation speed sensor 127a is opposed to a sensor rotor 129b attached to an inner race 2A fitted to the hub 2 of the rolling bearing unit 100 (the hub 2 and the inner race 2A makeup a rotation member) for detecting the number of revolutions of the hub 2, namely, the wheel 30.

A wheel unit 110 is made up of the rolling bearing unit 100 having the rotation speed sensor 127a, the knuckle member having the acceleration sensor 163 (namely, knuckle unit) 103, the braking unit containing the disk rotor 35, and the wheel 30.

Further, in the eighteenth embodiment, as shown in FIG. 61, an acceleration signal processor 163A is attached to the inside of the hole of the knuckle member 103 together with the acceleration sensor 163 and processes the acceleration signal of the acceleration sensor 163 to the signal of the form not receiving the effect of deformation of the wiring and then outputs the provided signals to a controller 60 (not shown) of the car body.

Using the wheel unit 110 in the eighteenth embodiment, vehicle control method can also be executed.

That is, the acceleration signal undergoing processing of the acceleration signal processor 163A from the acceleration sensor 163 in the eighteenth embodiment and output to the controller 60 of the car body does not receive the effect (distortion, noise, etc.,) of capacitance or wiring resistance change noise, etc., caused by motion (deflection) of the wiring when the car swings or turns, and the acceleration in the traveling direction of the wheel 30 and the acceleration in the up and down and side to side directions of the vehicle can be detected precisely.

The acceleration signal processor 163A can perform amplification processing, temperature insuring circuit, tire minute vibration removal filter, digitalization processing, etc., for the acceleration signal of the acceleration sensor 163, thereby performing not only processing of converting into the form not receiving the effect of motion of the wiring, but also processing of converting into the form not receiving any other effect of electromagnetic noise of the engine, temperature change, etc.

The acceleration signal processor 163A can also be configured so as to transmit the processed signal to the controller 60 of the car body by radio.

Further, the processing power of the acceleration signal processor 163A may be supplied from the car body or maybe supplied by electric power generation of wheel rotation.

According to the rolling bearing unit for axle support of the embodiment, the acceleration signal output from the semiconductor acceleration sensor is processed to the signal in the form not receiving the effect of deformation of the wiring and then is output to the controller of the car body by the acceleration signal processor attached to the stationary member of the wheel unit below the spring of the vehicle suspension together with the acceleration sensor.

That is, although high-accuracy semiconductor acceleration sensor such as an acceleration sensor using a piezo element or piezoelectric element or a capacitance type acceleration sensor is attached to the stationary member of the wheel unit below the spring of the vehicle suspension moving at all times, the signal output to the controller of the car body does not receive the effect (distortion, noise, etc.,) of capacitance or wiring resistance change noise, etc., caused by motion (deflection) of the wiring when the car swings or turns, and the acceleration in the traveling direction of each wheel can be detected precisely.

The acceleration signal processor can perform amplification processing, temperature insuring circuit, tire minute vibration removal filter, digitalization processing, etc., for the acceleration signal, thereby performing not only processing of converting into the form not receiving the effect of motion of the wiring, but also processing of converting into the form not receiving any other effect of electromagnetic noise of the engine, temperature change, etc.

[Description of insisting that the priority date is Feb. 3, 2003]

(1) The variable names in the description are as follows: The traveling speed V_{X} is ground speed V, the tire radius R is tire real radius R, the tire radius r is virtual radius r, the rotation angular speed V_{θ} is wheel angular speed ω, the traveling acceleration Aₓ is acceleration αₓ, the rotation angular acceleration A_{θ} is wheel angular acceleration ωα, and the slip ratio λ is slip ratio S.

(2) The symbols of the description are effective only for the description.

Next, an embodiment of a slip ratio measurement method and a vehicle control method according to the invention will be discussed.

To begin with, a slip ratio measurement method will be discussed.

When a tire of a wheel firmly grips the road surface and rotates, creep occurs between the surface of the tire and the road surface. Thus, even when a real slip does not occur, the circumferential speed as the tire rotates appears to be higher than the traveling speed of the car body at the driving time and appears to be lower than the traveling speed of the car body at the braking time. The speed difference is caused by the creep.

Usually, if the speed difference is within the range of about ±20%, the tire grips the road surface. That is, when the slip ratio is a value in the neighborhood of 0.2 caused substantially only by the creep ratio, the drive force or braking force is transmitted from the tire to the road face and grip is provided; if the slip ratio exceeds the value, a real slip occurs and it becomes difficult to stably control the vehicle.

In the invention, three types of measurement methods are proposed based on the viewpoint that the slip ratio is made up of the creep ratio and the real slip ratio. In the specification, the three measurement methods are called (1) differentiation method, (2) integration method, and (3) combining method for convenience, which will be discussed below in order. To execute the methods, preferably at least a wheel unit including an acceleration sensor and a rotation sensor for each wheel (the two sensors are collectively called slip sensor), a rolling bearing unit for axle support (called slip sensor bearing), or a vehicle (called slip control system) as described above is used.

(1) Differentiation method

To begin with, the tire radius of each wheel is found in a state in which creep and a real slip do not occur, namely, the slip ratio is substantially almost zero. That is, at the preliminary running time of the vehicle as the drive force or braking force does not act on the tire in the wheel, tire radius R is found using basic expression “wheel traveling speed Vx is found by multiplying the tire radius R by tire rotation angular speed Vθ,” namely, expression (246) given below and expression (247) “wheel traveling acceleration Ax is found by multiplying the tire radius R by tire rotation angular acceleration Aθ.”

Here, preferably the preliminary running of the vehicle is the running state in which the vehicle runs on a flatland with a road gradient of −4 degrees to +2 degrees at low speed of 4 km/h or less with low acceleration of 0.05 G or less, for example.

[Expression 156]
Vₓ=RVθ (246)
[Expression 157]
Aₓ=RAθ (247)

In expressions (246) and (247), the preliminary traveling acceleration Ax and the preliminary rotation angular speed Vθ at the preliminary running time are detected and found from the acceleration sensor and the rotation sensor attached to the wheel. Further, the preliminary rotation angular acceleration Aθ is found by differentiating the preliminary rotation angular speed Vθ in expression (246). Thus, in expression (247), the preliminary traveling acceleration Ax and the preliminary rotation angular acceleration Aθ are determined and the precise tire radius R is found. The tire radius R found here is temporarily stored in memory (for example, storage unit shown in FIG. 59).

Further, the tire radius R and the preliminary rotation angular speed Vθ can be assigned to expression (246) to find the precise preliminary traveling speed Vx.

After the wheel tire radius R is found at the preliminary running time, apparent tire radius r found by assuming that the slip ratio is zero is found at the real running time as the drive force or braking force acts actually on the tire, and wheel slip ratio λ is found from the ratio between the apparent tire radius r and the tire radius R found at the preliminary running time, r/R.

The speed difference occurs between the circumferential speed as the tire rotates and the traveling speed of the car body at the real running time. If the speed difference is replaced with zero (namely, the slip ratio is zero) and the tire radius is assumed to change, the apparent tire radius r can be found using the following expressions (248) and (249) assuming the tire radius R in expressions (246) and (247) to be the apparent tire radius r:

[Expression 158]
Vₓ=rVθ (248)
[Expression 159]
Aₓ=rAθ (249)

In expressions (248) and (249), the real traveling acceleration Ax and the real rotation angular speed Vθ at the real running time are detected and found from the acceleration sensor and the rotation sensor attached to the wheel. Further, the real rotation angular acceleration Aθ is found by differentiating the real rotation angular speed Vθ in expression (248). Thus, in expression (249), the real traveling acceleration Ax and the real rotation angular acceleration Aθ are determined and the apparatus tire radius r is found.

Further, the tire radius r and the real rotation angular speed Vθ can be assigned to expression (248) to find the precise real traveling speed Vx.

The ratio between the apparatus tire radius r and the tire radius R found at the preliminary running time represents the degree of the difference between the tire rotation speed and the car body speed, namely, indicates the degree of slip (creep plus real slip). Therefore, the slip ratio λ is found according to the following expression (250):

[Expression 160]
r/R=1±λ (250)

According to the differentiation method described above, measurement can always be conducted for each wheel in real time at any of the traveling time in a straight line, the turning time, the acceleration time, the deceleration time, the time of going up a hill, or the high-speed time regardless of the front wheel, the rear wheel, drive wheel, the driven wheel, or the steering wheel of the vehicle, and the slip ratio can be found with high accuracy. Therefore, stable running of the vehicle can be maintained.

(2) Integration method

To begin with, the tire radius R at the preliminary running time of the vehicle is found using expressions (246) and (247) mentioned above and further using the following expression (251) of integrating expression (247) per unit time Δ:

[Expression 161]
ΔVₓ=RΔVθ (251)

Here, the preliminary traveling acceleration Ax and the preliminary rotation angular speed Vθ at the preliminary running time are detected and found from the acceleration sensor and the rotation sensor attached to the wheel as in the differentiation method described above. Further, the preliminary rotation angular acceleration Aθ is found by differentiating the preliminary rotation angular speed Vθ in expression (246). The preliminary traveling acceleration Ax and the preliminary rotation angular acceleration Aθ thus found are assigned to expression (247) and integration is performed, whereby increment of preliminary traveling speed, ΔVx, shown in expression (251) and increment of the preliminary rotation angular speed, ΔVθ, are calculated, whereby the precise tire radius R is found. Since the tire radius R found here is calculated from the integration value in the unit time Δ, errors of variations in the data within the integration unit time Δ are averaged. The tire radius R found here is temporarily stored in the memory.

Further, the tire radius R and the preliminary rotation angular speed Vθ can be assigned to expression (246) to find the precise preliminary traveling speed Vx.

After the wheel tire radius R is found at the preliminary running time, apparent tire radius r found by assuming that the slip ratio is zero is found at the real running time, and wheel slip ratio λ is found from the ratio between the apparent tire radius r and the tire radius R found at the preliminary running time, r/R, as in the differentiation method described above.

In the integration method, the apparent tire radius r is found using expressions (248) and (249) mentioned above and the following expression (251) of integrating expression (249) per unit time Δ:

[Expression 162]
ΔVₓ=rΔVθ (252)

Here, the real traveling acceleration Ax and the real rotation angular speed Vθ at the real running time are detected and found from the acceleration sensor and the rotation sensor attached to the wheel as in the differentiation method described above. Further, the real rotation angular acceleration Aθ is found by differentiating the real rotation angular speed Vθ in expression (248). The real traveling acceleration Ax and the real rotation angular acceleration Aθ thus found are assigned to expression (249) and integration is performed, whereby increment of real traveling speed, ΔVx, shown in expression (252) and increment of the real rotation angular speed, ΔVθ, are calculated, whereby the apparent tire radius r is found. Since the apparent tire radius r found here is calculated from the integration value in the unit time Δ, errors of variations in the data within the integration unit time Δ are averaged.

Further, the tire radius r and the real rotation angular speed Vθ can be assigned to expression (248) to find the precise real traveling speed Vx.

The apparent tire radius r thus found and the tire radius R found at the preliminary running time can be assigned to expression (250) to find the slip ratio λ as in the differentiation method.

According to the integration method described above, measurement can always be conducted for each wheel in real time at any of the traveling time in a straight line, the turning time, the acceleration time, the deceleration time, the time of going up a hill, or the high-speed time regardless of the front wheel, the rear wheel, drive wheel, the driven wheel, or the steering wheel of the vehicle, and the slip ratio can be found with high accuracy. Therefore, stable running of the vehicle can be maintained. Since errors of variations of the tire radius R and the apparatus tire radius r are averaged, the slip ratio per unit time can be found more precisely.

(3) Combining method

The combining method is used preferably when the vehicle has driven wheels. Here, the case where a vehicle having two driven wheels and two drive wheels is used will be discussed.

Letting one of the driven wheels be i, the other of the driven wheels be ii, one of the drive wheels be iii, and the other of the drive wheels be iv, the preliminary traveling speed Vx of each wheel at the preliminary running time is represented by the following expression (253) from expression (245) given above:

[Expression 163]
Vₓ=RᵢVθᵢ=RᵢᵢVθᵢᵢ=RᵢᵢᵢVθᵢᵢᵢ=RᵢᵥVθᵢᵥ (253)

From this expression (253), assuming that the tire radius Ri of the driven wheel i is the reference radius, the tire radiuses Rii, Riii, and Riv of other wheels are found as the following expression (254) where Vθi, Vθii, Vθiii, and Vθiv are the preliminary rotation angle speed of the tires:

[Expression 164]
Rᵢ=reference radius
Rᵢᵢ=Rᵢ(Vθᵢ/Vθᵢᵢ)
Rᵢᵢᵢ=Rᵢ(Vθᵢ/Vθᵢᵢᵢ)
Rᵢᵥ=Rᵢ(Vθᵢ/Vθᵢᵥ) (254)

The tire radiuses Ri, Rii, Riii, and Riv thus found are temporarily stored in the memory.

Next, wheel rotation speed difference is found using apparent tire radiuses ri, rii, riii, and riv at the real running time of the vehicle.

Real traveling speed Vxi, Vxii, Vxiii, and Vxiv of the wheels at the real running time are represented by the following expression (255) using expression (248) given above. The rotation angle speed of the tires Vθi, Vθii, Vθiii, and Vθiv can be detected by the rotation sensors attached to the wheels.

[Expression 165]
Vᵢ=rᵢVθᵢ
Vᵢᵢ=rᵢᵢVθᵢᵢ
Vᵢᵢᵢ=rᵢᵢᵢVθᵢᵢᵢ
Vᵢᵥ=rᵢᵥVθᵢᵥ (255)

Since the driven wheel does not involve a slip at any time other than the braking time, the apparent radiuses ri and rii do not change. That is, the apparent tire radiuses ri and rii of the driven wheels are equal to the tire radiuses Ri and Rii in expression (254) given above.

[Expression 166]
rᵢ=Rᵢ
rᵢᵢ=Rᵢᵢ (256)

At the traveling time of the vehicle in a straight line, the wheels are equal in real traveling speed. Therefore, from expression (255) given above, the apparent radiuses riii and riv of the drive wheels are found as the following expression (257):

[Expression 167]
rᵢᵢᵢ=Vₓᵢ/Vθᵢᵢᵢ=rᵢVθᵢ/Vθᵢᵢᵢ=RᵢVθᵢ/Vθᵢᵢᵢ
rᵢᵥ=Vₓᵢ/Vθᵢᵥ=rᵢVθᵢ/Vθᵢᵥ=RᵢVθᵢ/Vθᵢᵥ (257)

At the turning time of the vehicle, the wheels differ in real traveling speed and therefore expression (257) does not hold.

As for the driven wheels, expression (256) holds and therefore the real traveling speed at the turning time can be found from expression (255).

As for the drive wheels, real traveling acceleration Axiii, Axiv is integrated from the turning start time and the result is added to the real traveling speed (equal to Vxi) at the traveling time in a straight line just before the turning start to calculate the real traveling speed at the turning time (non-stationary traveling speed) Vxiii, Vxiv as shown in the following expression (258):

[Expression 168]
Vₓᵢᵢᵢ=Vₓᵢ+∫Aₓᵢᵢᵢ
Vₓᵢᵥ =Vₓᵢ+∫Aₓᵢᵥ (258)

As the turning start time, the real rotation speed provided by integrating the real rotation angular speed of the wheel is observed and the time when the speed difference occurring between the left and right wheels exceeds a setup value is determined the turning start. At the turning start time, a turning trigger signal may be generated and integrating of the real traveling acceleration Axiii, Axiv may be started at the generation time of the trigger signal.

From expressions (255), (256), and (258) given above, the apparent tire radiuses riii and riv of the drive wheels at the turning time are found according to the following expression (259):

[Expression 169]
rᵢᵢᵢ=Vₓᵢᵢᵢ/Vθᵢᵢᵢ
rᵢᵥ=Vₓᵢᵥ/Vθᵢᵥ (259)

Thus, the apparatus tire radius r at the real running time is divided by the tire radius R at the preliminary running time at which a slip (creep) scarcely occurs, whereby the rotation speed difference to grasp the slip difference between the wheels is found. The driven wheel ratio is r/R=1.

Considering that the wheels and the car body are elastically joined, processing similar to that at the turning time may be performed also at the traveling time of the vehicle in a straight line if the wheels become different in traveling acceleration.

At the braking time of the vehicle, the braking force also acts on the driven wheel and creep occurs and the apparatus tire radius becomes small. Therefore, without using the driven wheel as the reference, the traveling acceleration of each axle is integrated starting at the brake trigger time and the result may be added to the previous traveling acceleration of the axle to find the non-stationary traveling speed of the axle.

The traveling acceleration of each axle is integrated for one second at a time one after another (in a cascade manner), for example, at 0.1-second intervals at all times and the result is added to the traveling acceleration of each axle before the integration start to find the non-stationary traveling speed at the time and if the difference between the non-stationary traveling speed of the driven wheel used as the reference and the non-stationary circumferential speed of the driven wheel becomes a given value or more, the integration start point in time may be adopted as the brake trigger. For each axle, the integration from the integration start point in time is continued and the non-stationary traveling speed of the axle found by the integration is used. Then, if the difference between the non-stationary traveling speed of the driven wheel used as the reference and the non-stationary circumferential speed of the driven wheel becomes given value or less, the state is restored to the former state. Thus, the ratio between the apparent tire radius and the real tire radius R, r/R, is observed, whereby the degree of the rotation difference is determined and the degree of slip (slip ratio) is determined.

According to the combining method described above, measurement can always be conducted for each wheel in real time at any of the traveling time in a straight line, the turning time, the acceleration time, the deceleration time, the time of going up a hill, or the high-speed time regardless of the front wheel, the rear wheel, drive wheel, the driven wheel, or the steering wheel of the vehicle, and the slip ratio can be found with high accuracy. Therefore, stable running of the vehicle can be maintained. In the combining method, the tire radius of the drive wheel can be found using the driven wheel as the reference, so that the slip ratio, etc., can be found with high accuracy without particularly using a sensor of high resolution.

Any of (1) differentiation method, (2) integration method, or (3) combining method is used, whereby the precise slip ratio considering creep for each wheel can be found from the ratio between the apparent tire radius and the real tire radius.

In the method described above, whether the tire radius ratio r/R is smaller or greater than 1 is checked, whereby whether the wheel is in an acceleration or deceleration state can be determined. If the tire radius ratio r/R is smaller than 1, the wheel is in the deceleration state (braking state); if the tire radius ratio r/R is greater than 1, the wheel is in the acceleration state (drive state).

Next, a vehicle control method of controlling braking of a vehicle using the slip ratio will be discussed.

The slip ratio in which the creep ratio reaches the maximum (called the limit slip ratio) generally is about 0.2 (20%). However, the value changes depending on the contact state with the road surface and is not necessarily be 20%. The large creep ratio means the state in which the grip force of the wheel and the road surface works accordingly and thus braking in a state in which the creep ratio is large as much as possible provides a large braking force. Then, if a real slip is about to occur exceeding creep, as the brake force is controlled so that the slip ratio always becomes a value less than and close to the maximum value of the creep ratio, the real slip can be prevented from occurring and the maximum braking force can be provided.

For example, when the vehicle is braked suddenly, acceleration of large deceleration acts on each wheel. At the time, if the slip ratio of the wheel also “increases” in association with “increase” in the acceleration of deceleration, the wheel is involved in the deceleration. However, if any wheel starts actually (really) to slip, the slip ratio “suddenly increases” in contrast to “increase” in the acceleration of deceleration or “increases” in contrast to “decrease” in the acceleration of deceleration. The wheel does not serve any longer for braking. From the state, braking of the wheel is a little relieved, raising the braking force.

To perform this control, the slip ratio just before the slip ratio suddenly increases is adopted as the limit slip ratio and brake control is performed in the ratio. As the brake is a little relieved, the slip ratio decreases and the grip force can be maintained so that no real slip occurs. As a method of determining the limit slip ratio, the slip change rate per unit time of the slip ratio is calculated at all times and it is determined that the time when the slip ratio suddenly increases, namely, the slip change rate becomes large exceeding any desired change rate is the time at which the wheel starts to slip. At the time, if “decrease” in the slip ratio of the wheel starts to be associated with “decrease” in the acceleration of deceleration, the brake force is raised. Here, the desired change rate used as the determination material may be previously found by experiment, etc.

Accordingly, the wheel can be stopped at the shortest braking distance on any road surface.

Likewise, to prevent a side slip, if brake control is performed in the limit slip ratio, the side slip can also be minimized.

As a specific example, assuming that the minimum slip ratio is 10% and the maximum slip ratio is 25%, the ratio of slip ratio λ to traveling distance Ax of each wheel, λ/Ax, or change rate dλ/dAx is checked from the brake trigger time with the maximum value 25% in the range as the target value. Sudden increase of λ/Ax is, for example, 10%, 20%, 50%, etc., and sudden increase of dλ/dAx is, for example, twice, five times, 10 times, 20 times, etc., in determination.

The slip ratio can also be used to estimate road surface reaction.

Road surface reaction Fx is the force in the traveling direction imposed on an axle and is proportional to the slip ratio λ almost as in the following expression (259):

[Expression 170]
Fₓ=Kₑμ·F_{z}·λ (260)

Ke depends almost on the nature of the surface of a tire and generally is about 0.2.

According to expression (259), if the wheels are the same in road friction coefficient μ and the vertical load imposed on the road surface, the degree of the road surface reaction Fx of each wheel can be estimated from the slip ratio.

Assuming that the road friction coefficient μ and the car body load do not change, the change percentage of the vertical load imposed on the road surface of each wheel is found by back and force, side to side, and up and down acceleration sensors on the car body, whereby the degree of the road surface reaction Fx of each wheel at the time of “acceleration,” “deceleration,” “sudden acceleration,” “sudden deceleration,” “turning” can be estimated from the slip ratio.

In this case, further if each road surface reaction Fx is multiplied by each tire radius, the degree of the drive torque of each wheel can be estimated.

The slip ratio can also be used to perform stability control.

The above-described vehicle control method is also effective for stability control of preventing slide deflection and wheel spin at a curve and on a road surface where a slip easily occurs because a slip can be prevented for each wheel and the wheel itself can be maintained in a state in which an actual slip does not occur.

For example, a G (acceleration) sensor is provided on the car body and lateral G (acceleration), inclination angle, and turning angle are found. If any of them becomes an abnormal state, the engine throttle is closed (opened), the brake required for each wheel is applied (relieved), the clutch is disconnected (connected), and active suspension is adjusted for performing attitude control. At the time, the throttle, the brake, and the clutch can be controlled so that the slip ratio measured from the acceleration sensor and rotation sensor for each wheel does not become beyond the limit slip ratio (in which an actual slip occurs).

Since the slip ratio of each wheel is always known before the limit is reached, how much an allowance exists until the limit is reached can be predicted and acceleration or deceleration can be controlled earlier accordingly.

Since the slip ratio is almost proportional to the road surface reaction before the limit slip ratio, the power (drive torque) can be controlled matching the allowance amount of the slip ratio. Accordingly, the real slip of a tire can basically be eliminated, so that abnormal car body deflection can be suppressed. The allowance amount of the slip ratio is known and optimum power control can be performed in advance.

The slip ratio can also be used to detect a heavily uneven road surface.

For example, a vibration sensor for measuring longitudinal vibration is placed on the axle, the waveform of vibration (width and height) is observed in contrast to the wheel rotation speed, the tire trace distance is estimated, the slip ratio is found from the trace speed and the tire circumferential speed, and brake control, engine throttle control, speed control, etc., can be performed within the range of the limit slip ratio for preventing an abnormal running state from occurring.

To use the above-described slip ratio measurement method, if the real radius of the tire changes, the apparent tire radius is not restored to if acceleration is stopped. Thus, whether the real radius of the tire changes or the tire radius appears to change simply because of creep can be determined. If the apparent tire radius is restored to, it can be determined that the tire radius appeared to change because of creep.

When change in the apparent tire radius is fierce (when tire radius abnormal area is entered), there is a possibility of a tire blowout and thus it is determined a tire blowout and control may be performed so as to close an accelerator throttle. Although the throttle is closed, if the apparent radius tire is not restored to the former state to some extent (when it does not exit from the tire radius abnormal area), a warning is given and (low-speed, constant-speed driving is entered) and the driver is prompted to stop driving the vehicle. Here, the tire radius abnormal area refers to an area in which the apparent tire radius decrease rate of any one wheel (1−r/R) is larger than the apparent tire radius decrease amount of another wheel. For example, it is 10% or more between 2 and 5 seconds, 5% or more between 5 and 20 seconds, etc. Alternatively, the tire radius abnormal area refers to an area in which the apparent tire radius decrease amount of any single wheel (1−r/R) is large. For example, it is 5% or more for 60 seconds or more.

If the apparent tire radius decrease rate is 3% or more for a long term (for example, 5 minutes or more, 10 minutes or more), it is assumed that the tire radius decrease is caused by change in superimposed load, display, etc., is produced, and again the real radius may be measured. However, measurement should be conducted after waiting until the measurement conditions become complete.

When the acceleration changes (when either of Ax and Aθ changes a given amount or more), the wheel slip ratio changes and the apparent tire radius r also changes. Thus, it is appropriate to integrate output of the acceleration sensor from the immediately preceding speed to find the speed and find the apparent tire radius r from the speed.

In the differentiation method and the integration method described above, the slip ratio can be found more precisely using the high-resolution acceleration sensor. As the high-resolution acceleration sensor, a sensor of high resolution (for example, the resolution is 1/10000 of the maximum measurement value) can be used or two sensors of normal resolution (for example, the resolution is 1/1000 of the maximum measurement value) different in the maximum measurement value can be used and if the sensor with the smaller maximum measurement value scales out, the sensor can be switched to the sensor with the larger maximum measurement value for use (the resolution is 1 mG or less, preferably 0.5 mG, 0.2 mG or less).

The acceleration sensor used here is a sensor that can measure acceleration from frequency of 1000 Hz or less or 100 Hz or less to frequency at the stationary acceleration time with almost no vibration to find the speed of an automobile unlike a general vibration sensor to measure vibration.

For a vibration noise filter, when the acceleration is large, the responsivity may be made fast; when the acceleration is small, the responsivity may be made small. For example, when the acceleration is 0.1 G or more, the responsivity may be 50 Hz, 20 ms or more; when the acceleration is 0.1 G or less, the responsivity may be 10 Hz, 100 ms or less.

As the high-resolution rotation sensor used, an active sensor for detecting a magnetic encoder with a Hall element is appropriate for a wheel. As the magnetic encoder, preferably a magnetic encoder with a small pitch error (1.0% or less, 0.5% or less, more preferably 0.1% or less) may be used. To do this, although a rubber magnet may be used, a plastic working magnet (iron chrome cobalt magnet) that can be worked with high accuracy or magnetized with high accuracy, a metal magnet (manganese aluminum carbon magnet, etc.,), a plastic magnet (a magnet having ferrite and neodymium Nd—Fe—B mixed into plastic), etc., can be used preferably.

If high accuracy is hard to provide (ferrite rubber magnet encoder, etc.,), a pitch error of one revolution is previously stored in memory and is used while an error correction is made, whereby high accuracy can be insured. To make correction at the initial time of running, data of several revolutions is averaged or correction is made from pattern recognition. At the time, pitch is shifted, for example, 10% or 50% only at one point and if correction is made with the point as the reference, processing is facilitated.

The non-detection face of the ferrite rubber magnet encoder is shaped like a cylinder or a disk and is magnetized 20 to 60 pulses (NS=one pulse) alternatingly like NSNS in the circumferential direction. The ferrite rubber magnet is inexpensive, but is hard to provide magnetization accuracy. However, it is made unequal pitches, whereby high accuracy is provided. An unequal pitch encoder for detection the wheel rotation speed of an automobile is as follows:

(1) Rubber magnet bonded with ferrite powder.

(2) Baked to a magnetic board.

(3) Molded as isotropy in a vertical magnetic field at the baking time.

(4) Magnetized alternatingly like NSNS vertically after mold.

(5) Having at least one reference pitch (calibration pitch is calibrated with the reference pitch as the reference).

(6) Having a plurality of calibration pitches.

(7) Error of each calibration pitch from the center value is 2% or less of pitch.

(8) The reference pitch deviates 5% or more of pitch from the center value of the calibration pitch.

The unequal pitch encoder thus made is rotated and an error of each calibration pitch is read based on the time lag from the reference value and is stored. When the encoder is used, it is corrected based on the error for use.

The magnetic encoder may be reinforced with a magnetic board attached to the rear. Preferably, the magnetic encoder is fitted into the inside of a cylinder part of a holder for support to prevent facture and misalignment. Further, the holder may be a press mold steel plate having an L-letter part in cross section for preventing deformation. The plastic magnet may be oil proof (grease) and undergo waterproof treatment for use, and the ferrite magnet may be made isotropic (reinforced) in the vertical direction and vertically magnetized for use.

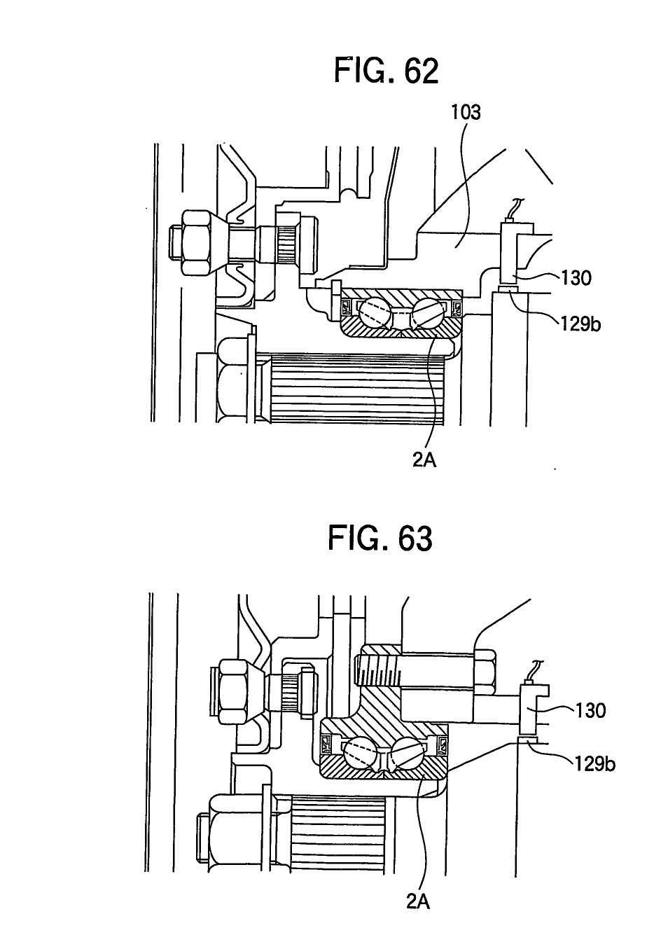

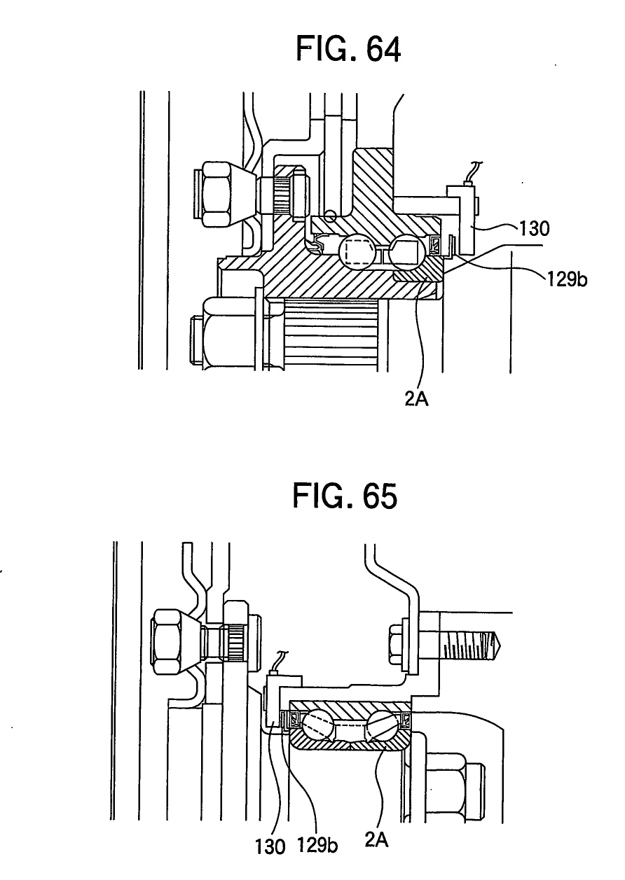

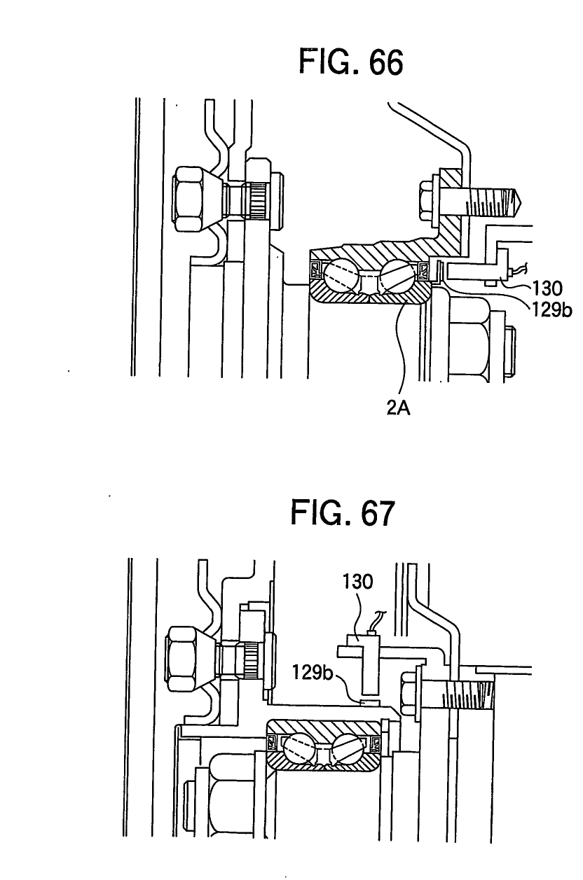

As the acceleration sensor attached to an axle, preferably a composite sensor integrated with a rotation sensor is used. FIGS. 62 to 68 show preferred embodiments wherein a composite sensor is attached to an axle.

In each of the examples shown in FIGS. 62 to 66, a composite sensor 130 is attached to the outer race side of a bearing unit of inner race rotation hub type, and a sensor rotor 129b is provided at the part on the side of an inner race 2A opposed to the composite sensor 130.

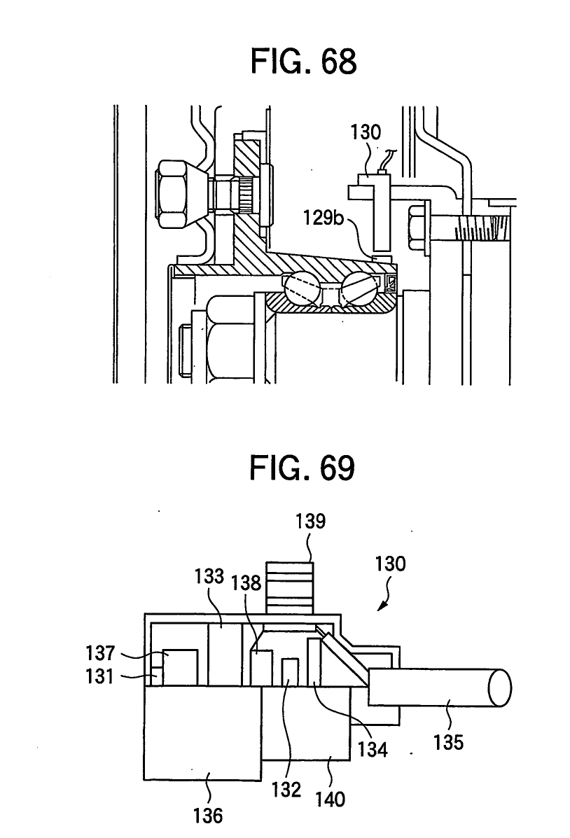

In each of the examples shown in FIGS. 67 and 68, a composite sensor 130 is attached to the outside of an outer race of a bearing unit of outer race rotation hub type, and a sensor rotor 129b is provided at the part on the side of an outer race opposed to the composite sensor 130.

FIG. 69 shows a preferred embodiment of composite sensor 130.

The composite sensor 130 is a rotation sensor containing an acceleration sensor and is an external sensor unit. An active rotation sensor and an acceleration sensor are put into one package to form the composite sensor 130. A Hall element 131 for the rotation sensor, a GMR element, and acceleration sensor 132 are magnetically shielded by a magnetic board 133, and electromagnetic noise is shielded using a cover 134 of the acceleration sensor section as a magnetic material for protecting the acceleration sensor 132 from noise, and signal processing is performed. The signal processing maybe performed through a cable 135 (for example, USB standard) made up of two power supply lines of 5 V, 12 V, 24 V, etc., plus one acceleration signal line plus one rotation pulse signal line or two power supply lines plus one signal line with acceleration and rotation pulse mixed. If the acceleration signal line and the rotation pulse signal line are separate signal lines, a system of converting acceleration output into an analog signal or a digital signal and sending the signal to the car body on a separate line with the rotation pulse signal as former is used on the axle side. The composite sensor 130 is attached to the outside of the bearing. In the external sensor, the Hall element 131 is covered with a non-magnetic SUS cover 136 to detect magnetism. For the BRG containing type, similar shielding is also performed. The composite sensor 130 includes a magnet 137 at a position adjacent with the Hall element 131 and further has a signal processing circuit 138 placed between the magnetic board 133 and the acceleration sensor 132 and also has a bush 139 and a magnetic case 140. A composite sensor of the type wherein the magnet 137 is not provided can also be used.

The acceleration signal output from the acceleration sensor maybe processed to the signal in the form not receiving the effect of deformation of the wiring and then may be output to a controller of the car body by an acceleration signal processor attached to a stationary member of a wheel unit below a spring of a vehicle suspension together with the acceleration sensor.

That is, although high-accuracy semiconductor acceleration sensor such as an acceleration sensor using a piezo element or piezoelectric element or a capacitance type acceleration sensor is attached to the stationary member of the wheel unit below the spring of the vehicle suspension moving at all times, the signal output to the controller of the car body does not receive the effect (distortion, noise, etc.,) of capacitance or wiring resistance change noise, etc., caused by motion (deflection) of the wiring when the car swings or turns, and the acceleration in the traveling direction of each wheel can be detected precisely.

The acceleration signal processor can perform amplification processing, temperature insuring circuit, tire minute vibration removal filter, digitalization processing, etc., for the acceleration signal of the acceleration sensor, thereby performing not only processing of converting into the form not receiving the effect of motion of the wiring, but also processing of converting into the form not receiving any other effect of electromagnetic noise of the engine, temperature change, etc.

The acceleration signal processor may be configured so as to transmit the processed signal to the controller of the car body by radio.

Further, the processing power of the acceleration signal processor may be supplied from the car body or may be supplied by electric power generation of wheel rotation.

Measures for preventing a side slip at the vehicle turning time (corning time) will be discussed below:

The force in the traveling direction, Fx(=1/λm μ Fz λ) (where limit slip ratio λm=0.15 and vertical load imposed on tire: Fz), is almost proportional to the slip ratio until a point before a real slip (for example, λ>0.1) and therefore the degree of road surface resistance force is determined from the slip ratio.

Therefore, drive and braking can be controlled referencing the degree of road surface resistance force.

Fx may be found from expression of Fx=(Fz/g) Ax (where g is gravity acceleration).

Since road friction coefficient μ is almost (0.15/g) (Ax/λ) until a point before a real slip (for example, λ>0.1), it is always found from the ratio between the acceleration and the slip ratio (it may be found from the inclination angle or the change rate).

For the friction coefficient as a road surface fixed value, the coefficient found in the almost linear range before a real slip (for example, λ<0.1) is stored and the previous road friction coefficient μ is used in the range of λ>0.1.

For the friction coefficient as correlation between the road surface and tire, the road friction coefficient μ is found as the ratio between the acceleration and the slip ratio (0.15/g) (Ax/λ) itself.

However, the expression of Fx given above holds at the braking time of the non-drive time.

At the braking time, considering that the same braking force Fx acts on each wheel, from the following expression (264):

[Expression 171]
Fₓ=1/0.2·μF_{z}·λ (261)

the proportional distribution of Fzi, Fzii, Fziii, and Fziv of the wheels becomes the proportional distribution of 1/λi, 1/λii, 1/λiii, and 1/λiv, the reciprocal of the slip ratio at the time and thus becomes as in the following expression (262):

[Expression 172]
F_{zn}=(1/λₙ)/Σ(1/λₙ) (262)

For example,

[Expression 173]
fᵢ=(1/λᵢ)/(1/λ)+(2/λ)+(3/λ)+(4/λ) (263)

This expression (262) is stored as the load coefficient of each wheel. The total of Fzi, Fzii, Fziii, and Fziv of the wheels is the car body total weight W and therefore can be later used as Fzi=W fi.

For the expression of Fx=(Fz/g) Ax described above, at the acceleration time of two-wheel drive, if the right, Fz is calculated as the sum of Fz before and after the right. For example,

[Expression 174]
Fₓᵢ=((F_{zi}+F_{zii})g)Aₓ (264)

From this expression (264) and the following expression (265), further the following expression (266) is obtained:

[Expression 175]
Fₓᵢ=1/0.2·μ·F_{zi}λ (265)

$$\begin{matrix}[ Expression 176 ] & \\ {μ}_{i} = ( ( {F}_{zi} + {F}_{ziii} ) / g ) {A}_{x} / ( 1 / 0.2 \cdot μ \cdot {F}_{zi} λ ) & ( 266 ) \\ = 0.2 ( ( {f}_{i} + {f}_{iii} ) / {f}_{i} g ) \cdot {A}_{x} / {λ}_{i} & \end{matrix}$$

In fact, average of μn is adopted as μ.

Accordingly, Fzi, Fzl, and μ are also found and thus Fx is found as the ratio of W.

At the turning time, the acceleration relative to the Y direction (lateral direction) of the acceleration sensor of the car body and the acceleration relative to the Y direction (lateral direction) of each axle of the acceleration sensor of each axle are calculated from the time when angle sensor provided on the axle detects turning, and the acceleration difference is twice integrated to find the difference between the axle and the car body by calculation. When the difference (difference/μ) is large considering the road friction coefficient found according to the above-described method, the speed is reduced to lower the centrifugal force (or the corning force against the centrifugal force) for preventing a side slip and at the same time, preventing the slip ratio in the X direction (traveling direction) from reaching the limit slip ratio.

The turning angle is found from the difference between angle sensors of the steering wheel and a non-steering wheel.

When the turning angle is added or traveling speed difference appears between the left and right axles, the vehicle is turning and the centrifugal force works. The centrifugal acceleration is found by calculation and the lateral-direction share among the tires is found. If it becomes large considering the friction coefficient, the speed may be reduced.

At the turning time, if the acceleration sensor in the Y direction of the axle suddenly increases as compared with change speed of the turning angle difference or change in centrifugal acceleration, it is determined that the wheel starts a side slip, and the speed is reduced. At the time, if a side slip of the front wheel to the outside occurs, the drive torque may be suppressed and the brake may be (much) applied to the rear inner wheel for insuring the traceability of the vehicle. If a side slip of the rear wheel to the outside occurs, the brake may be (much) applied to the front outer wheel for insuring the traceability of the vehicle.

Industrial Applicability

As described above, according to the slip ratio measurement method and the vehicle control method and further the slip sensor, the slip sensor bearing, and the slip control system according to the invention, the precise slip ratio for each wheel can also be found at the traveling time of the vehicle in a straight line and at the turning time. The precise traveling speed for each wheel can be found from the apparent tire radius and the wheel rotation angular speed provided by the methods.

Further, the slip ratio and the traveling speed can be measured seamlessly regardless of the driving state of the vehicle, and the stable run state of the vehicle can be maintained.

1. A wheel run state measuring method of using an acceleration sensor in the traveling direction of each wheel and a wheel rotation sensor, attached to each axle unit of a vehicle.

2. A wheel run state measuring method of using an acceleration sensor in the traveling direction of each wheel, attached to each axle unit of a vehicle, an acceleration sensor in the lateral direction of each wheel, and a wheel rotation sensor.

3. A wheel run state measuring method of using an acceleration sensor in the traveling direction of each wheel, attached to each axle unit having a drive wheel of a vehicle and a wheel rotation sensor.

4. The vehicle using the method as claimed in claim 1.

5. The vehicle using the method as claimed in claim 2.

6. The vehicle using the method as claimed in claim 3.

7. An axle unit or a rolling bearing unit for axle support comprising:
an acceleration sensor for measuring acceleration in the traveling direction of a wheel, and
a rotation sensor for measuring the rotation angular speed of the wheel.

8. A vehicle control apparatus using an acceleration sensor of each wheel and a wheel rotation sensor, attached to each axle unit of a vehicle.

9. The rolling bearing unit for axle support comprising:
the acceleration sensor and the rotation sensor as claimed in claim 8.

10. A wheel unit comprising:
a stationary member,
a rotation member being rotatable relative to the stationary member,
a sensor rotor being attached to the rotation member,
a rotation speed sensor being attached to the stationary member so as to be opposed to the sensor rotor for outputting a rotation speed signal responsive to the rotation speed of the sensor rotor, and
an acceleration sensor being attached to the stationary member for outputting an acceleration signal responsive to the acceleration in the traveling direction of the wheel unit.

11. A wheel unit comprising:
a stationary member,
a rotation member being rotatable relative to the stationary member,
a sensor rotor being attached to the rotation member,
a rotation speed sensor being attached to the stationary member so as to be opposed to the sensor rotor for outputting a rotation speed signal responsive to the rotation speed of the sensor rotor, and
an acceleration sensor being attached to the stationary member for outputting an acceleration signal responsive to the acceleration in the traveling direction of wheel.

12. A rolling bearing unit for wheel support comprising:
a rotation wheel,
a stationary wheel,
a plurality of rolling elements being placed between the stationary wheel and the rotation wheel,
a sensor rotor being attached to the rotation wheel, a rotation speed sensor being attached to the stationary wheel so as to be opposed to the sensor rotor for outputting a rotation speed signal responsive to the rotation speed of the sensor rotor, and
an acceleration sensor being attached to the stationary wheel for outputting an acceleration signal responsive to the acceleration in the traveling direction of wheel.

13. A wheel unit comprising:
a stationary member of the wheel unit below a spring of a vehicle suspension,
a rotation member being rotatable relative to the stationary member,
a sensor rotor being attached to the rotation member,
a rotation speed sensor being attached to the stationary member so as to be opposed to the sensor rotor for outputting a rotation speed signal responsive to the rotation speed of the sensor rotor, and
a semiconductor acceleration sensor being attached to the stationary member for outputting an acceleration signal responsive to the acceleration in the traveling direction of wheel.

14. A vehicle control method using an acceleration sensor in the traveling direction of each wheel and a wheel rotation sensor, attached to each axle unit of a vehicle.

15. The sensor comprising:
an acceleration sensor and a rotation speed sensor provided on a wheel to use the measuring method as claimed in claim 1.

16. The bearing comprising the sensor as claimed in claim 15.

17. The control system for controlling the run state of an automobile using the measuring method as claimed in claim 1.

18. The sensor comprising:
an acceleration sensor and a rotation speed sensor provided on a wheel to use the vehicle control method as claimed in claim 14.

19. The bearing comprising the sensor as claimed in claim 18.

20. The control system for controlling the run state of an automobile using the vehicle control method as claimed in claim 14.
